(19) United States
(12) Patent Application Publication
(10) Pub. No.: US 2005/0022274 A1
(43) Pub. Date: Jan. 27, 2005

(54) User interface for infusion pump remote controller and method of using the same

(76) Inventors: Robert Campbell, Waltham, MA (US); Stephen Gemmell, Andover, MA (US); Marc Vogt, Rye, NH (US); John T. Garibotto, Marblehead, MA (US); Luis Malave, Peabody, MA (US); Deborah Cate-Brown, Marshfield, MA (US); Aaron Oppenheimer, Cambridge, MA (US); Christina Vivona, Portsmouth, RI (US); Pamela Mandler, Portsmouth, RI (US); David Frey, Cranston, RI (US)

Correspondence Address: MCDERMOTT, WILL & EMERY;ATTN: INTELLECTUAL PROPERTY DEPT., 28 STATE STREET, BOSTON, MA, 02109, US

(21) Appl. No.: 10/827,582

(22) Filed: Apr. 19, 2004

Related U.S. Application Data
(60) Provisional application No. 60/463,809, filed on Apr. 18, 2003.

(51) Int. Cl. G09G 5/00

(52) U.S. Cl. D24/100

(57) ABSTRACT

A control system for controlling an infusion pump, including interface components for allowing a user to receive and provide information, a processor connected to the user interface components and adapted to provide instructions to the infusion pump, and a computer program having setup instructions that cause the processor to enter a setup mode upon the control system first being turned on. In the setup mode, the processor prompts the user, in a sequential manner, through the user interface components to input basic information for use by the processor in controlling the infusion pump, and allows the user to operate the infusion pump only after the user has completed the setup mode.

### CROSS-REFERENCE TO RELATED APPLICATIONS

The present application claims priority to provisional U.S. patent application Ser. No. 60/463,809, filed on Apr. 18, 2003, which is assigned to the assignee of the present application and incorporated herein by reference. The present application also claims priority to provisional U.S. patent application serial No. ______, filed on Apr. 19, 2004 (attorney docket no. INSL-144PR2), which is assigned to the assignee of the present application and incorporated herein by reference.

### FIELD OF THE DISCLOSURE

The present disclosure relates generally to medical devices, systems and methods, and more particularly to a small, low cost, disposable infusion pump that is useable with a remote controller to achieve precise, sophisticated, and programmable flow patterns for the delivery of therapeutic liquids such as insulin to a patient. Even more particularly, the present disclosure is directed to a user interface for a remote controller of an infusion pump.

### BACKGROUND OF THE DISCLOSURE

Ambulatory infusion pumps have been developed and used to deliver liquid medicaments to patients. These infusion pumps have the ability to offer sophisticated fluid delivery profiles accomplishing bolus requirements, continuous infusion and variable flow rate delivery. These infusion capabilities usually result in better efficacy of the drug and therapy and less toxicity to the patient's system. An example of a use of an ambulatory infusion pump is for the delivery of insulin for the treatment of diabetes mellitus. These pumps can deliver insulin on a continuous basal basis as well as a bolus basis.

Currently available ambulatory infusion pumps are relatively expensive, bulky, heavy and fragile and are relatively difficult to program and prepare for infusion. Filling these pumps can be difficult and require the patient to carry both the intended medication as well as filling accessories. The pumps require specialized care, maintenance, and cleaning to assure proper functionality and safety for their intended long term use. Due to the high cost of existing pumps, healthcare providers limit the patient populations approved to use the devices and therapies for which the devices can be used. In addition, because of the relative difficulty to program and prepare the pumps for infusion, many patients who qualify as potential users are resistant to using the pumps.

Clearly, therefore, there was a need for a programmable and adjustable infusion system that is precise and reliable and can offer clinicians and patients a small, low cost, light-weight, easy-to-use alternative for parenteral delivery of liquid medicines.

In response, the assignee of the present application provided a small, low cost, light-weight, easy-to-use infusion pump for delivering liquid medicines to a patient. The infusion pump, which is described in co-pending U.S. patent application Ser. No. 09/943,992, filed on Aug. 31, 2001, includes an exit port, a dispenser for causing fluid from a reservoir to flow to the exit port, a local processor programmed to cause a flow of fluid to the exit port based on flow instructions from a separate, remote controller, and a wireless receiver connected to the local processor for receiving the flow instructions. To reduce the size, complexity and costs of the infusion pump, the pump is provided with a housing that is free of user input components, such as a keypad, for providing flow instructions to the local processor. Instead, the user input components are provided in the remote controller, which is used to remotely program and control the infusion pump. A single remote controller can be used with a plurality of the infusion pump, since the infusion pump are each inexpensive enough to be disposable after being used.

What is still desired is a new and improved user interface for use as part of a remote controller of an infusion pump. Preferably, the new and improved user interface will allow a user to easily and intuitively program, operate and obtain feedback from the infusion pump.

### SUMMARY OF THE DISCLOSURE

Exemplary embodiments of the present disclosure provide a control system for controlling an infusion pump, wherein the control system includes various user interface programs that, among other features, allow a user to easily and intuitively program, operate and obtain feedback from the infusion pump. According to one exemplary embodiment, the system includes user interface components for allowing a user to receive and provide information, a processor connected to the user interface components and adapted to provide instructions to the infusion pump, and a computer program having setup instructions that cause the processor to enter a setup mode upon the control system first being turned on. In the setup mode, the processor prompts the user, in a sequential manner, through the user interface components to input basic information for use by the processor in controlling the infusion pump, and allows the user to operate the infusion pump only after the user has completed the setup mode.

According to one aspect of the present disclosure, the infusion pump includes an exit port, a reservoir connected to the exit port, a dispenser for causing fluid within the reservoir to be dispensed through the exit port, and a wireless receiver connected to the dispenser and adapted to receive remotely transmitted flow instructions that instruct the dispenser to dispense fluid.

According to another aspect of the present disclosure, the system further includes a remote controller separate from the infusion pump. The remote controller includes the user interface components, a wireless transmitter for transmitting the flow instructions to the receiver of the infusion pump, and the processor is connected to the user interface components and the transmitter. The computer program further includes instructions that cause the processor to receive information from a user through the user interface components, calculate flow instructions based on the information and provide the flow instruction to the transmitter.

The present disclosure, therefore, provides a new and improved user interface for a remote controller of an infusion pump that allows a user to easily and intuitively program, operate and obtain feedback from the infusion pump. These aspects of the disclosure, together with additional features and advantages thereof, may best be understood by reference to the following detailed descriptions and examples taken in connection with the accompanying illustrated drawings.

### BRIEF DESCRIPTION OF THE DRAWINGS

FIG. 1 is a perspective view of a exemplary embodiment of a fluid delivery system constructed in accordance with the present disclosure, including an infusion pump shown secured on a patient and a remote controller shown being held by the patient and used to remotely control the infusion pump;

FIGS. 2 and 3 are enlarged top and bottom perspective views, respectively, of the infusion pump of FIG. 1;

FIG. 4 is a further enlarged top perspective view of the infusion pump of FIG. 1, shown with a top housing portion removed to reveal exemplary embodiments of interior portions of the pump; and

FIG. 5 is an enlarged front elevation view of the remote controller of FIG. 1, wherein an exemplary embodiment of a menu screen of a user interface according to the present disclosure is displayed on a display of the remote controller;

FIGS. 6 through 11 are flowcharts illustrating an exemplary embodiment of an initial setup component of a user interface computer program according to the present disclosure, which can be operated on the remote controller of FIG. 5 upon the remote controller being turned on for a first time;

FIG. 12 is a flowchart illustrating an exemplary embodiment of an infusion pump status request component of a user interface computer program according to the present disclosure, which can be operated on the remote controller of FIG. 5;

FIG. 13 is a flowchart illustrating an exemplary embodiment of a main menu component of a user interface computer program according to the present disclosure, which can be operated on the remote controller of FIG. 5;

FIG. 14 is a front elevation view of the remote controller of FIG. 5, wherein an exemplary embodiment of a status screen according to the present disclosure is displayed on the display of the remote controller after a soft key labeled “status” on the main menu of FIG. 5 is pressed;

FIG. 15 is a front elevation view of the remote controller of FIG. 5, wherein the menu screen is once again displayed on the display of the remote controller after a soft key labeled “menu” on the status screen of FIG. 14 is pressed;

FIGS. 16 and 17 are flowcharts illustrating an exemplary embodiment of a glucose meter operating component of a user interface computer program according to the present disclosure, which can be selected from the menu of FIG. 13;

FIG. 18 is a front elevation view of the remote controller of FIG. 5, wherein the menu screen is displayed on the remote controller and a “bolus” submenu selection is highlighted;

FIG. 19 is a front elevation view of the remote controller of FIG. 5, after the “bolus” submenu has been selected from the menu screen of FIG. 18;

FIGS. 20 through 25 are flowcharts illustrating an exemplary embodiment of a bolus submenu of a user interface computer program according to the present disclosure, which is operated on the remote controller of FIG. 5 after the “bolus” submenu has been selected;

FIG. 26 is a front elevation view of the remote controller of FIG. 5, wherein the menu screen is displayed on the remote controller and a “temporary basal” submenu selection is highlighted;

FIG. 27 is a front elevation view of the remote controller after the “temporary basal” submenu has been selected from the menu screen of FIG. 26;

FIG. 28 is a flowchart illustrating an exemplary embodiment of a temporary basal submenu of a user interface computer program according to the present disclosure, which can be operated on the remote controller of FIG. 5, after the “temporary basal” submenu has been selected;

FIG. 29 is a front elevation view of the remote controller of FIG. 5, wherein the menu screen is displayed on the remote controller and a “my records” submenu selection is highlighted;

FIG. 30 is a front elevation view of the remote controller after the “my records” submenu has been selected from the menu screen of FIG. 29;

FIGS. 31 through 37 are flowcharts illustrating an exemplary embodiment of a records submenu of a user interface computer program according to the present disclosure, which is operated on the remote controller of FIG. 5 after the “my records” submenu has been selected;

FIG. 38 is a front elevation view of the remote controller of FIG. 5, wherein the menu screen is displayed on the remote controller and a “settings” submenu selection is highlighted;

FIG. 39 is a front elevation view of the remote controller after the “settings” submenu has been selected from the menu screen of FIG. 38;

FIG. 40 is a flowchart illustrating an exemplary embodiment of a settings submenu component of a user interface computer program according to the present disclosure, which is operated on the remote controller of FIG. 5 after the “settings” submenu has been selected;

FIG. 41 is a flowchart illustrating an exemplary embodiment of a “change pump” submenu component of a user interface computer program according to the present disclosure, which is operated on the remote controller of FIG. 5 after the “change pump” submenu has been selected from the settings submenu of FIG. 40;

FIGS. 42 through 44 are flowcharts illustrating an exemplary embodiment of a “basal program list” submenu component of a user interface computer program according to the present disclosure, which is operated on the remote controller of FIG. 5 after the “basal program list” submenu has been selected from the settings submenu of FIG. 40;

FIG. 45 is a further enlarged front elevation view of the remote controller of FIG. 5, wherein a graph of flow rate versus time is displayed on the remote controller to represent a basal rate that has been programmed by a user;

FIG. 46 is a flowchart illustrating an exemplary embodiment of a “manage presets” submenu component of a user interface computer program according to the present disclosure, which is operated on the remote controller of FIG. 5 after the “manage presets” submenu has been selected from the settings submenu of FIG. 40;

FIGS. 47 and 48 are flowcharts illustrating an exemplary embodiment of a “edit temporary basal presets” submenu component of a user interface computer program according to the present disclosure, which is operated on the remote controller of FIG. 5 after the “edit temporary basal presets” submenu has been selected from the “manage presets” submenu of FIG. 46;

FIG. 49 is a flowchart illustrating an exemplary embodiment of a “manage bolus presets” submenu component of a user interface computer program according to the present disclosure, which is operated on the remote controller of FIG. 5 after the “manage bolus presets” submenu has been selected from the “manage presets” submenu of FIG. 46;

FIGS. 50 through 56 are flowcharts illustrating an exemplary embodiment of a “manage carbohydrate presets” submenu component of a user interface computer program according to the present disclosure, which is operated on the remote controller of FIG. 5 after the “manage carbohydrate presets” submenu has been selected from the “manage presets” submenu of FIG. 46;

FIG. 57 is a flowchart illustrating an exemplary embodiment of a “view food database” submenu component of a user interface computer program according to the present disclosure, which is operated on the remote controller of FIG. 5 after the “view food database” submenu has been selected from the “manage carbohydrate presets” submenu of FIGS. 50 through 56;

FIGS. 58 and 59 are flowcharts illustrating an exemplary embodiment of a “manage custom foods” submenu component of a user interface computer program according to the present disclosure, which is operated on the remote controller of FIG. 5 after the “manage custom foods” submenu has been selected from the “view food database” submenu of FIG. 57;

FIG. 60 is a flowchart illustrating an exemplary embodiment of a “system setup” submenu component of a user interface computer program according to the present disclosure, which is operated on the remote controller of FIG. 5 after the “system setup” submenu has been selected from the settings submenu of FIG. 40;

FIG. 61 is a flowchart illustrating an exemplary embodiment of a “edit date and time” submenu component of a user interface computer program according to the present disclosure, which is operated on the remote controller of FIG. 5 after the “edit date and time” submenu has been selected from the system setup submenu of FIG. 60;

FIGS. 62 through 65 are flowcharts illustrating an exemplary embodiment of a “bolus and basal setting” submenu component of a user interface computer program according to the present disclosure, which is operated on the remote controller of FIG. 5 after the “bolus and basal setting” submenu has been selected from the system setup submenu of FIG. 60;

FIGS. 66 through 69 are flowcharts illustrating an exemplary embodiment of a “patient factors” submenu component of a user interface computer program according to the present disclosure, which is operated on the remote controller of FIG. 5 after the “patient factors” submenu has been selected from the “bolus and basal setting” submenu of FIG. 62;

FIG. 70 is a flowchart illustrating an exemplary embodiment of a “blood glucose meter setup” submenu component of a user interface computer program according to the present disclosure, which is operated on the remote controller of FIG. 5 after the “blood glucose meter setup” submenu has been selected from the system setup submenu of FIG. 60;

FIGS. 71 through 73 are flowcharts illustrating an exemplary embodiment of an “alarms and reminders” submenu component of a user interface computer program according to the present disclosure, which is operated on the remote controller of FIG. 5 after the “alarms and reminders” submenu has been selected from the system setup submenu of FIG. 60;

FIG. 74 is a flowchart illustrating an exemplary embodiment of a “setup remote options” submenu component of a user interface computer program according to the present disclosure, which is operated on the remote controller of FIG. 5 after the “setup remote options” submenu has been selected from the system setup submenu of FIG. 60;

FIG. 75 is a flowchart illustrating an exemplary embodiment of a “run diagnostics” submenu component of a user interface computer program according to the present disclosure, which is operated on the remote controller of FIG. 5 after the “run diagnostics” submenu has been selected from the system setup submenu of FIG. 60;

FIG. 76 is a front elevation view of the remote controller of FIG. 5, wherein the menu screen is displayed on the remote controller and a “suspend/cancel” submenu selection is highlighted;

FIG. 77 is a front elevation view of the remote controller after the “suspend/cancel” submenu has been selected from the menu screen of FIG. 76;

FIG. 78 is a flowchart illustrating an exemplary embodiment of a suspend/cancel submenu component of a user interface computer program according to the present disclosure, which is operated on the remote controller of FIG. 5 after the “suspend/cancel” submenu has been selected; and

FIG. 79 is legend for use with the flow charts shown in the attached figures.

Like reference characters designate identical or corresponding components and units throughout the several views.

### DETAILED DESCRIPTION OF EXEMPLARY EMBODIMENTS OF THE DISCLOSURE

An exemplary embodiment of a new and improved user interface according to the present disclosure for use with a remote controller for remotely controlling an infusion pump is shown and described in detail herein. The new and improved user interface allows a user to easily and intuitively operate the remote controller in order to program, operate and obtain feedback from the infusion pump. Exemplary embodiments of the user interface include a hierarchical-structure menu system that enables users to execute programs by selecting a program in a displayed menu through a conversation-style interaction with the remote controller. Thus, users who are not familiar with personal computers can easily use such a menu system.

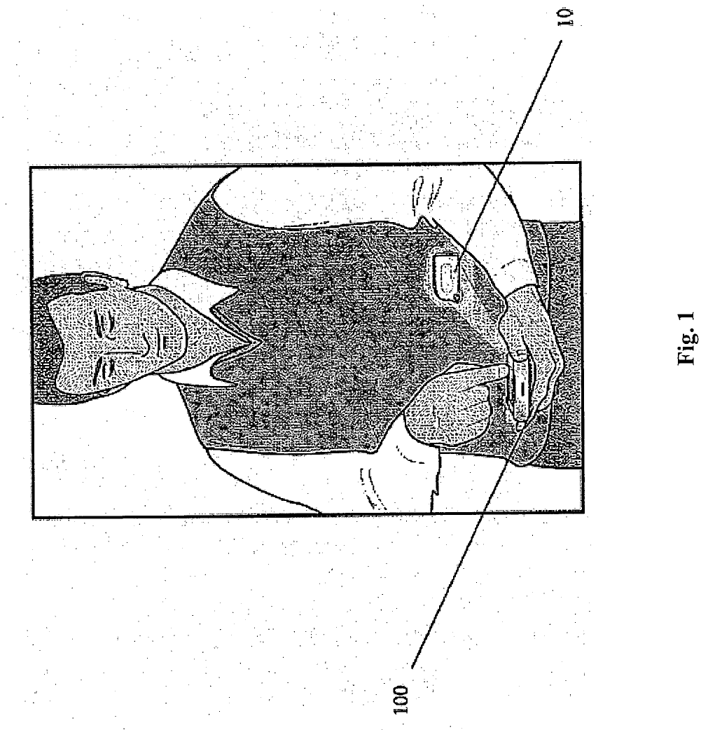

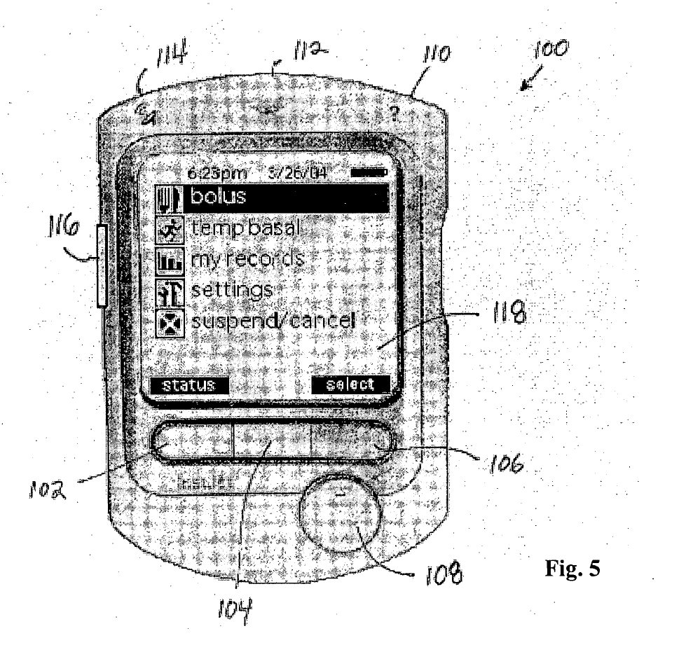

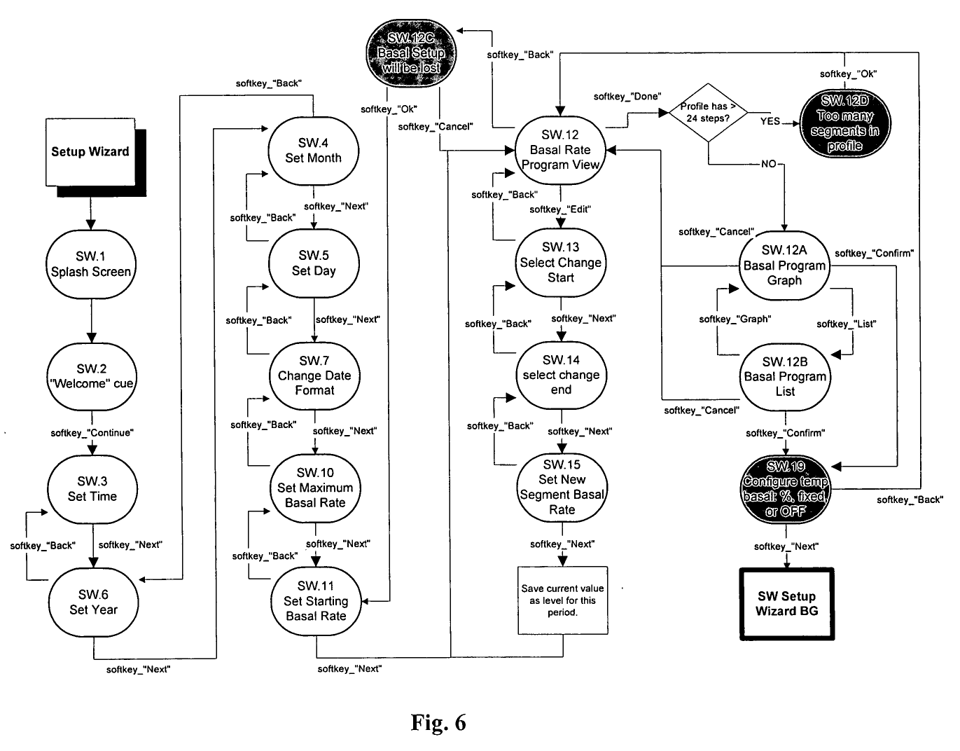

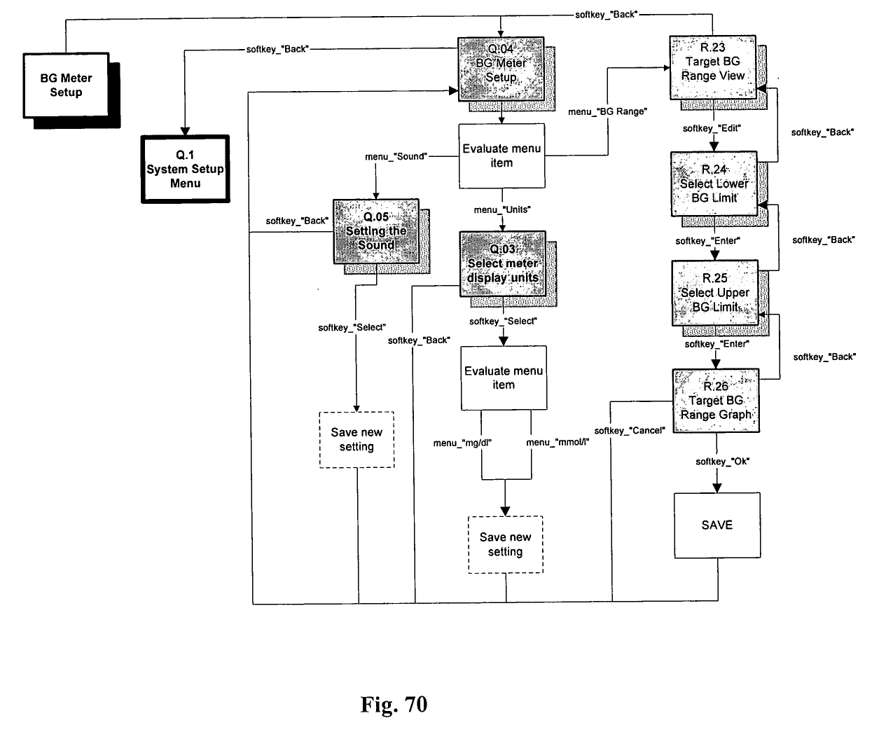

FIGS. 1 through 4 show an exemplary embodiment of a remotely controlled, disposable infusion pump 10, which can be used with the user interface of the present disclosure, while FIGS. 1 and 5 show an exemplary embodiment of a remote controller 100 which can also be used with the new and improved user interface of the present disclosure to remotely control the infusion pump 10 of FIGS. 1 through 4. Examples of similar infusion pumps are disclosed in co-pending U.S. patent application Ser. No. 09/943,992, filed on Aug. 31, 2001, which is incorporated herein by reference. The remote controller 100 and the infusion pump 10 can incorporate the new and improved user interface provided by the present disclosure, which is illustrated in FIGS. 6 through 70.

While the user interface of the present disclosure is described with reference the exemplary embodiment of the infusion pump 10 and the remote controller 100 of FIGS. 1 through 5, it should be understood that the present disclosure is broadly applicable to any form of programmable infusion pumps. For example, the user interface of the present disclosure may be used with programmable ambulatory insulin infusion pumps of the sort currently commercially available from a number of manufacturers, including without limitation and by way of example, Medtronic Minimed under the trademark PARADIGM, Animas Corporation under the trademarks IR 1000 and IR 1200, Smiths Medical under the trademark Deltec COZMO, DANA Diabecare USA, and others.

The infusion pump 10 is used to deliver fluids to a person or animal. The types of liquids that can be delivered by the infusion pump 10 include, but are not limited to, insulin, antibiotics, nutritional fluids, total parenteral nutrition or TPN, analgesics, morphine, hormones or hormonal drugs, gene therapy drugs, anticoagulants, analgesics, cardiovascular medications, AZT or chemotherapeutics. The types of medical conditions that the infusion pump 10 might be used to treat include, but are not limited to, diabetes, cardiovascular disease, pain, chronic pain, cancer, AIDS, neurological diseases, Alzheimer's Disease, ALS, Hepatitis, Parkinson's Disease or spasticity.

In the exemplary embodiment of FIGS. 1 through 4, the infusion pump 10 is disposable and adapted for attachment to the skin of a patient for infusing fluid, such as insulin, into the patient on a continuous basis. The infusion pump 10 can have a usable life of about three days, for example, before being removed from the patient and discarded.

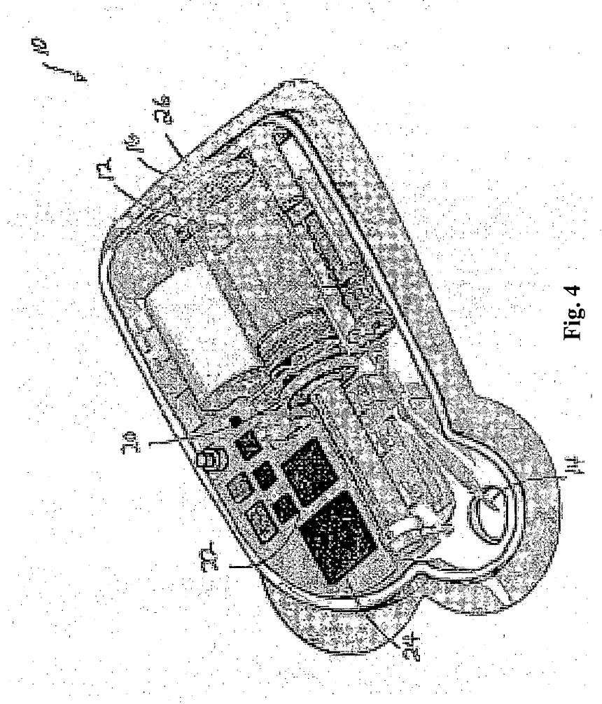

Referring to FIG. 4, the infusion pump 10 includes, for example, a dispenser assembly 20 for causing fluid from a fluid reservoir 12 to flow through a flow path assembly 16 to a transcutaneous access tool (e.g., needle) 14 for infusion into a patient. The volume of the reservoir 12 is chosen to best suit the therapeutic application of the infusion pump 10 impacted by such factors as available concentrations of medicinal fluids to be delivered, acceptable times between refills or disposal of the infusion pump 10, size constraints and other factors. A processor or electronic microcontroller (hereinafter referred to as the “local” processor) 22 is connected to the dispenser 20, and is programmed to cause a flow of fluid to the transcutaneous access tool 14 based on flow instructions from the separate, remote controller 100 of FIG. 5. A wireless receiver 24 is connected to the local processor 22 for receiving flow instructions from the remote controller 100 and delivering the flow instructions to the local processor 22. The device 10 also includes a housing 26 containing the flow path assembly 16, the transcutaneous access tool 14, the reservoir 12, the dispenser 20, the local processor 22, and the wireless receiver 24.

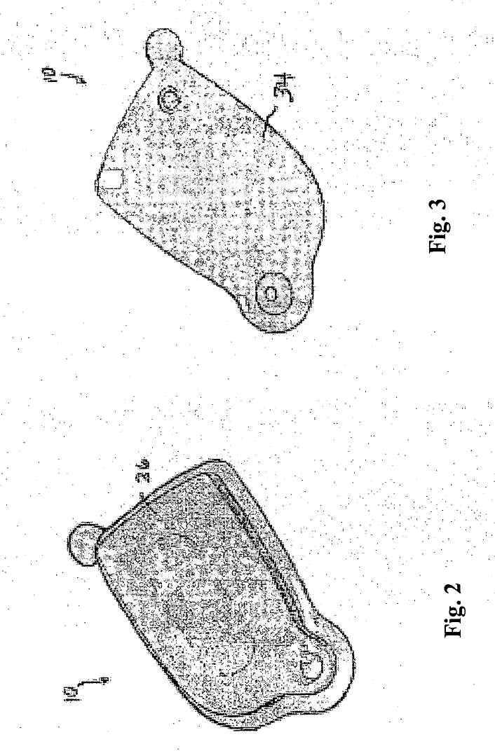

As shown best in FIGS. 2 and 3, the housing 26 of the infusion pump 10 preferably is free of user input components for providing flow instructions to the local processor, such as electromechanical switches or buttons on an outer surface of the housing 26, or interfaces otherwise accessible to a user to adjust the programmed flow rate through the local processor. The lack of user input components allows the size, complexity and costs of the device 10 to be substantially reduced so that the device 10 lends itself to being small and disposable in nature.

In the exemplary embodiment of FIG. 4, the infusion pump 10 also includes a power supply, such as a battery or capacitor, for supplying power to the local processor 22. The power supply is preferably integrated into the fluid delivery device 10, but can be provided as replaceable, e.g., a replaceable battery. The pump 10 can also include sensors or transducers such as a flow condition sensor assembly or dispenser position monitors, for transmitting information to the local processor 22 to indicate how and when to activate the dispenser 20, or to indicate other parameters determining fluid flow, as well as conditions such as the reservoir being empty or leaking, or the dispensing of too much or too little fluid from the reservoir 12, etc. As shown in FIG. 3, the pump 10 can also be provided with an adhesive layer on the outer surface of the housing 26 for securing the device 10 directly to the skin of a patient, as illustrated in FIG. 1.

In order to program, adjust the programming of, or otherwise communicate instructions to the local processor, the infusion pump 10 includes the wireless communication element, or receiver 24, as shown in FIG. 4, for receiving the instructions from the separate, remote controller 100 of FIG. 5. Signals can be sent via a communication element (not shown) of the remote controller 100. Alternatively, the infusion pump 10 may have an integrated user interface with some or all of the features of a remote control interface, for allowing a user to directly input instructions or commands to the pump 10. In another alternative embodiment, the infusion pump 10 may have both an integrated user interface with some or all of the features of a remote control interface as well as a wireless communication element for receiving instructions or commands from a separate remote controller. Hereinafter, the user interface will be described in the context of the exemplary embodiment of the remote controller 100 shown in FIG. 5, in which the user interface resides exclusively on the remote controller. However, the user interface programs of the present disclosure is equally applicable to alternative embodiments, such as those wherein some or all of the features of a user interface are incorporated in the infusion pump.

The remote controller 100 generally comprises a control system for remotely controlling the infusion pump and including user interface components for allowing a user to receive and provide information, a processor (hereinafter referred to as the “remote” processor) connected to the user interface components and adapted to provide instructions to the infusion pump, computer programs for providing instructions to the processor of the remote controller 100, and the user interface components, including user input components and user output components. The computer programs instruct the remote processor to receive user inputs from the user input components and provide information to the user output components, in accordance with the new and improved user interface disclosed in detail below, and then remotely provide control instructions or drive signals to the infusion pump 10.

In the exemplary embodiment of the remote controller 100 shown in FIG. 5, the user input components include electromechanical switches, such as three soft key selection switches 102, 104, 106, an up/down navigation toggle switch 108, a “display user information” switch 110, a power on/off switch 112, a “check pump status” switch 114, and an “instant bolus” switch 116, as shown in FIG. 5. The user output components include a visual display, such as a liquid crystal display (LCD) 118 and sound making devices, such as buzzers (not viewable) for making noise, and a vibrating element that causes the remote controller to vibrate.

The three soft key selection switches 102, 104, 106 cause the device to perform actions as indicated by labels that appear on the LCD 118. If there is no label over one of the switches 102, 104, 106, pressing the switch at that time will result in no activity. The up/down navigation toggle switch 108 is used to navigate a menu, enter a number, or change a character during text entry.

The LCD 118 displays icons to distinguish between various features. For non-menu pages, these icons are displayed in the upper-left corner of the screen displayed on the LCD 118. On menu pages, the icon is displayed to the left of the currently highlighted menu item, except on the main menu where an icon is displayed to the left of all menu items.

System functions are navigated by means of menus. These menus list the functions available to the user, and allow the user to quickly enable the appropriate function. Menus consist of a set of options in a list, with a highlight that moves up and down in response to the up/down navigation toggle switch 108. When the highlight is over the appropriate option, the user uses one of the three soft key selection switches 102, 104, 106 to select the option. Text entry in the system is accomplished using the soft keys 102, 104, 106 and the up/down toggle switch 108. The user moves the flashing up/down icon left and right using two of the soft keys, and changes the character above the icon using the up/down navigation toggle switch 108. Pressing the up/down toggle switch 108 changes the letter to the next letter in the sequence.

On many screens, one of the soft key selection switches 102, 104, 106 is labeled “back.” This button should take the user back one step in the current process. If the previous displayed screen was a menu, the option that was selected to move forward should be highlighted when the user selects “back.” If the previous screen was a data-entry screen, it should show the value that the user entered.

Although not shown, the remote controller 100 can include other components including an integrated glucose meter, such as a TheraSense® FreeStyle™ Glucose Meter which is available from Abbott Diabetes Care (formerly TheraSense) of Alameda, Calif. (http://www.therasense.com). The user interface components of the remote controller 100 are used to operate the glucose meter, as described below.

According to one exemplary embodiment, the communication element 24 of the infusion pump 10 receives electronic communication from the remote controller 100 using radio frequency or other wireless communication standards and protocols. In a preferred embodiment, the communication element 24 is a two-way communication element, including a receiver and a transmitter, for allowing the infusion pump 10 to send information back to the remote controller 100. In such an embodiment, the remote controller 100 also includes an integral communication element comprising a receiver and a transmitter, for allowing the remote controller 100 to receive the information sent by the infusion pump 10.

The local processor 22 of the infusion pump 10 contains all the computer programs and electronic circuitry needed to allow a user to program the desired flow patterns and adjust the program as necessary. Such circuitry can include one or more microprocessors, digital and analog integrated circuits, resistors, capacitors, transistors and other semiconductors and other electronic components, for example. The local processor 22 also includes programming, electronic circuitry and memory to properly activate the dispenser 20 at the needed time intervals. In a preferred embodiment, user inputs or commands are processed in the remote controller 100 to generate one or more specific flow control instructions, or drive signals, for the infusion pump 10. In an alternative embodiment, user inputs or commands are transmitted from the remote controller 100 to the infusion pump 10 where the commands are processed to generate flow control instructions, or drive signals for the infusion pump 10.

In general, the remote controller 100 is used to remotely initialize and program the infusion pump 10 with a patient's custom basal insulin delivery profile. The infusion pump 10 operates at the programmed rate independently of the remote controller 100. At any time the user can utilize the remote controller 100 to check the infusion pump 10 status, deliver a bolus dose of insulin or make changes to their insulin delivery profile. The remote controller 100 is similar to a personal digital assistant (PDA) device in size and is ergonomically shaped to fit comfortably in a shirt or pant pocket. The remote controller 100 is, for example, supplied to a patient, doctor or clinician in a non-sterile state in a padded box with a printed users guide booklet.

The user interface, which is also referred to a graphical user interface (GUI), of the present disclosure handles all processes in the set-up and use of the remote controller 100 and the infusion pump 10 in a step-by-step, easy to follow fashion. The size of the LCD 118 of the remote controller 100 is adapted to allow the use of full text displays to prompt the user through all set-up and use menus. The user interface is designed to mimic the way patients understand diabetes care and pump therapy. A “main menu” lists the tasks for which the user has turned on the remote controller 100 and users are lead through the process of administering a bolus, changing a basal rate, etc. Prompts are provided by the user interface to ensure that patients understand where they are in the menus.

The user interface includes features designed to simplify pump therapy for both the patient and a clinician. Features of the user interface may include: a bolus dose calculator based on preprogrammed insulin to carbohydrate ratios, correction (sensitivity) factor and blood glucose target range; a food database (meal planner) to assist in determining carbohydrates, fats, proteins, calories, etc. in a particular meal or food item; a graphical representation of historical blood glucose readings, bolus deliveries, basal rates and carbohydrate intake, up to two hundred and fifty blood glucose measurements and configuration information including the last calibration code; and a complete users manual, troubleshooting guide and education guide including recommended courses of action for alarm conditions and diabetes management scenarios.

A user interface provided in accordance with the present disclosure includes, but is not limited to, an initial setup component that operates upon the remote controller being turned on for a first time or in other specific circumstances; an infusion pump status request component; a main menu component; a glucose meter operating submenu; a bolus dose programming submenu; a temporary basal rate programming submenu component; a patient's records submenu component; a system settings options submenu; a replace pump submenu; a “basal program list” submenu; a “temporary basal presets list” submenu component; a “bolus presets list” submenu; a “manage carbohydrate presets” submenu component; a “manage custom foods” submenu component; a “system setup” submenu; an “edit date and time” selection submenu; a “bolus and basal setting” submenu component; a “patient factors” submenu component; a blood glucose meter setup submenu; an alarm and alerts options submenu; a “setup remote options” submenu; a run diagnostics submenu; and a suspend/cancel operation selection submenu. Exemplary embodiments of all of these features will now be described in detail.

Initial Setup Menu of the User Interface

Upon the remote controller 100 being turn on for a first time, the computer program of the remote controller 100 includes setup instructions that cause the processor of the remote controller 100 to enter a setup mode. The setup mode may also be activated by a reset of the remote controller, by user command, or other circumstances where it is desirable to guide the user through an interview comprising one or more queries requesting the user to input certain information into the remote controller. The setup mode generally includes prompting the user, in a sequential manner, through the user interface components of the remote controller 100 to input basic information for use by the remote processor in controlling the infusion pump 10. Preferably, the remote processor is instructed by the setup instructions to allow the user to operate the infusion pump 10 only after the user has completed the setup mode interview.

The basic items of information are, in general, minimal information that the system requires in order to function properly. The items of basic information input during the setup process include, for example, a current time, a current date, a preferred date display format, a maximum basal rate, a starting basal rate, a bolus increment, a maximum bolus dose, whether to enable a missed bolus reminder, whether to enable an external bolus function, and whether to enable a low reservoir volume alert level. The items of basic information can further include a blood glucose unit preference, a blood glucose lower range limit, a blood glucose upper range limit, a blood glucose target value, a target blood glucose correction value, an insulin to carbohydrate ratio, a correction factor, a carbohydrate preset value, and an insulin duration. Additional or different items of basic information may be selected depending upon the particular functionality included in the infusion system.

According to one exemplary embodiment of the user interface, the setup instructions cause the processor to exit the setup mode only after the user inputs each item of the basic information. In another exemplary embodiment, the setup instructions cause the processor to use default basic information if the user aborts the setup mode.

According to an additional exemplary embodiment, the setup instructions cause the processor of the remote controller 100 to alert the user if the items of basic information are inconsistent, and then cause the processor to prompt the user to reenter at least one of the items of basic information to resolve the inconsistency. The setup instructions cause the processor to prompt the user to select between a main menu and a new pump activation after the user has completed the setup mode.

FIGS. 6 through 11 are flowcharts illustrating an exemplary embodiment of an initialization setup component of the user interface computer program according to the present disclosure, which can be operated on the remote controller 100 of FIG. 1 upon the remote controller 100 being turned on for a first time. The remote controller 100 uses the setup component (also referred to in the drawings as “Setup Wizard”) of the user interface computer program to prompt the user with successively displayed screens to enter required user specific information and preferences.

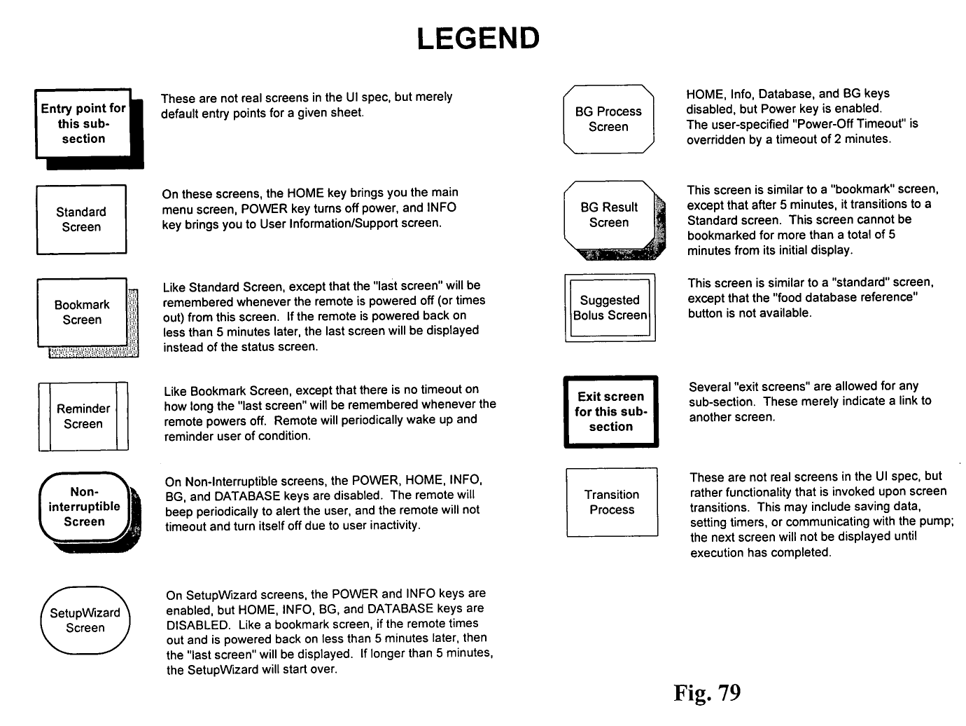

It should be noted that FIG. 79 provides a legend for use with the flow charts shown in the attached figures. It should also be understood that the flow charts shown in the attached figures illustrate methods for operating the remote controller 100 and/or computer programs for instructing the computer processor of the remote controller 100. Claims directed to methods for operating a controller of an infusion pump and/or computer programs for instructing a controller of an infusion pump are included hereinbelow. A control system of the remote controller 100 includes the computer processor of the remote controller 100 and the computer programs illustrated by the flow charts shown in the attached figures.

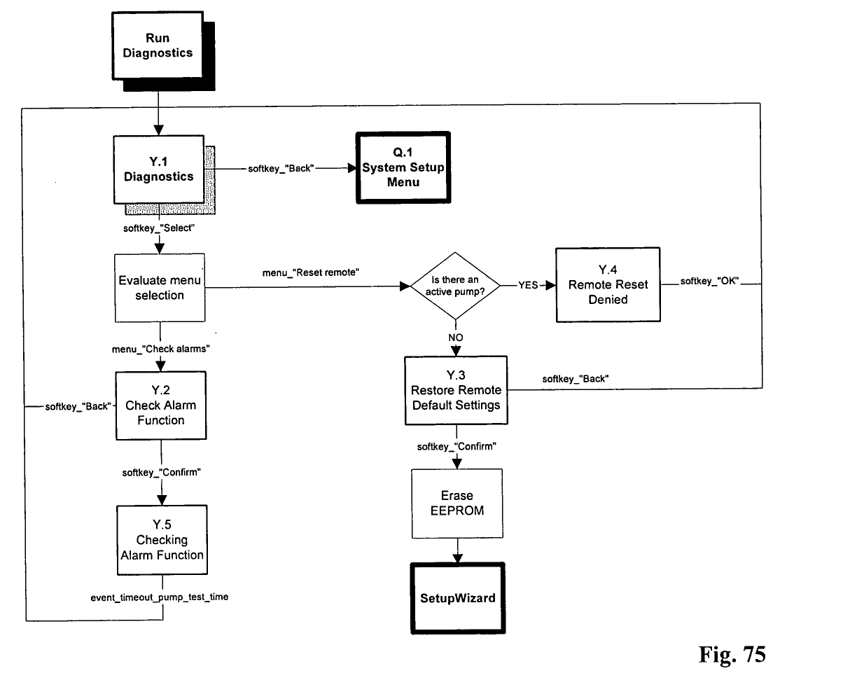

The Setup Wizard is useful for assisting a medical provider in setting up the remote controller 100 for a new patient. When turned on for the first time, the remote controller 100 will initiate the Setup Wizard. The Wizard works by presenting the user with a series of screens similar to those found in other parts of the interface. The user may not exit the Wizard until all of the settings have been filled in. At every step starting with SW.3 in FIG. 6, the left soft key selection switch 102 allows the user to go “back” to the previous step. If the remote controller 100 times-out during the Setup Wizard, and the user turns it back on within a set period, such as five minutes, it will return to the same screen location when the remote 100 is powered on. If off for more than five minutes, the remote controller 100 will erase all settings and start over. Setup Wizard values can be erased by going to the “User Diagnostic” section of the user interface program, shown in FIG. 75, and selecting “Reset Remote Defaults.

Referring to FIG. 6, a splash screen SW.1 only appears prior to the Setup Wizard. Once the remote 100 is setup, this screen will not appear again. This screen displays a brief splash screen with the insulin pump manufacturer's name, for example. After three seconds, the controller goes to the Welcome Cue screen SW.2. One of the soft key selection switches 102, 104, 106 labeled “continue” brings the user to the next step or screen.

The time and date can be set by the user at successively displayed screens, such as a Set Time screen SW.3, a Set Year screen SW.6, a Set Month screen SW.4, a Set Day screen SW.5, and a Set Date Format screen SW.7, as shown in FIG. 6.

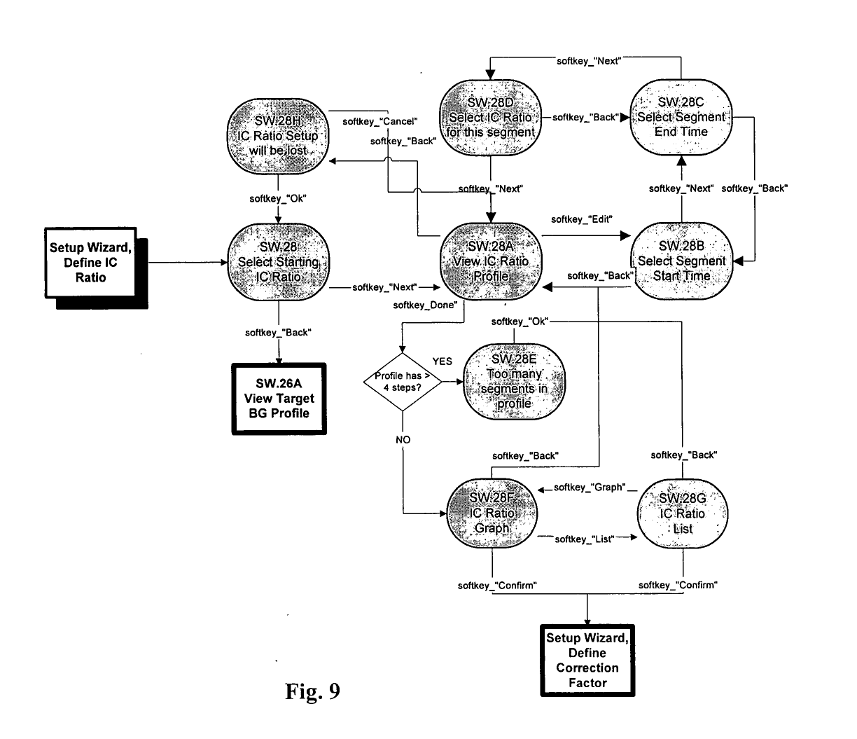

As shown in FIG. 9, a Set Bolus Increment screen, SW.8, allows the user to specify a bolus increment for use by the controller 100, while a Set Maximum Bolus Dose screen, SW.9, allows the user to specify the value for a bolus or basal setting. A flashing icon next to the number to change signifies use of the up/down navigation toggle switch 108 to change the value.

Referring back to FIG. 6, a Set Maximum Basal Rate screen SW.10 allows the user to specify the value for a bolus or basal setting. A Set Starting Basal Rate screen SW.11 allows the user to specify the initial basal rate. A Basal Rate Program View screen SW.12 shows the details of one of the basal rate programs stored in the device. The basal rate program is displayed with its default name, and is shown as a set of time segments, while a Confirm Active Basal Program Graph screen SW.12A requires the user to confirm the newly created basal rate program as the default basal program and shows the basal program graph with the option on the soft keys to show the list (SW.12B). A Confirm Active Basal Program List screen SW.12B requires the user to confirm the newly created basal rate program as the default basal program and shows the basal program list with the option on the soft keys to show the graph (SW.12A).

A Select Change Start Time time-entry screen SW.13, as shown in FIG. 6, allows the user to specify the start time for a basal rate program being created., while a Select Change End Time time-entry screen SW.14 allows the user to specify a change in the end time for the new basal program being created. A Set Basal Rate for New Segment numeric-entry screen SW.15 allows the user to specify the basal rate for the segment being created.

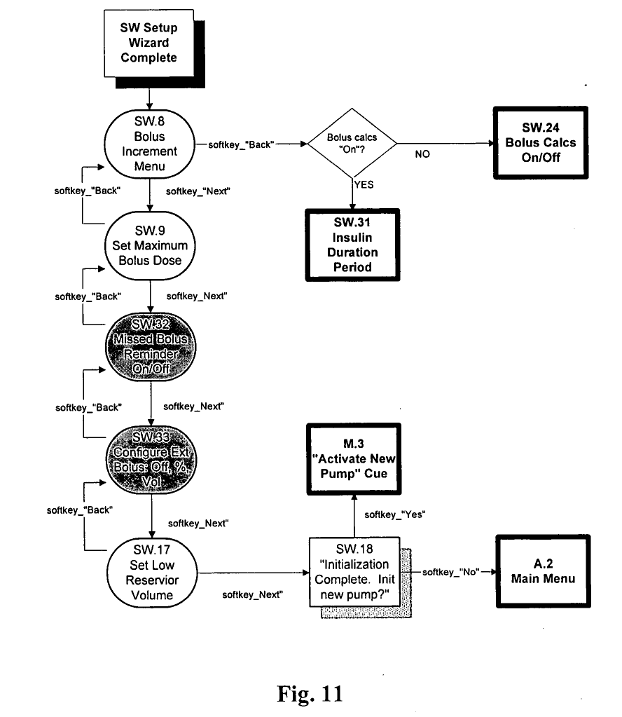

A Set Low Reservoir Volume numeric-entry screen SW.17, as shown in FIG. 11, allows the user to specify the value for the low reservoir volume. When the pump reaches this level, the pump will alert the user via an advisory alarm. An Initialization Complete Cue screen SW.18, informs the user that the remote controller 100 is setup and is ready to initialize an infusion pump 10.

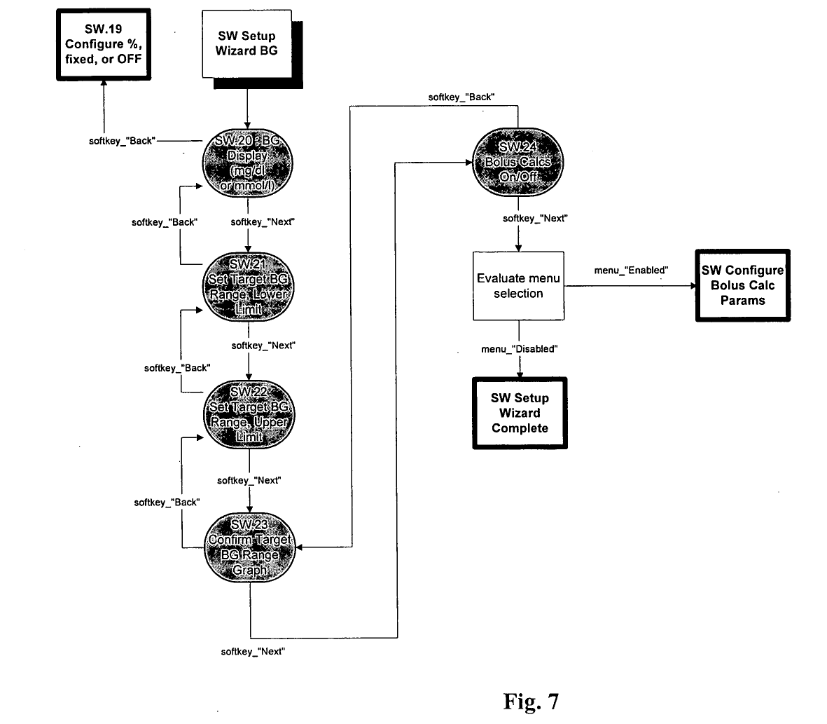

Referring back to FIG. 6, a Configure Temp Basal Mode screen SW.19 is a menu displaying three options for configuring the temporary basal rate feature. The Menu consists of the following menu options: a Select BG Meter Display Units screen SW.20, as shown in FIG. 7, is a menu displaying two options for the blood glucose meter display units. Referring to FIG. 7, the Menu consists of the following menu options: a Set Target BG Range Lower Limit numeric-entry screen SW.21, allows the user to specify the value for lower limit of the target blood glucose range, while a Set Target BG Range Upper Limit numeric-entry screen SW.22, allows the user to specify the value for upper limit of the target blood glucose range. A Confirm Target BG Range screen SW.23 displays the user's selected lower and upper range limits and asks the user to confirm.

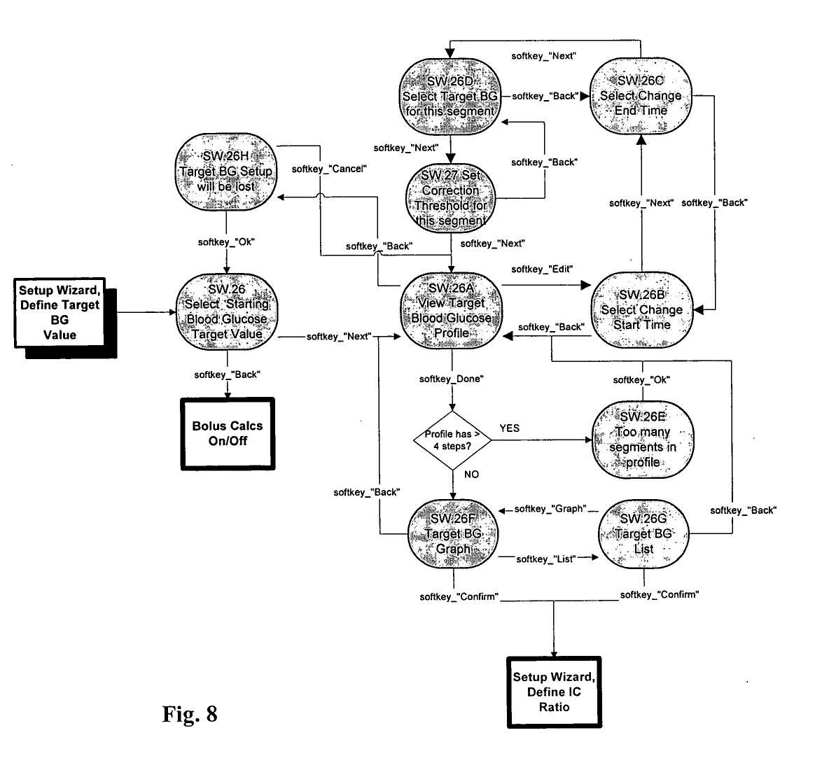

A Select Bolus Calculations Option screen SW.24 is a menu displaying two options for the “suggested bolus calculations” feature. The Menu consists of the following menu options: a Select Blood Glucose Target Value numeric-entry screen SW.26 shown in FIG. 8, allows the user to specify the target blood glucose value, which is used for correction bolus calculations, and a Set Target BG Correction Threshold numeric-entry screen SW.27 allows the user to specify the target blood glucose correction threshold value, which is used to indicate when a correction bolus should be suggested.

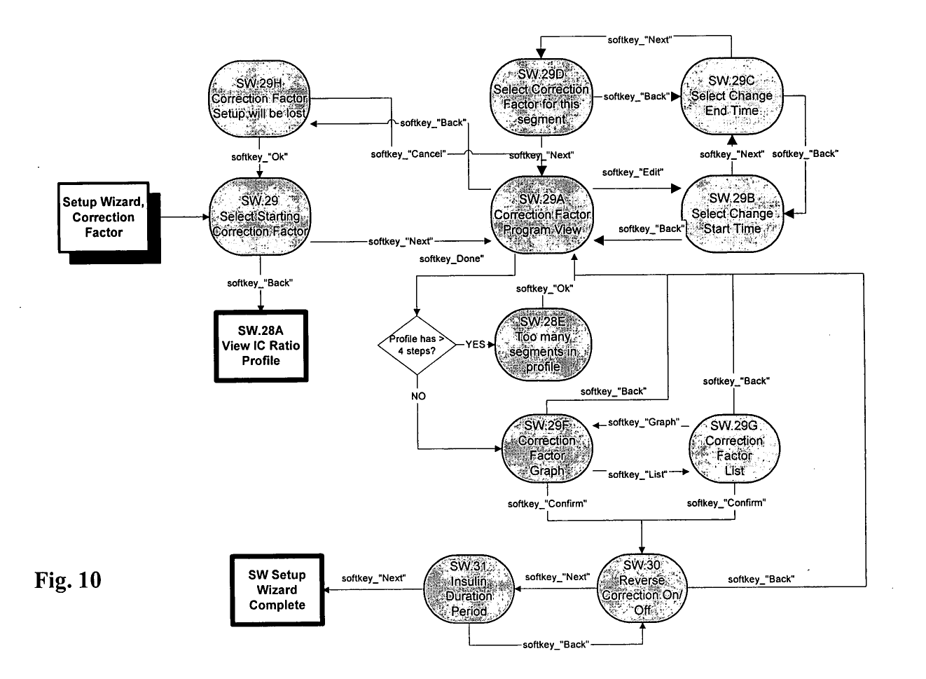

Referring to FIG. 9, a Select Starting IC Ratio numeric-entry screen SW.28 allows the user to specify the Insulin-to-Carbohydrate ratio to be used when calculating meal/carbohydrate bolus volumes, and a Select Starting Correction Factor numeric-entry screen SW.29 in FIG. 10 allows the user to specify the correction factor for the remote to use when calculating a suggested correction bolus. A Reverse Correction On/Off Option screen SW.30 is a menu allowing the user to either enable or disable a reverse correction bolus. A Select Insulin Duration Period numeric-entry screen SW.31 allows the user to specify the insulin duration period to be used for the calculation of “insulin on board”, which is considered when suggesting a correction bolus, and a Select Missed Bolus Reminder Option screen SW.32 shown in FIG. 11, which is a menu allowing the user to enable or disable the “missed bolus” reminder option. A Select Extended Bolus Option screen SW.33 is a menu allowing the user to enable or disable the extended bolus feature.

Throughout the Setup Wizard screens the user will be able to power off the remote, the status button will not function and the user info button will function. Each page will act similar to a Bookmark screen type in that if a user attempts to turn off the remote and then turn the remote on within five minutes, the remote will proceed to the last displayed SW screen. If it has been longer than five minutes, the remote will return to the beginning of the setup wizard screen SW.1.

Pump Status Request

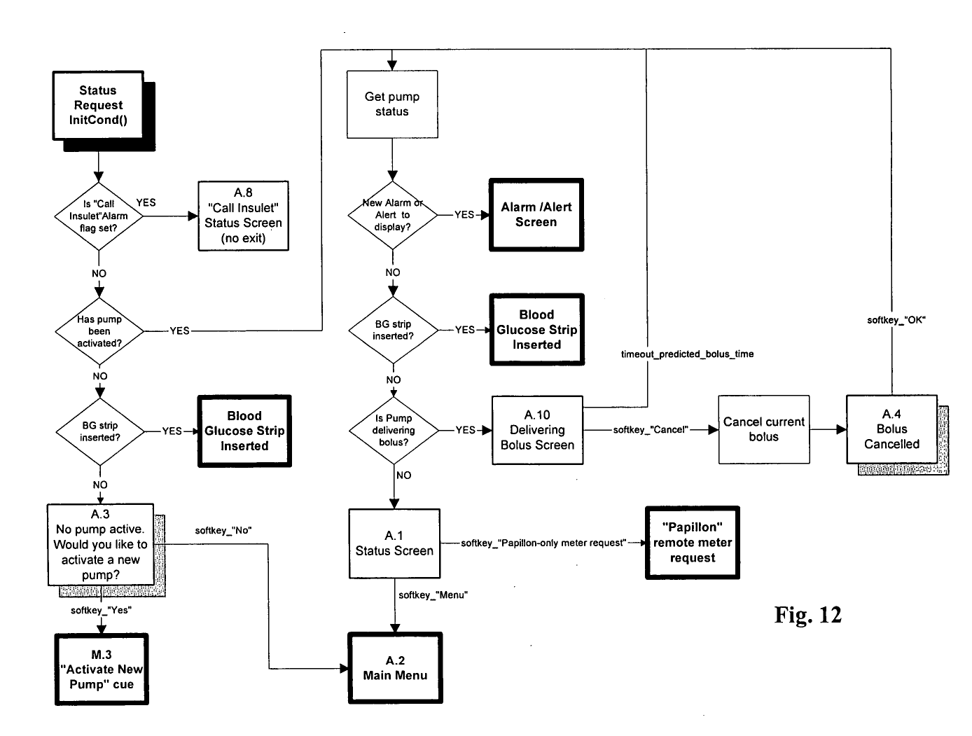

FIG. 12 is a flowchart illustrating an exemplary embodiment of an infusion pump status request component of the user interface computer program of the present disclosure, which can be operated on the remote controller 100 of FIG. 5 after the remote controller has completed the initialization setup component of FIGS. 6 through 11. The status request component is begun when a user presses one of the soft key switch 102 labeled “status” or the “check pump status” switch 114, as shown in FIG. 5.

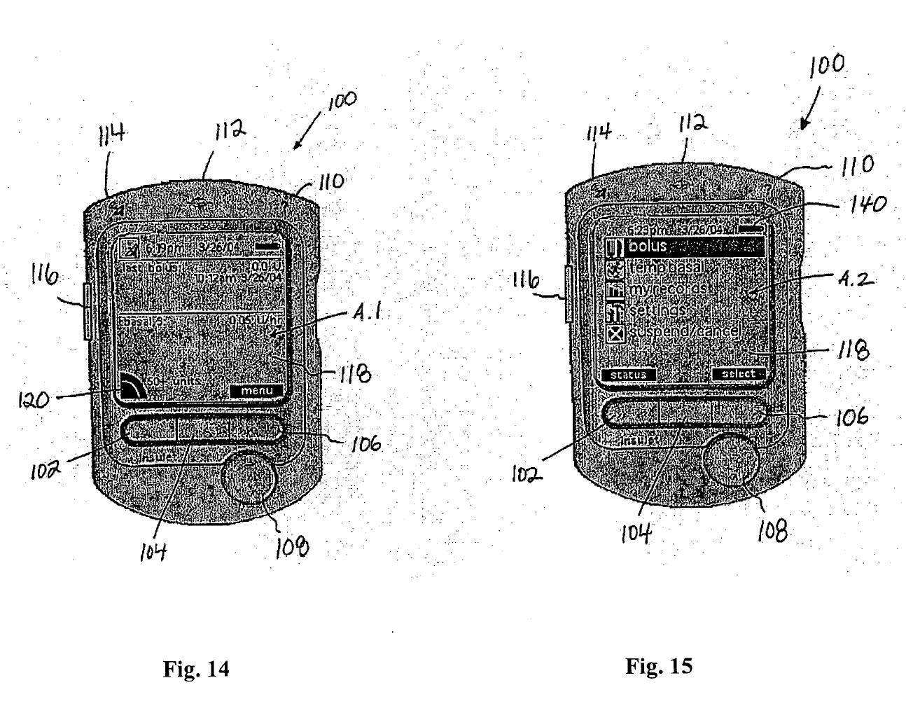

FIG. 14 is an enlarged front elevation view of the remote controller 100 of FIG. 1, wherein an exemplary embodiment of a status screen A.1 according to the present disclosure is displayed on the display 118 of the remote controller 100 after a soft key switch 102 labeled “status” on the main menu of FIG. 5 is pressed and the infusion pump status request component of FIG. 12 is run. As shown, the status screen A.1 includes an insulin gauge icon 120 that displays the amount of insulin currently remaining in the infusion pump 10. The controller of the pump 10 is programmed to report either a specific number of units, or a general value: “50+U.” Whenever the user returns to the Status Screen A.1, the controller of the remote controller 100 queries the controller of the infusion pump 10, so that the current reservoir volume can be updated, rates confirmed, and any alarm states reported. Updated information is not shown on the Status Screen A.1 until the pump status has been confirmed.

In the exemplary embodiment of FIG. 12, during a status request, the remote controller 100 first checks if a pump is activated. If a pump is activated, the controller then gets the pumps status, including whether the pump is in an alarm state, whether a glucose strip is inserted into the remote, and whether the pump is delivering a bolus. If none of these conditions are meet, then the status screen A.1 is displayed. From the status screen A.1, the main menu screen A.2 can be accessed by pressing the soft key switch 106 labeled “menu” or the glucose meter can be accessed by pressing the soft key switch labeled “meter” or by inserting a blood glucose strip into the meter.

If no pump is active, the controller checks whether a “call manufacturer” (e.g., Insulet Corporation) flag is set, and whether a glucose strip is inserted into the pump. If neither of these conditions are meet, then a “no pump active” screen A.3 is displayed. If the user selects “yes” from the no pump active screen A.3, the activate new pump screen M.3 is displayed. If the user selects “no” from the no pump active screen A.3, the main menu screen A.2 is displayed.

If the pump is in an alarm state, an alarm screen A.5 is displayed. If a blood glucose strip is inserted, then a “Blood Glucose Strip Inserted” screen is displayed, as shown at 136. If a “call manufacturer” (e.g., Insulet Corporation) flag is set, then a “Call Insulet” status screen A.8 is displayed.

Still referring to the exemplary embodiment of the pump status request component of FIG. 12, if the pump is delivering a bolus dose, then a “Delivering Bolus” screen A.10 is displayed. A user is then provided an opportunity to cancel the bolus dose, as shown at screen A.4.

From the status screen A.1, as shown in FIG. 12, the blood glucose meter can be requested or the main menu can be requested, as shown at A.2.

Main Menu

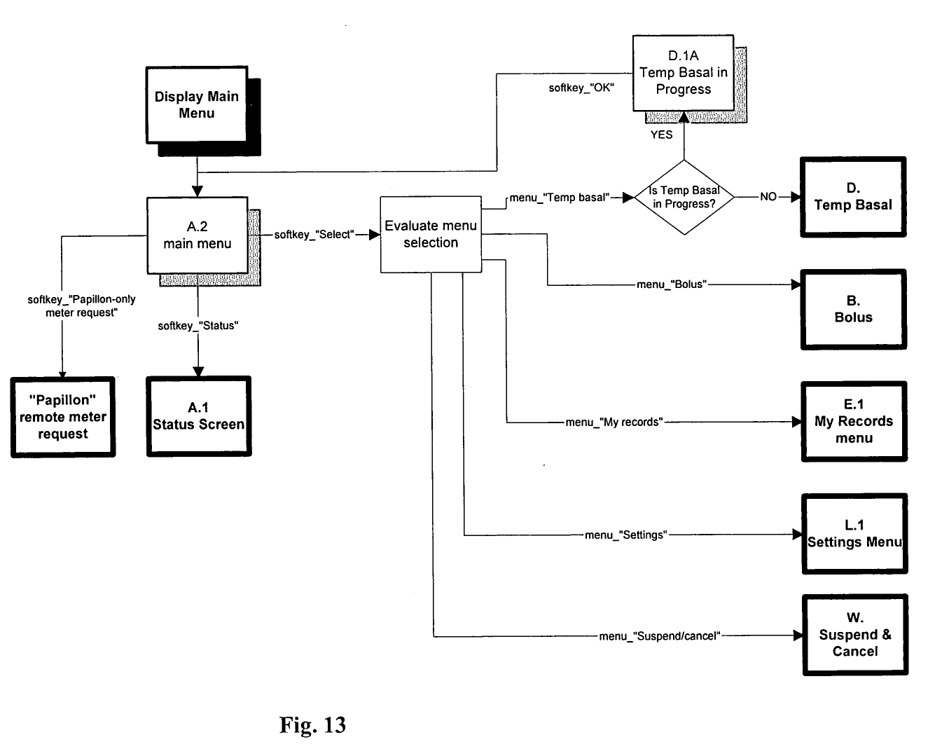

FIG. 13 is a flowchart illustrating an exemplary embodiment of a main menu component of a user interface computer program according to the present disclosure, which can be operated on the remote controller of FIG. 5 after the remote controller 100 has completed the initialization setup component of FIGS. 6 through 11. The main menu screen A.2 is displayed when a user presses the soft key switch 106 labeled “menu”, as shown in FIG. 14. The main menu screen A.2 is also displayed whenever the remote controller 100 is turned on (but after the remote controller 100 has completed the initialization setup component of FIGS. 6 through 11).

FIG. 15 is an enlarged front elevation view of the remote controller of FIG. 1, wherein an exemplary embodiment of a main menu screen is displayed on the display of the remote controller after a soft key labeled “menu” on the status screen of FIG. 14 is pressed. The main menu screen A.2 displays the current date and time, and an icon 140 representing a level of battery charge remaining in the remote controller 100.

The main menu screen A.2 allows a user to select between several listed options. In the exemplary embodiment shown in FIG. 15, the options include a “bolus” selection, a “temp basal” selection, a “my records” selection, a “settings” selection and a “suspend/cancel” selection. In the exemplary embodiment shown in FIG. 13, the options include a “temp basal” selection D, a “bolus” selection B, a “my records” selection E.1, a “settings menu” selection L.1, and a “suspend/cancel” selection W. Before the “temp basal” screen D is displayed, the controller checks whether a temporary basal dosage is already being delivered, as shown in screen D.1A. From the main menu A.2, as shown in FIG. 13, the blood glucose meter can also be requested.

Glucose Meter Operating Submenu

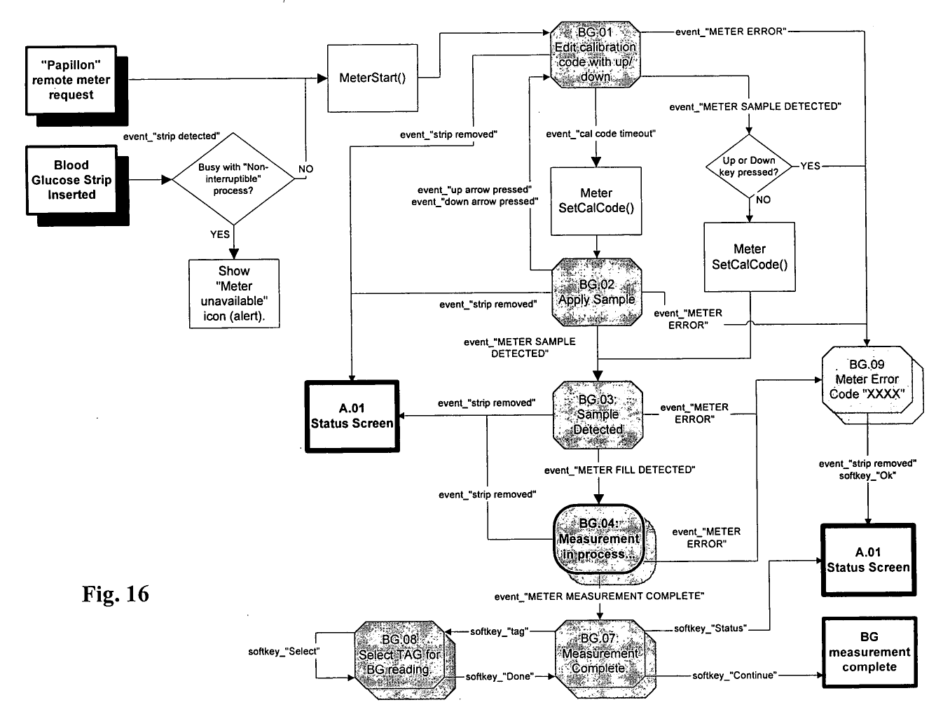

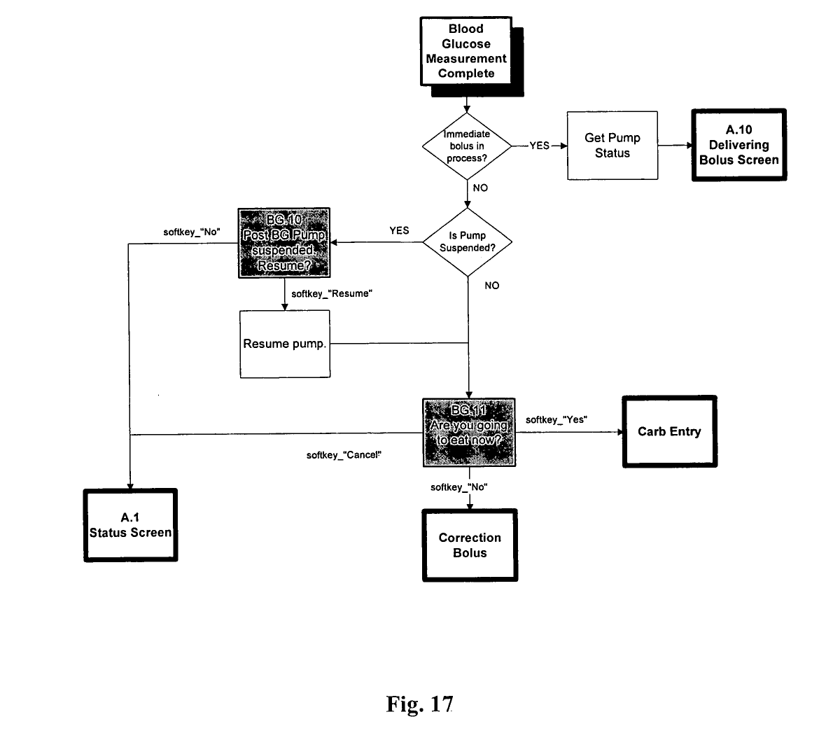

FIGS. 16 and 17 are flowcharts illustrating an exemplary embodiment of a glucose meter operating component of a user interface computer program according to the present disclosure, which can be selected from the menu of FIG. 13. An Enter Calibration Code screen BG.01 is a numeric-entry screen that allows the user to specify the strip calibration code to be used for the blood glucose measurement. A flashing icon next to the number to change signifies use of the Up/Down Controller Button to change the value. The user can either edit the displayed value or accept it. If the user does not modify the displayed calibration code within 2 seconds, the remote will accept the previous reading and move to the Apply Sample BG.02 screen. If the user removes the strip while on this screen, the Status Screen A.1 will be displayed.

The Apply Sample screen BG.02 prompts the user to apply a blood drop to the calibration strip. This screen will be displayed until a sample is detected. When the sample is detected, the user interface program will transition to a Sample Detected screen BG.03. If the user does not apply a sample within 120 seconds, the remote will turn itself off. If the user removes the strip while on this screen, the Main Menu will be displayed. If the meter reports the temperature is outside it's normal operating range, then the remote will display the “temperature out of range” icon on the screen. If the user removes the strip while on this screen, the Status Screen A.1 will be displayed.

The Sample Detected screen BG.03 is displayed once the meter detects a valid signal. An audible alert accompanies entry into this screen. The Sample Detected screen BG.03 indicates that blood has been detected, but not yet enough to perform a reading. The user should continue to apply the sample. If the user does not apply adequate sample within a predetermined period, such as two minutes, the remote will generate an error and proceed to the error screen. If the user removes the strip while on this screen, the Status Screen A.1 will be displayed. If the temperature reported by the meter is outside it's normal operating range, then the remote will display the “temperature out of range” icon on the screen. Once an adequate sample has been detected, the user interface transitions to a Blood Glucose Measurement in Process screen BG.04.

The Blood Glucose Measurement in Process screen BG.04 is displayed while the processing takes place. If the temperature reported by the meter is outside it's normal operating range, then the remote will display the “temperature out of range” icon on the screen. When the processing completes, the user interface proceeds to a Blood Glucose Measurement Complete screen BG.07. If processing does not complete within 2 minutes, the screen will transition to a Blood Glucose Measurement Error screen BG.09.

The Blood Glucose Measurement Complete screen BG.07 is displayed when the measurement has completed successfully and displays the blood glucose measurement and units. A Low Blood Glucose Measurement screen is displayed when the measurement has completed successfully, but the reading is under 20 mg/dl, while a High Blood Glucose Measurement screen is displayed when the measurement has completed successfully, but the reading is over 500 mg/dl.

A Tag Blood Glucose Measurement screen BG.08 allows the user to select a “tag” from a fixed menu list of options: pre-meal, post-meal, missed bolus, exercise (light), exercise (moderate), exercise (strenuous), sick, ketones (neg), ketones (trace), ketones (small), ketones (moderate), ketones (large), skipped meal, CHO guess, fasting, pump evaluation—start, pump evaluation—stop. Next to each tag on the list will appear a “checkbox” icon, that is either empty or checked. From this list, the user is allowed to select two tags. Once a tag is selected, the icon next to it is updated, and the “Select” softkey will change to “Remove”. Once two tags have been selected, the softkey will be blank, unless the checked tags are highlighted, in which case it will read “Remove”.

After the completion of a blood glucose reading, if suggested bolus calculations are enabled, then this screen is displayed if the pump is currently suspended. It prompts the user whether to resume the pump or not at screen BG.10. If the user does not choose to resume, then no further calculations pertaining to a bolus are done. If the user does choose to resume or the pump is running, then a Are you going to Eat Now screen BG.11 is displayed, giving the user the option of proceeding to the carbohydrate entry process or the correction bolus process.

“Bolus” Submenu

The user is able to enter the total amount of a bolus to be delivered. If the user has configured the remote to enable the extended bolus feature, the user is able to request that the pump deliver: All of the bolus immediately; All of the bolus over a specified time period (extended bolus); or A portion of the bolus immediately and the remainder of the bolus over a specified time period (extended bolus). The user is able to specify the extended bolus amount either by volume or by a percentage of the total bolus volume. If the extended bolus feature has been disabled by the user, then the entire bolus is programmed for immediate delivery.

During extended bolus delivery, the remote 100 allows the user to initiate an immediate bolus delivery. The remote 100 recalculates the bolus and reprograms the pump 10 to deliver the immediate bolus first, then resume delivery of the extended bolus.

The remote is programmed to require the user to specify a maximum bolus volume and the remote does not allow the user to manually specify a single bolus that exceeds this maximum bolus limit. If the user has enabled suggested bolus calculations, the remote warns the user if a bolus suggested by the remote exceeds this maximum bolus limit.

The user is able to cancel an immediate bolus that is currently being delivered and an extended bolus that is currently being delivered. If the user programmed a bolus with an immediate portion and an extended portion, when the user cancels the bolus, the remote programs the pump to cancel both the immediate and the extended portions. If the user programmed an immediate and an extended bolus separately, then the remote programs the pump to cancel the immediate bolus only. After canceling an immediate bolus, the software displays the amount of bolus insulin delivered before the immediate bolus was cancelled.

The user has the ability to enable or disable suggested bolus calculations through the Setup Wizard and through configuration screens. If the system is configured to have “suggested bolus calculations” disabled, then the user is able to program a bolus using custom bolus presets.

Suggested bolus calculations depend upon user-settable variables, some of which can have multiple settings dependent upon time. When the remote suggests a bolus volume, it will utilize the current values of each of these variables, even if the user has configured the variable to change in near future.

The remote 100 is programmed not to suggest a bolus to the user if the current blood glucose reading is below a predefined lower level or above a predefine upper level. If the user has enabled the extended bolus feature, the user is not allowed to extend the “correction” component of a suggested bolus, but is allowed to extend the “meal” component of a suggested bolus.

The remote controller 100 is programmed to calculate a suggested bolus dose equal to a correction bolus minus insulin on board the patient plus a carbohydrate bolus, if the current blood glucose value is above the target blood glucose. The correction bolus is equal to the current blood glucose minus the target blood glucose divided by the correction factor. The insulin on board is equal to, for each previous bolus dose administered to the patient within the duration of insulin action, a total correction volume of the previous bolus dose, in units, multiplied by one minus an elapsed time in minutes since the previous bolus was administered divided by the duration of insulin action, in minutes. The carbohydrate bolus is equal to the grams of carbohydrates minus the grams of fiber divided by the insulin to carbohydrate ratio.

The suggested bolus dosage is equal to a reverse correction bolus plus the carbohydrate bolus if the current blood glucose value is less than the target blood glucose value, and the user has enabled reverse correction boluses through the user interface components. The suggested bolus dosage is equal to the carbohydrate bolus if the current blood glucose value is less than the target blood glucose value, and the user has disabled reverse correction boluses through the user interface components. The suggested bolus dose is equal to the carbohydrate bolus if the current blood glucose value is unknown. A bolus dose is not suggested to the user if the current blood glucose reading is outside of a predetermined range.

If the suggested bolus calculated by the remote exceeds the maximum bolus volume configured by the user, the remote informs the user that this bolus would exceed that limit, and offer the user the option to cancel or temporarily override this limit. If the user decides to temporarily override the maximum bolus limit to deliver a suggested bolus, the remote indicates this override within the bolus history.

When the user initiates the programming of a bolus and suggested bolus calculations are enabled, if the remote does not have a current blood glucose result, then the remote provides the user with the option of manually entering a blood glucose result.

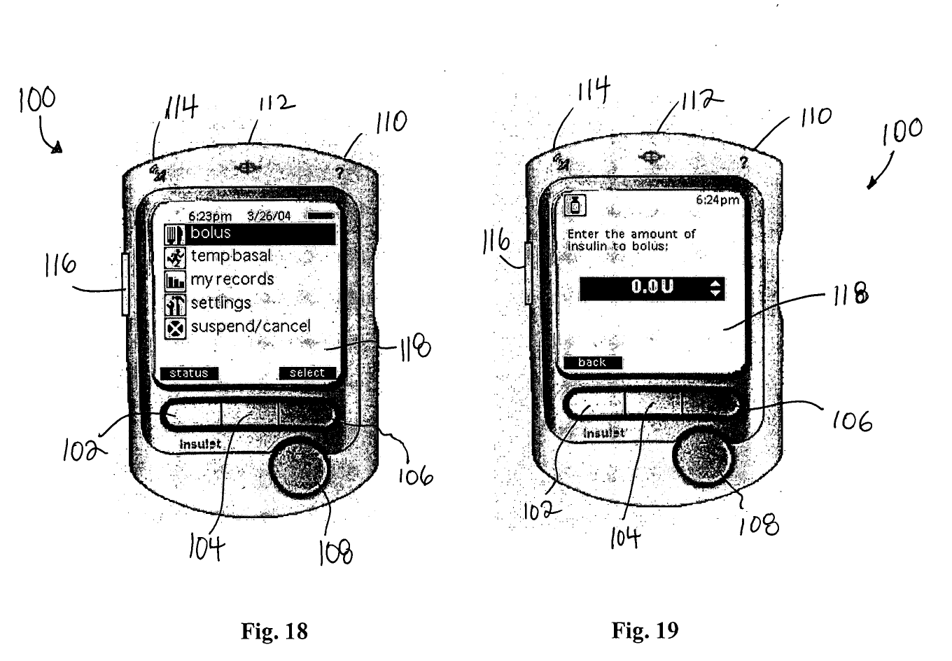

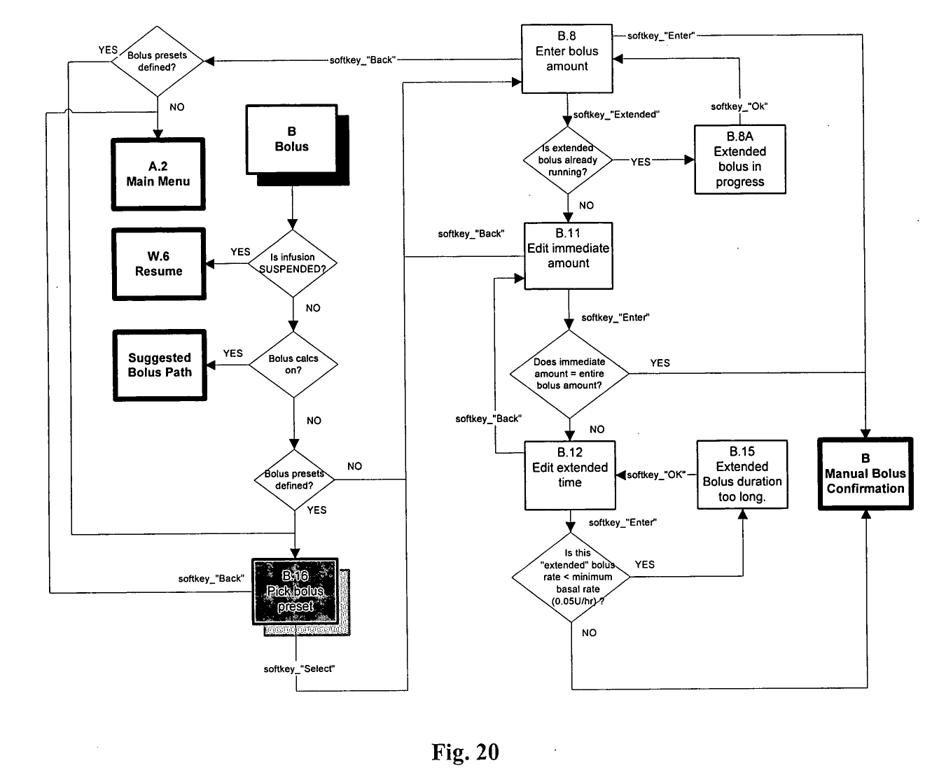

FIG. 18 is a front elevation view of the remote controller of FIG. 5, wherein the menu screen is displayed on the remote controller and a “bolus” submenu selection is highlighted, while FIG. 19 is a front elevation view of the remote controller after the “bolus” submenu has been selected from the menu screen of FIG. 18.

FIGS. 20 through 25 are flowcharts illustrating an exemplary embodiment of a bolus submenu component of a user interface computer program according to the present disclosure, which is operated on the remote controller after the “bolus” submenu has been selected. The bolus submenu includes an Edit Bolus B.08 numeric-entry screen that allows the user to specify the number of units of insulin to bolus. A flashing icon next to the number to change signifies use of the Up/Down Controller Button to change the value. An Extended Bolus Currently Active screen B.08A informs the user that there is an extended bolus currently active due to the fact that they have just “clicked” on extended button the Edit Bolus screen B.8.

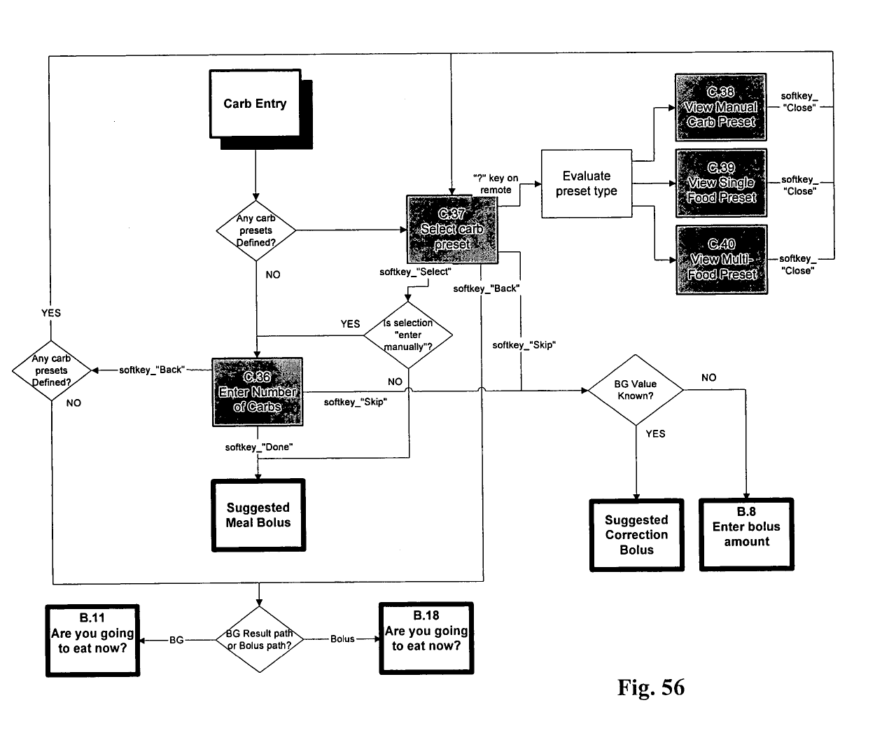

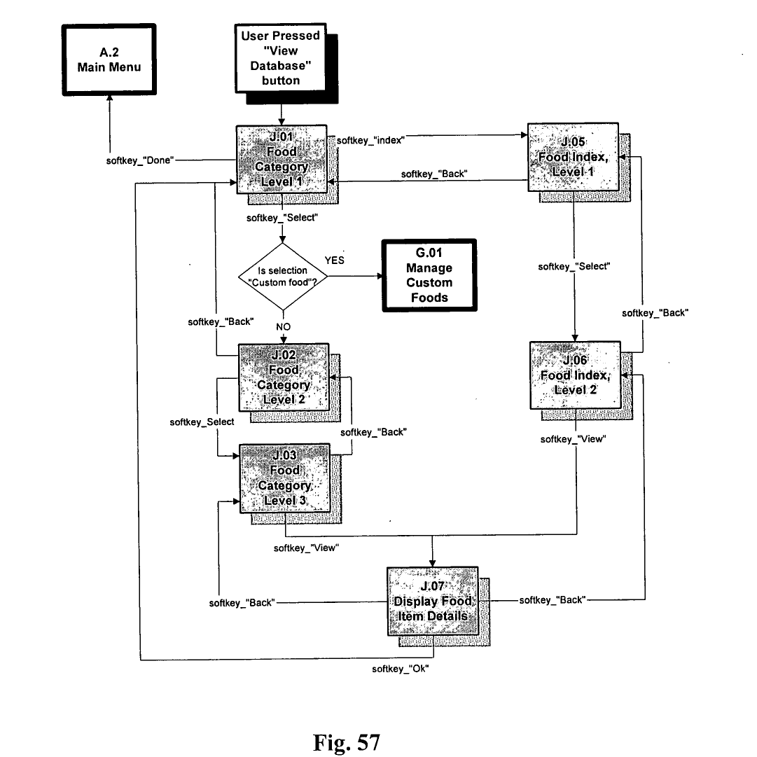

A Confirm Bolus screen B.10 requires the user to confirm the amount of insulin to be delivered, or to specify no insulin be delivered, while an Edit Immediate Amount B.11 numeric-entry screen allows the user to specify the number of units of insulin or % of total bolus to take immediately. The entry method depends upon the user's configuration of the extended bolus feature. A flashing icon next to the number to change signifies use of the Up/Down Controller Button to change the value. The Edit Immediate Amount B.111 numeric-entry screen is also shown in FIG. 56 as part of the carbohydrate entry submenu (discussed below).

An Edit Extended Time B.12 duration-entry screen allows the user to specify the amount of time over which to spread the amount of an extended bolus not taken immediately. A flashing icon next to the number to change signifies use of the Up/Down Controller Button to change the value.

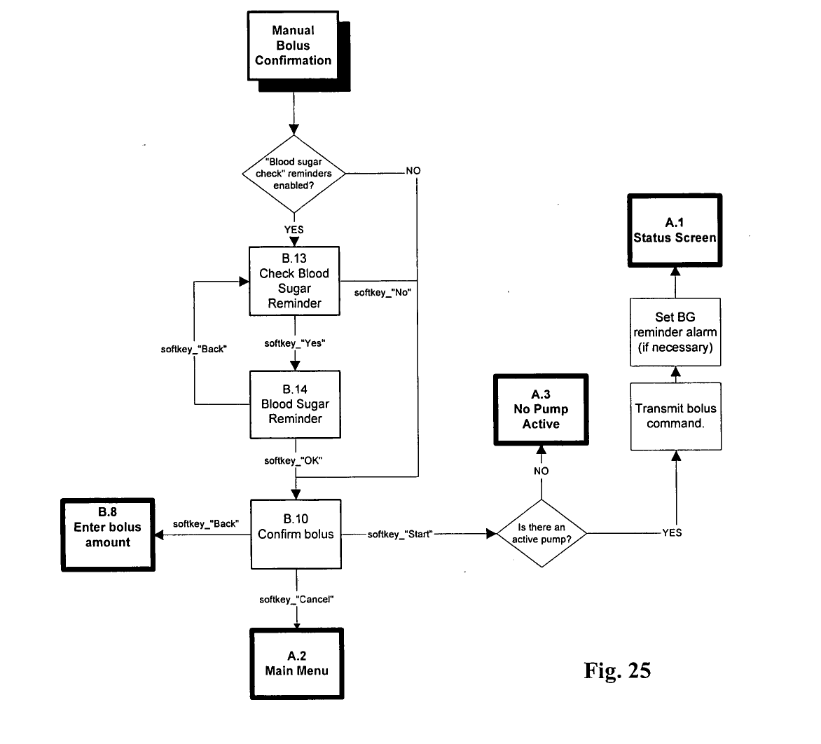

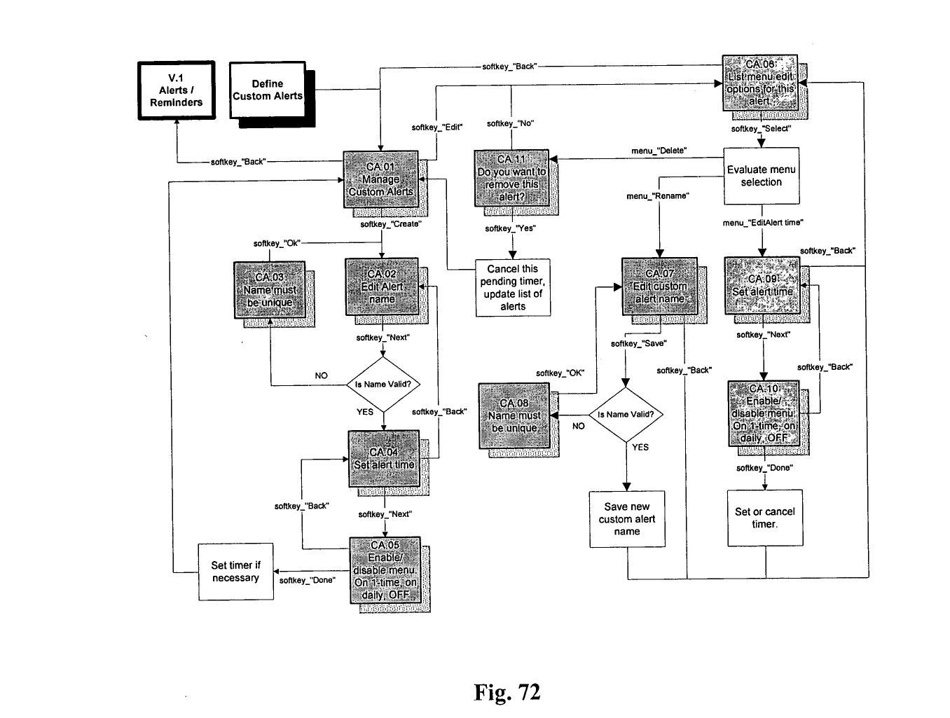

A Check Blood Glucose Reminder screen B.13, in FIG. 25, asks the user if they would like to be reminded to check their blood glucose. The blood glucose reminder options setting is located in the Alarms & Alerts Menu of FIG. 72. The Blood Glucose Reminder screen B.14, in FIG. 25, asks the user when (in hours) they would like a reminder to check their blood glucose, and a Blood Glucose Alert screen reminds the user to check their blood glucose level.

An Extended Bolus Duration too Long screen B.15, in FIG. 20, indicates to the user that they have specified an extended bolus duration that will result in an hourly delivery that is smaller than the minimum operational rate of the pump. A Select Bolus Preset screen B.16 lists bolus presets if bolus presets are enabled and have been defined by the user.

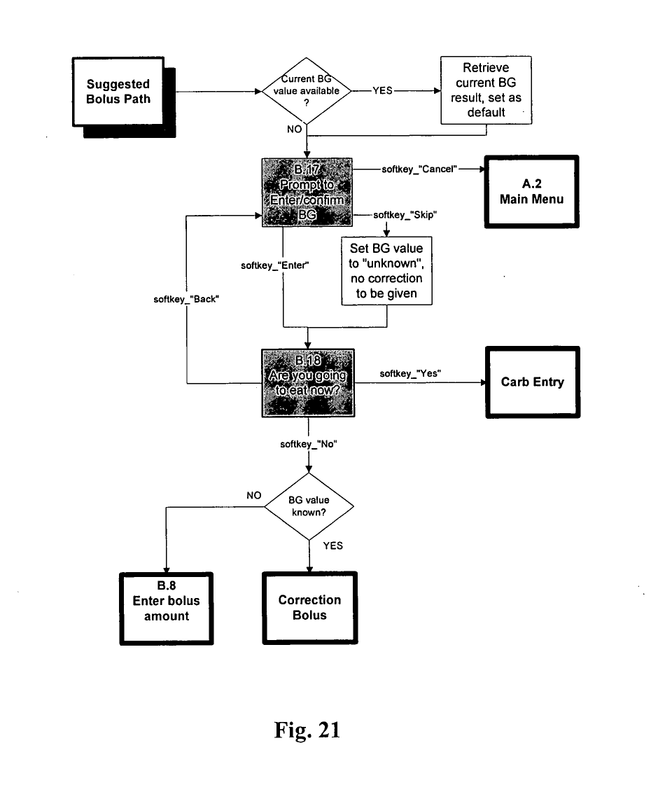

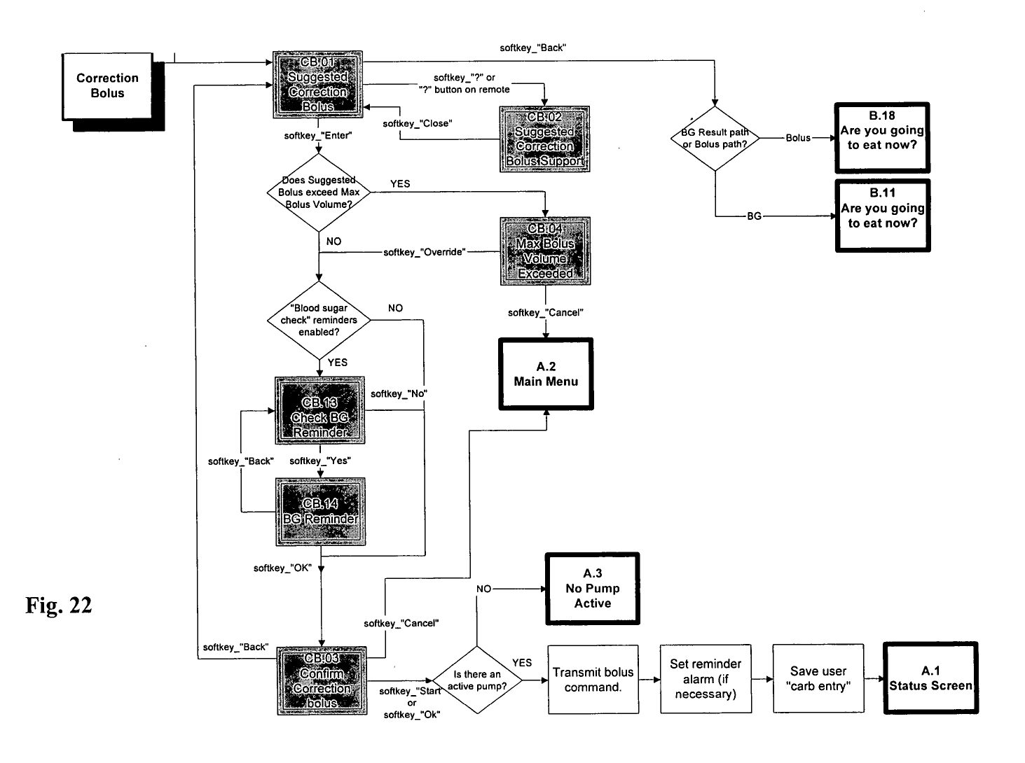

An Enter BG value screen B.17, in FIG. 21, will be presented to the user whenever they select the “Bolus” menu option from the main menu if the user has enabled “suggested bolus” calculations (as long as a pump is active and it is not suspended). This screen prompts the user to enter a BG value to be used for a correction bolus. The user has the option of “skipping” this screen if a correction bolus is not desired. A Prompt for Carb Entry screen B.18 gives the user the option of proceeding to the carbohydrate entry process. The Prompt for Carb Entry screen B.18 is also shown in FIG. 56 as part of the carbohydrate entry submenu.

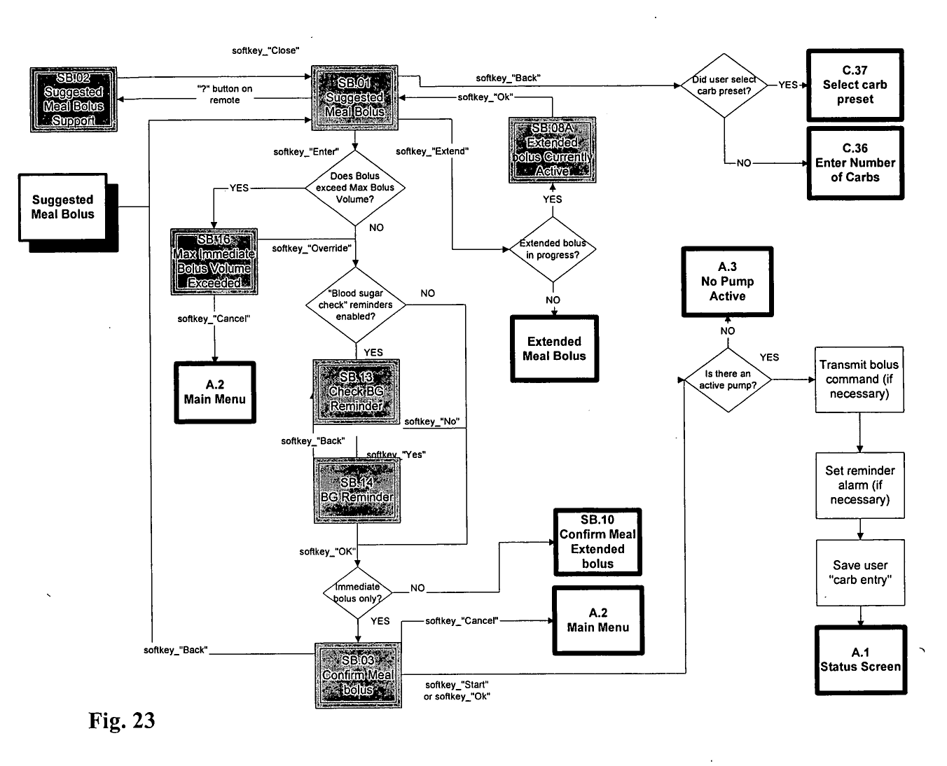

In FIG. 23, a Suggested Correction Bolus CB.01 screen displays the suggested meal bolus and supporting information to a user. In addition to the prompt indicating the suggested bolus volume, there is a numeric-entry field that allows the user to adjust the programmed volume. The programmed volume defaults to the suggested volume. A flashing icon next to this field signifies use of the Up/Down Controller Button to change the value.

A Suggested Correction Bolus Support CB.02 screen displays the details of the calculations and variables used to generate the suggested meal bolus to a user upon pressing the info/support hard key “?.” A Confirm Suggested Correction Bolus CB.03 screen displays the suggested meal bolus to a user for confirmation to deliver.

A Max Bolus Volume Exceeded CB.04 screen informs the user that the current bolus volume exceeds the user-specified max bolus limit. The user is given the option to temporarily override this limit or to cancel.

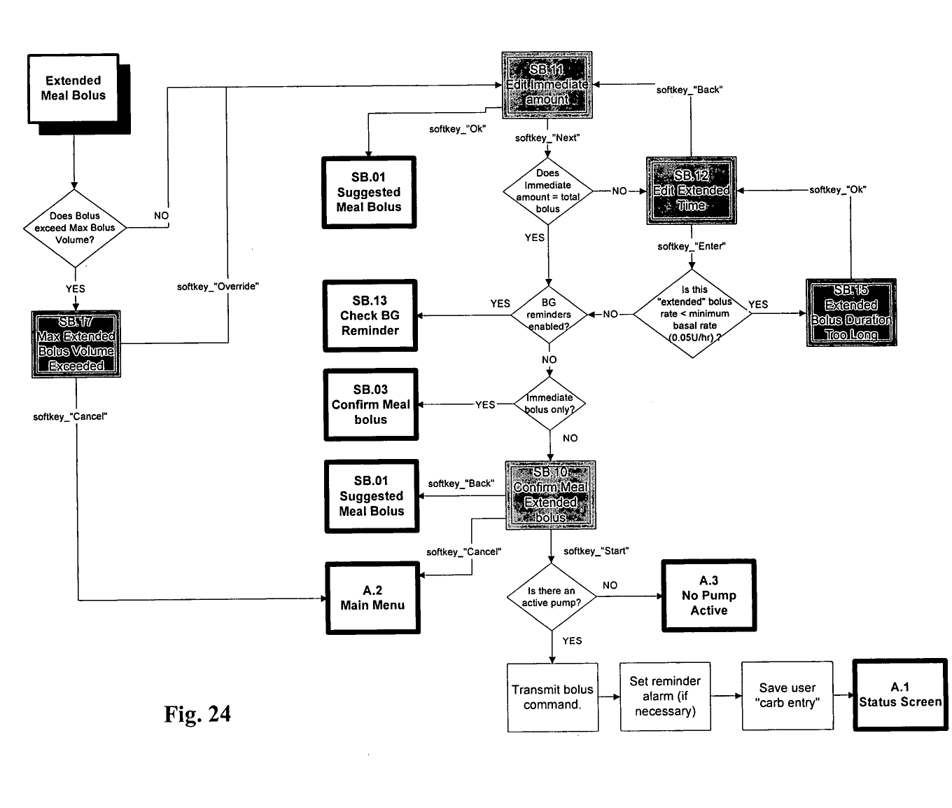

In FIGS. 24 and 25 a Suggested Meal Bolus SB.01 screen displays the suggested meal bolus and supporting information to a user. In addition to the prompt indicating the suggested bolus volume, there is a numeric-entry field that allows the user to adjust the programmed volume. The programmed volume defaults to the suggested volume. A Suggested Meal Bolus Support SB.02 screen displays the details of the calculations and variables used to generate the suggested meal bolus to a user upon pressing the user support hard key “?.”

A Confirm Suggested Meal Bolus SB.03 screen displays the suggested meal bolus to a user for confirmation to deliver. An Edit Immediate Amount SB.11 numeric-entry screen allows the user to specify the number of units of insulin or % of the meal bolus to take immediately. The entry method depends upon the user's configuration of the extended bolus feature.

An Edit Extended Time SB.12 duration-entry screen allows the user to specify the amount of time over which to spread the amount of an extended bolus not taken immediately. An Extended Bolus Currently Active SB.8A screen informs the user that there is an extended bolus currently active. A Confirm Suggested Meal Bolus with Extend SB.10 screen requires the user to confirm the amount of insulin to be delivered, or to specify no insulin be delivered.

An Extended Bolus Duration too Long SB.15 screen indicates to the user that they have specified an extended bolus duration that will result in an hourly delivery that is smaller than 0.05 units (the minimum operational rate of the pump). A Max Immediate Bolus Volume Exceeded SB.16 screen informs the user that the current bolus volume exceeds the user-specified max bolus limit. The user is given the option to temporarily override this limit or to cancel. A Max Extended Bolus Volume Exceeded SB.17 screen informs the user that the current bolus volume exceeds the user-specified max bolus limit. The user is given the option to temporarily override this limit or to cancel.

“Temporary Basal” Submenu

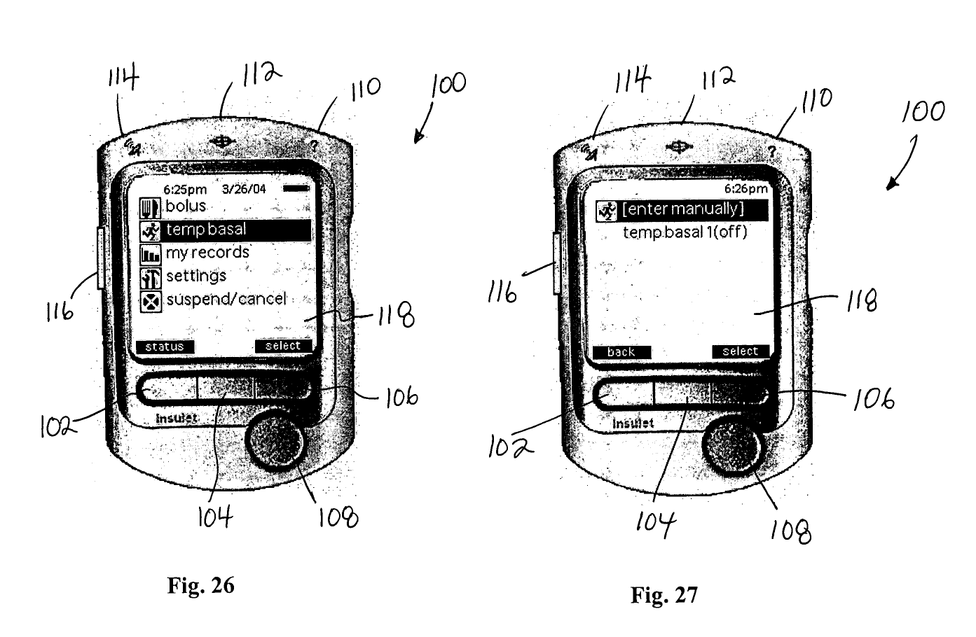

FIG. 26 is a front elevation view of the remote controller of FIG. 5, wherein the menu screen is displayed on the remote controller and a “temporary basal” submenu selection is highlighted, and FIG. 27 is a front elevation view of the remote controller after the “temporary basal” submenu has been selected from the menu screen of FIG. 26.

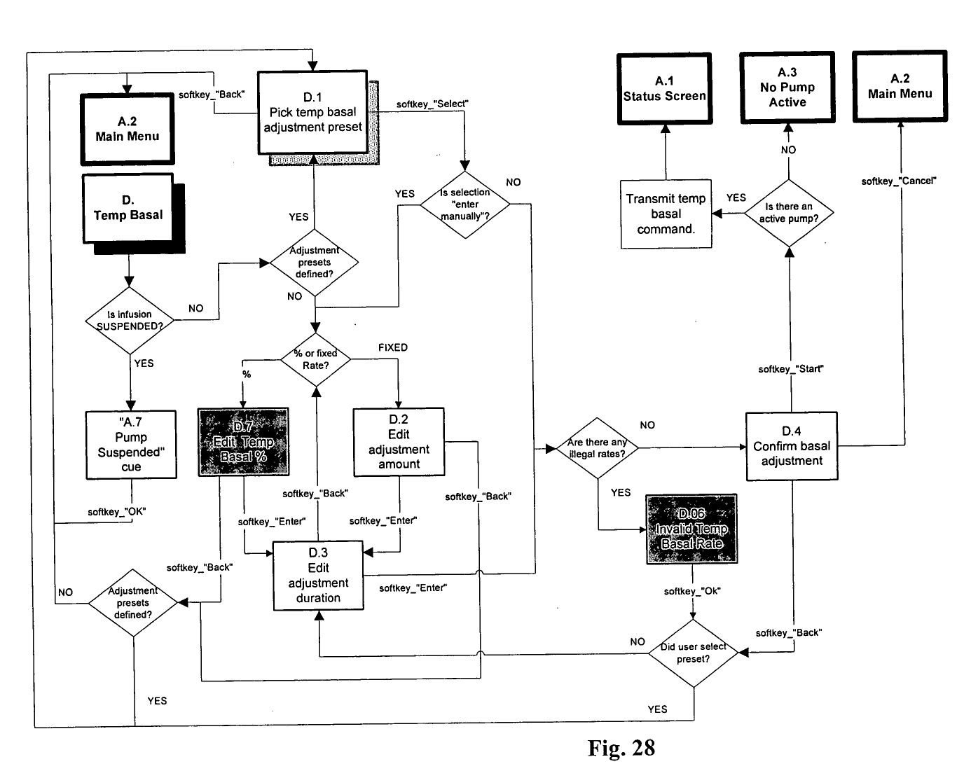

FIG. 28 is a flowchart illustrating an exemplary embodiment of a temporary basal submenu of a user interface computer program according to the present disclosure, which can be operated on the remote controller of FIG. 5, after the “temporary basal” submenu has been selected. The “temporary basal” submenu includes a Pick Temp Basal Rate Presets D.01 screen that list Temp Basal Rate presets defined by the user, if any.

An Edit Temp Basal Rate Amount D.02 numeric-entry screen allows the user to specify the rate of delivery for the duration of the temporary basal rate. An Edit Temp Basal Rate Duration D.03 duration-entry screen allows the user to specify the duration of the temp basal rate. A Confirm Temp Basal Rate D.04 screen requires the user to confirm the temp basal rate. An Invalid Temp Basal Adjustment Rate D.06 screen informs the user that the temp basal adjustment that the user has selected, for the duration selected, will result in a flow rate that is beyond the flow rate range of the pump.

An Edit Temp Basal Adjustment Percentage D.07 numeric-entry screen allows the user to specify the percentage adjustment of the basal rate for the duration of the temporary basal rate.

New basal rate instructions then create a temporary basal rate delivery program using the delivery rate input by the user for the temporary basal rate, and calculates the end time based on the start time and the duration, if the duration is entered for the temporary basal rate. A new basal rate delivery program is then created by inserting the temporary basal rate delivery program into an existing basal rate delivery program between the start time and the end time.

Patient's Records Submenu

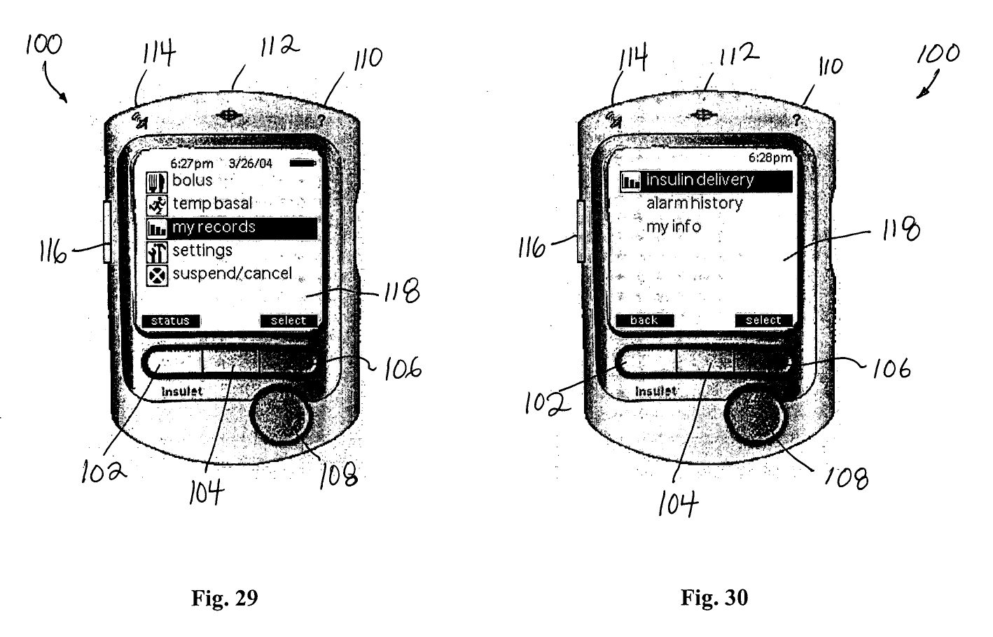

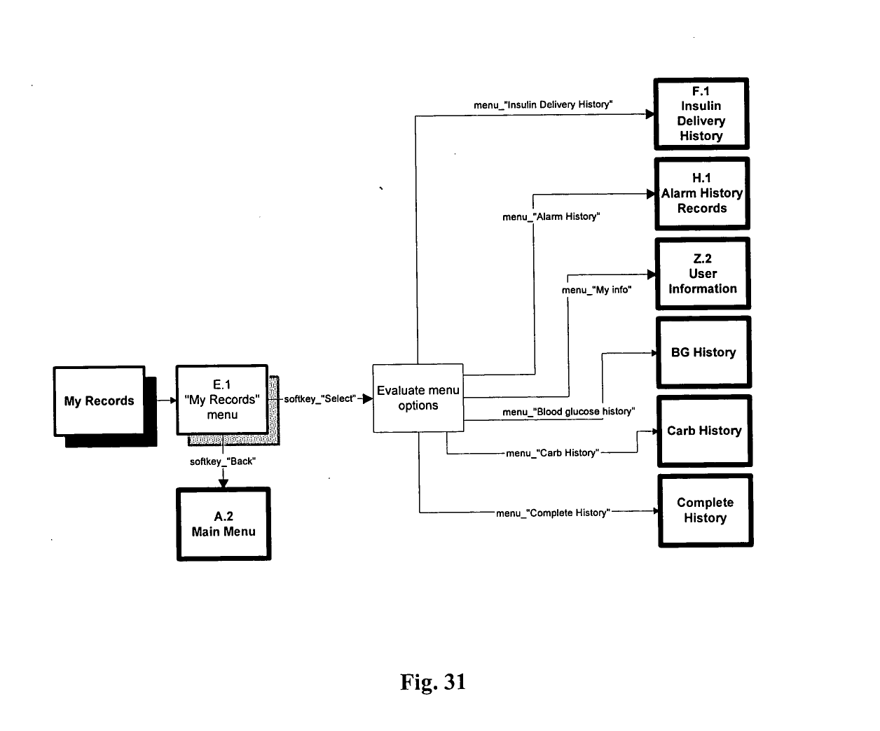

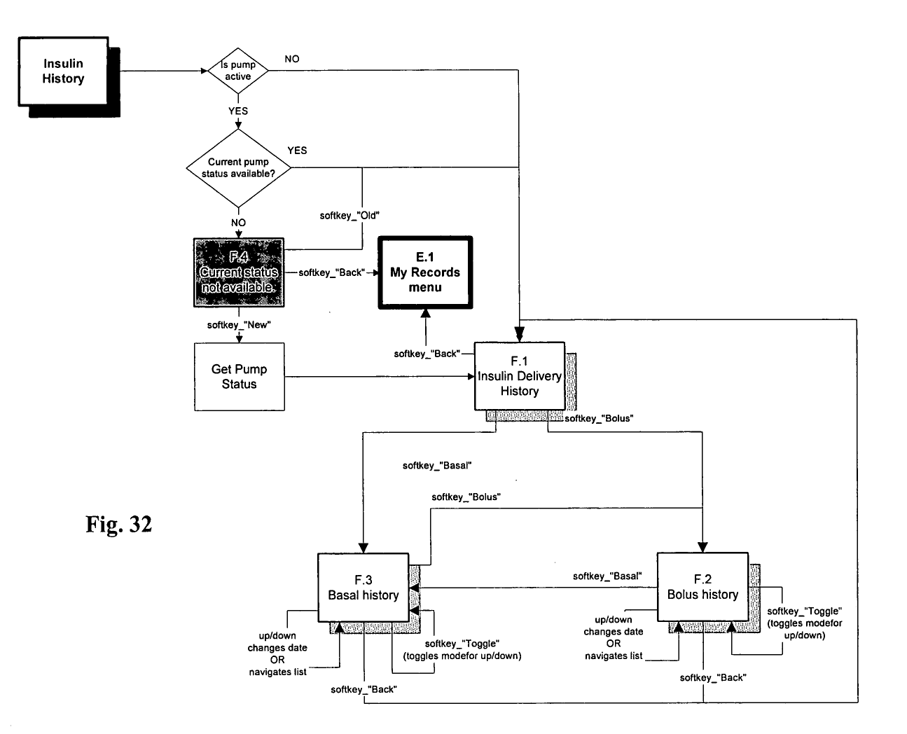

FIG. 29 is a front elevation view of the remote controller of FIG. 5, wherein the menu screen is displayed on the remote controller and a “my records” submenu selection is highlighted, while FIG. 30 is a front elevation view of the remote controller after the “my records” submenu has been selected from the menu screen of FIG. 29. FIGS. 31 through 37 are flowcharts illustrating an exemplary embodiment of a records submenu of a user interface computer program according to the present disclosure, which is operated on the remote controller of FIG. 5 after the “my records” submenu has been selected.

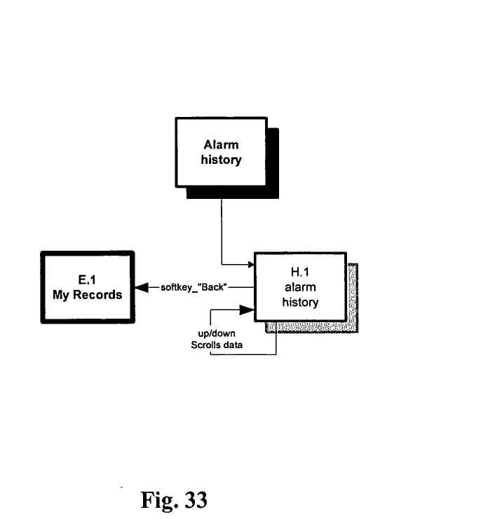

An exemplary embodiment of a “my records” submenu shown in FIG. 31 includes a My Records menu E.1 screen. From this screen an Insulin Delivery History F.01 screen lists the insulin delivery history of the device, and is also shown in FIG. 33 and includes basal rate histories and bolus dose histories.

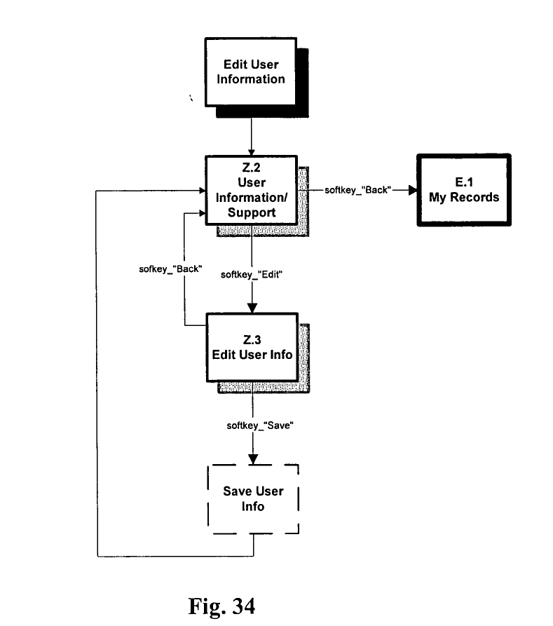

An Alarm History H.01 screen, from the “my records” submenu in FIG. 31, lists the alarm history of the device and is also shown in FIG. 33. User Info Screen Specifications Z.1-Z.3 screens show information about the user of the device along with product specific information (ex. name, address, and phone number can be entered), as also shown in FIG. 34.

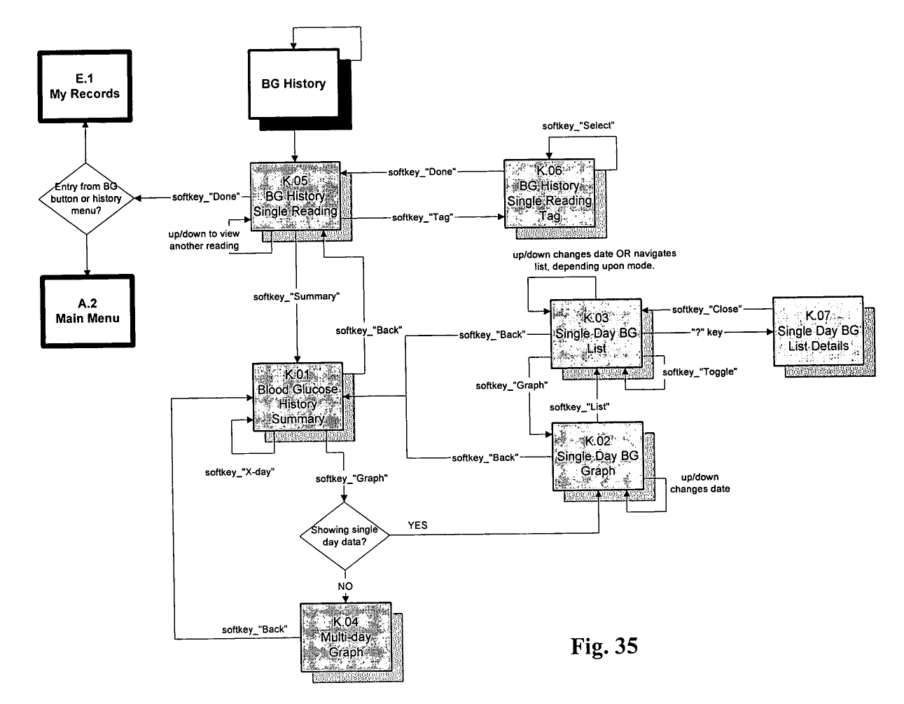

A BG History Summary K.01 screen, also shown in FIG. 35, shows summary statistics of blood glucose measurements, based upon various sets of data. The initial data set is all records within the past 90 days. The user can use the middle soft key switch 104 to select the next data set. The data sets available for summary statistics are: 90 days, single day (today), 7 days, 14 days, 30 days, 60 days.

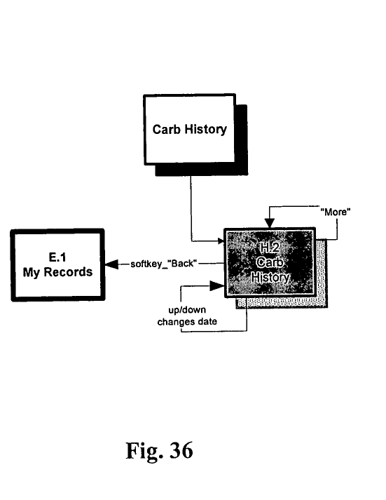

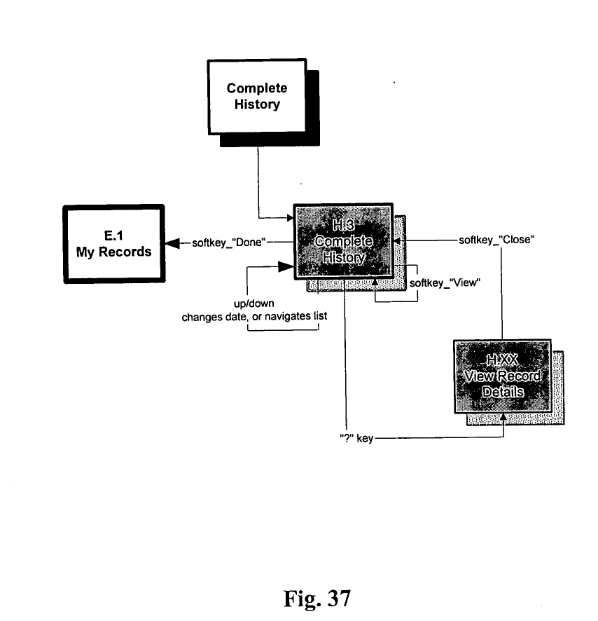

A Carbohydrate History H.02 screen lists the daily carbohydrate history of the device, as shown in FIG. 36. A Complete History H.03 screen, also shown in FIG. 37, lists the daily complete history of the device. This includes all records shown in basal history, bolus history, alarm history, carbohydrate history, and blood glucose history. The date for the current record is shown with a blinking indicator that the user may use the Up/Down Controller Button to change the date. The starting date for this page is the current day. The most recent entry for the day being displayed should be displayed at the top of the page.

“Settings” Submenu

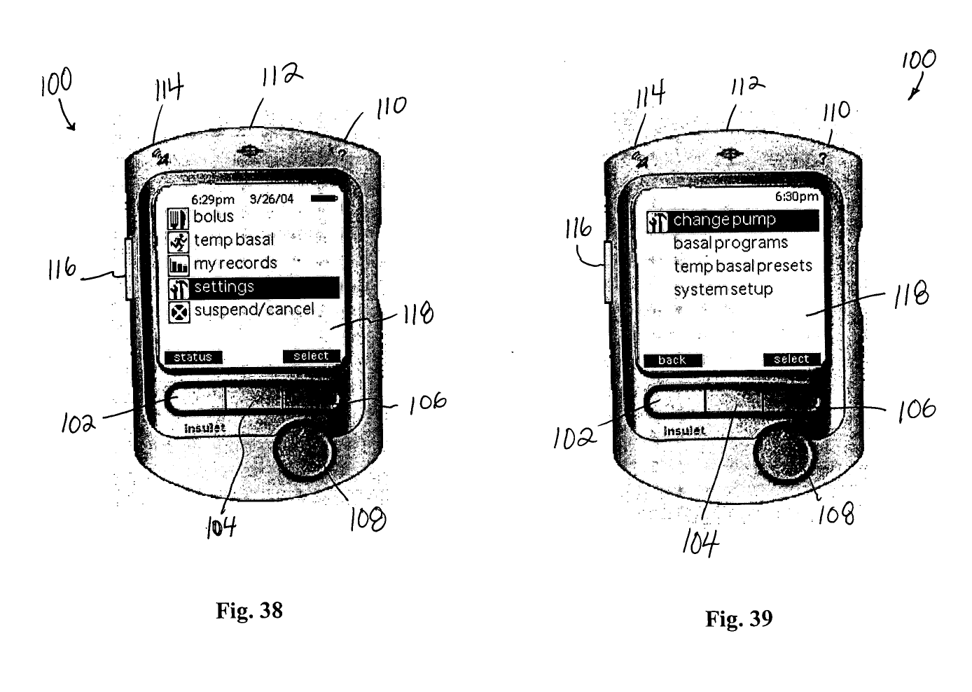

FIG. 38 is a front elevation view of the remote controller of FIG. 5, wherein the menu screen is displayed on the remote controller and a “settings” submenu selection is highlighted. FIG. 39 is a front elevation view of the remote controller after the “settings” submenu has been selected from the menu screen of FIG. 38. In the exemplary embodiment of FIG. 39, the settings menu includes four selections: change pump; basal programs; temporary basal presets; and systems setup.

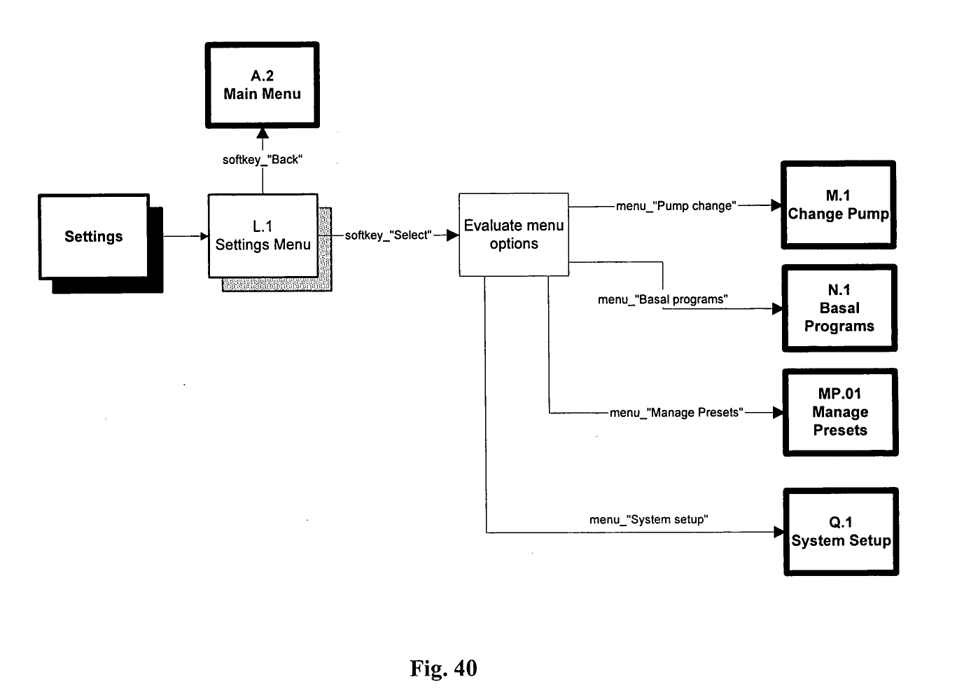

FIG. 40 is a flowchart illustrating an exemplary embodiment of a settings submenu component of a user interface computer program according to the present disclosure, which is operated on the remote controller of FIG. 5 after the “settings” submenu has been selected. In the exemplary embodiment of FIG. 40, a “settings” submenu screen L.1 includes a change pump submenu, a basal programs submenu, a manage presets submenu and a system setup submenu.

“Change Pump” Submenu

The user interface of the present disclosure includes change pump instructions that that are initiated upon the user selecting a change pump option through the user interface components and that instruct the processor to sequentially prompt the user through the user interface components to take predetermined actions to prepare the replacement infusion pump to deliver fluid to a patient. The actions include at least one of checking whether an infusion pump is currently active, deactivating the infusion pump if the infusion pump is active, removing the infusion pump if the infusion pump is deactivated, filling a replacement infusion pump, setting a unique ID for the replacement infusion pump, priming the replacement infusion pump, removing an adhesive cover from the replacement infusion pump and securing the replacement infusion pump on a skin surface of the patient using the adhesive, activating an insertion assembly of the replacement infusion pump, and begin basal delivery from the replacement infusion pump.

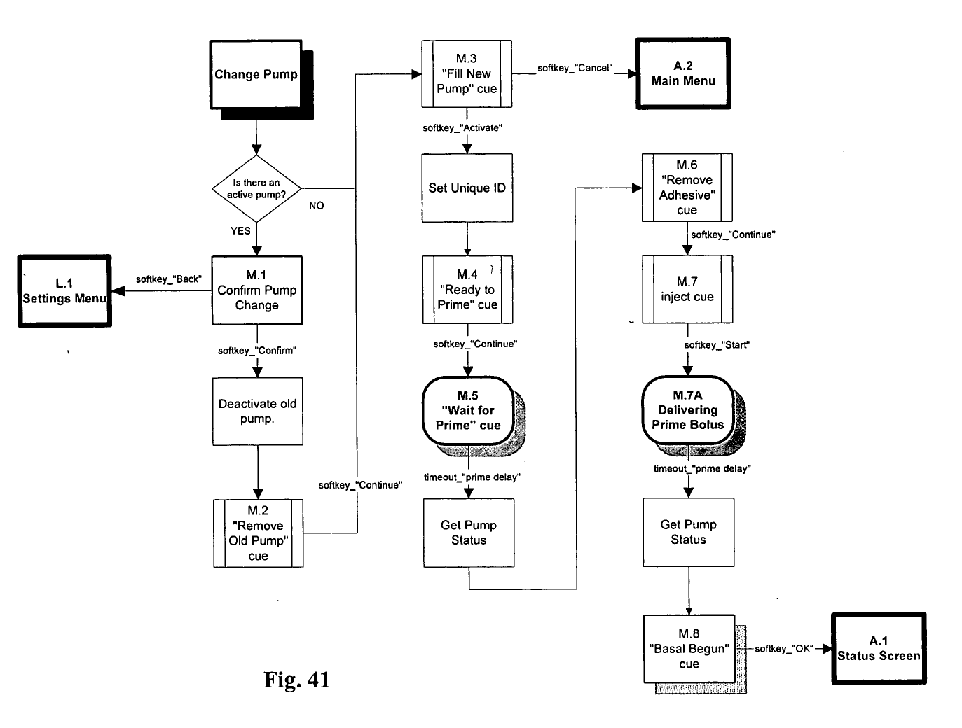

FIG. 41 is a flowchart illustrating an exemplary embodiment of a “change pump” submenu component of a user interface computer program according to the present disclosure, which is operated on the remote controller of FIG. 5 after the “change pump” submenu has been selected from the settings submenu of FIG. 40.

A Confirm Pump Change M.1 screen requires the user to confirm their intent the change the pump, and a Remove Old Pump Cue M.2 screen notifies the user that they should discard their old pump. A Fill New Pump Cue M.3 screen prompts the user to associate a new pump with the remote, while a Ready to Prime Cue M.4 screen prompts the user to fill the new pump.

A Wait for Prime Cue M.5 screen prompts the user to wait while the system primes the infusion pump 10. Once the pump is primed a Remove Adhesive Cue M.6 screen prompts the user to remove the adhesive backing from the pump and attach the pump to the patient's skin using the adhesive.

Still referring to FIG. 41, an Inject Cue M.7 screen prompts the user to prepare for needle injection. By pressing the soft key switch labeled “start”, the remote controller 100 causes the needle and cannula of the infusion pump 10 to be inserted into the patient, and a prime bolus dose delivered to further prime the inserted cannula of the pump. A Delivering Prime Bolus Cue M.7A screen prompts the user to wait while the prime bolus is delivered, and a Basal Begun Cue M.8 screen informs the user that the basal rate has begun. When the soft key switch labeled “OK” is pressed, the user interface returns to the status screen A.1, as shown.

“Basal Program List” Submenu

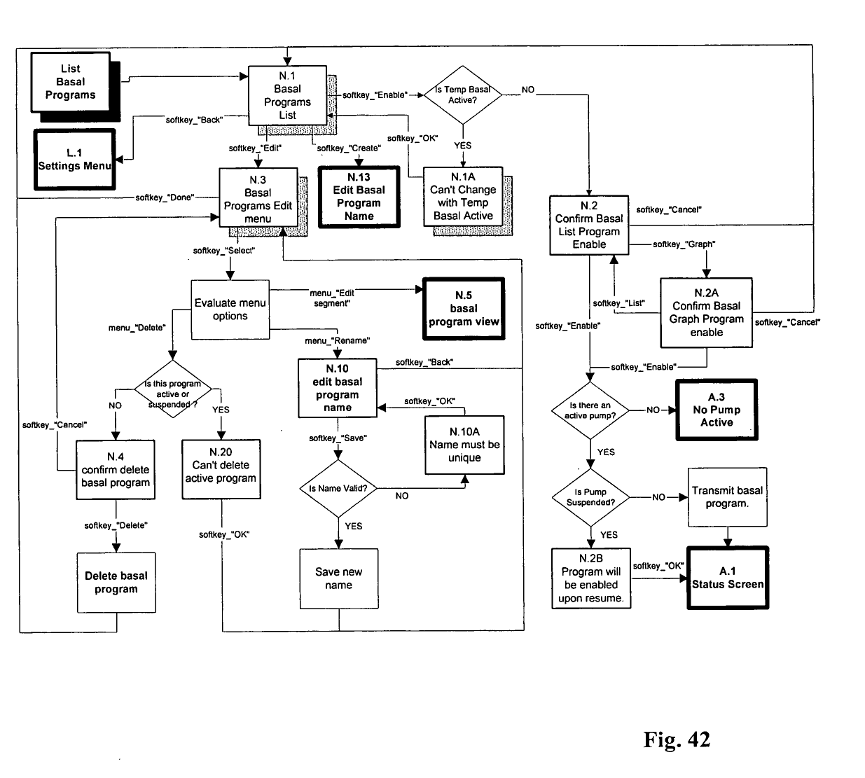

FIGS. 42 through 44 are flowcharts illustrating an exemplary embodiment of a “basal program list” submenu component of a user interface computer program according to the present disclosure, which is operated on the remote controller of FIG. 5 after the “basal program list” submenu has been selected from the settings submenu of FIG. 40.

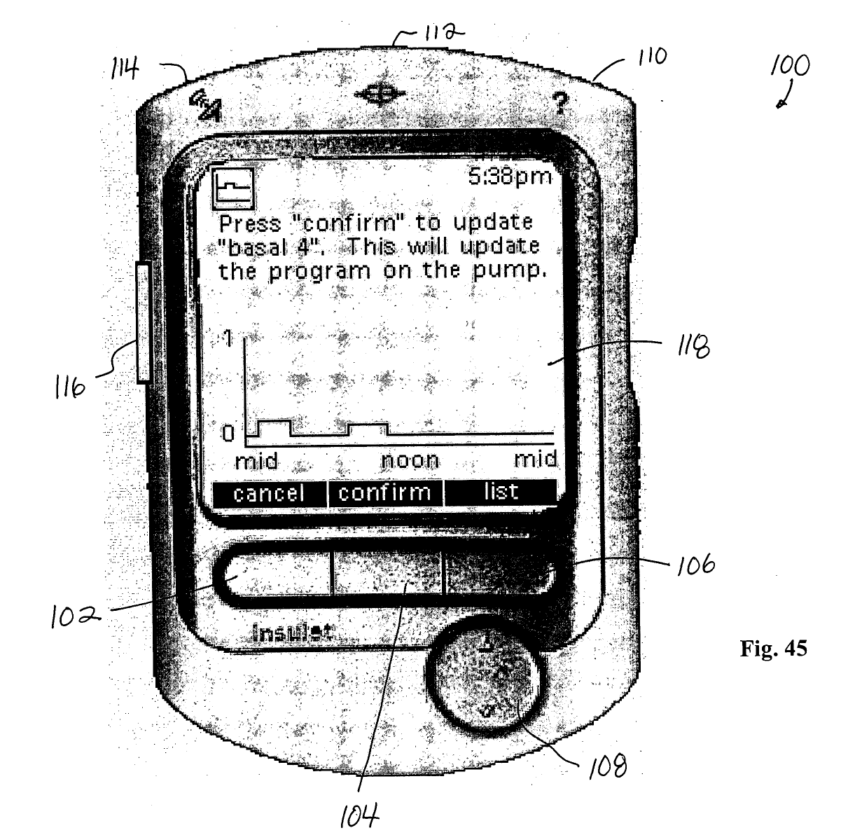

For parameters that are represented as a program, the user interface of the present disclosure will display a graph of the program as a confirmation step. The graph displays twenty-four hours of the program, with the x-axis labeled “mid” “noon” “mid.” The y-axis is dependant on the data being displayed, such a flow rate. Each graph screen has an associated set of scales, which are selected dynamically to fit all the data on the screen. FIG. 45 is a front elevation view of the remote controller of FIG. 5, wherein a graph of flow rate versus time is displayed on the remote controller to represent a basal rate that has been programmed by a user.

Referring back to FIG. 42, a Basal Programs List N.1 screen lists the basal rate programs in the device and allows the user to choose one to enable. The names of the basal programs are shown in a list format; the Up/Down Controller Button navigates the list. The currently active program is displayed with [active] appended to its name indicating that it is the currently enabled program. The last item on the list is [new program]—selecting this creates a new basal program.

A Confirm Basal List Program Enable N.2 screen requires the user to confirm a change of basal rate program and shows the basal program list with the option on the soft keys to show the graph, while a Confirm Basal Graph Program Enable N.2A screen requires the user to confirm a change of basal rate program and shows the basal program graph with the option on the soft keys to show the list. A Change Enabled Basal Program While Pump is Suspended N.2B screen informs the user that the basal program that was enabled will start when their insulin delivery is resumed since the pump is currently suspended.

A Basal Program Edit Menu N.3 screen lists the options for editing a basal program, while a Confirm Basal Program Delete N.4 screen requires the user to confirm the deletion of a basal rate program.

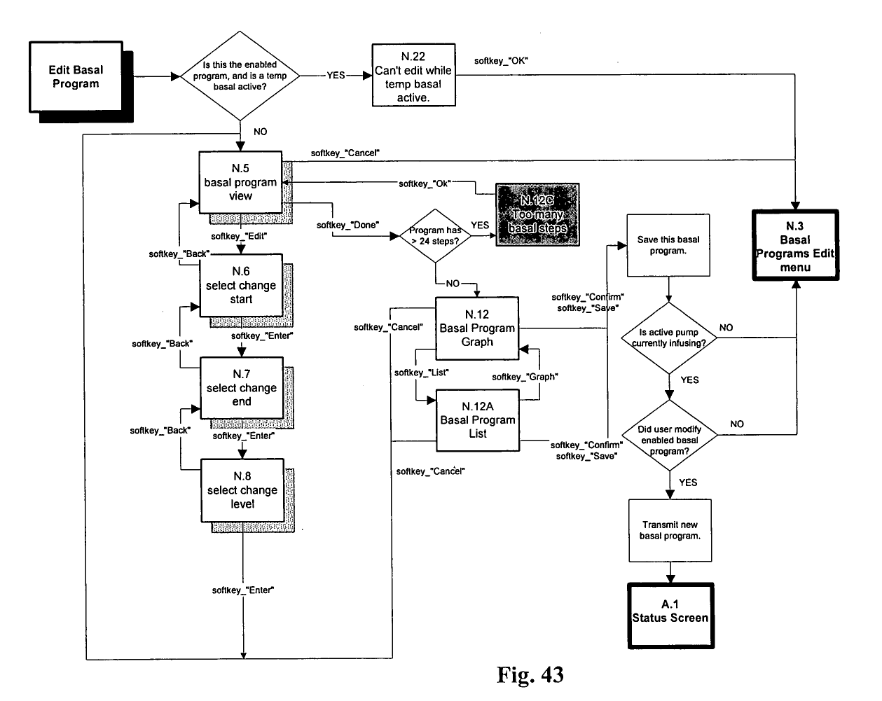

In Fig. FIG. 43, a Basal Rate Program View N.5 screen shows the details of one of the basal rate programs stored in the device. The basal rate program is displayed with its name, and is shown as a set of time spans. A Select Change Start Time N.6 time-entry screen allows the user to specify a change in the start time for the basal rate program being changed. A flashing icon next to the number to change signifies use of the Up/Down Controller Button to change the value. A Select Change End Time N.7 time-entry screen allows the user to specify a change in the end time for the basal rate program being changed. A Select Change Level N.8 numeric-entry screen allows the user to specify the basal rate for the current change time.

In FIG. 42, an Edit Basal Program Name N.10 text edit page allows the user to edit the name text for the basal program. A Basal Program Graph N.12 screen requires the user to confirm the active basal program being edited. Alternatively, if the user selects the soft key switch labeled “List” a Basal Program List N.12A screen requires the user to confirm the active basal program being edited. An Edit Basal Program, Too Many Steps N.12C screen informs the user that the current basal program that they are trying to save exceeds the max number of steps allowed. In the exemplary embodiment, no more than 24 basal steps are allowed.

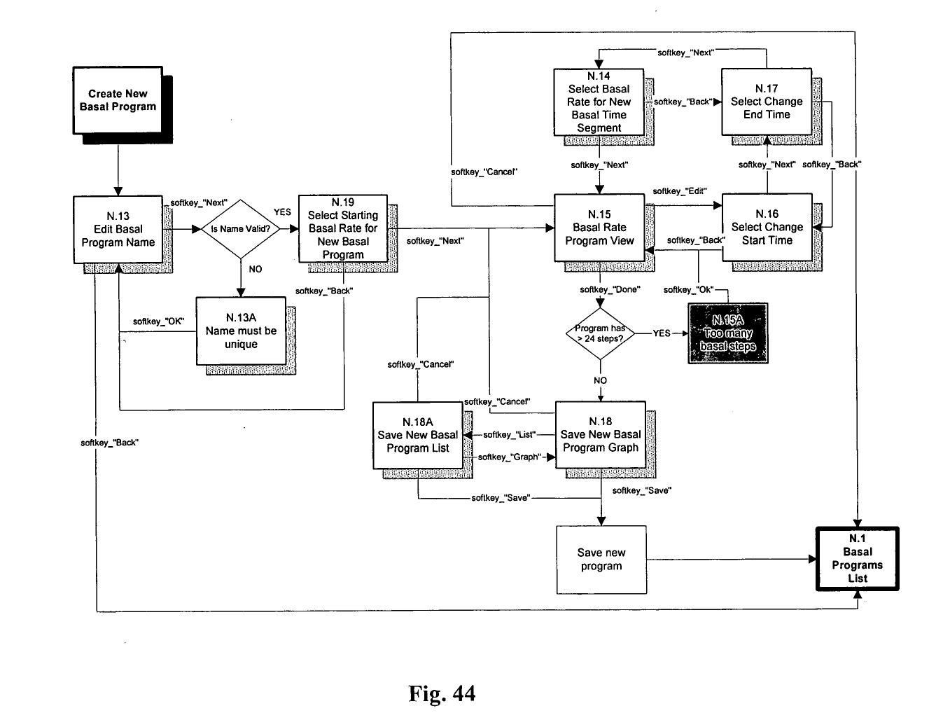

In FIG. 44, an Enter New Basal Program Name N.13 text edit page allows the user to edit the name text for the basal program. If the new name to save is not valid and does not contain the minimum number of characters (one) or the name is already assigned to another basal program, a New Basal Program Name Not Valid N.13A screen is shown.

A Select Starting Basal Rate for New Basal Program N.19 numeric-entry screen allows the user to specify the initial basal rate for the basal program preset being created, and a Select Basal Rate for New Basal Time Segment N.14 numeric-entry screen allows the user to specify the basal rate for the current change time. The details of the new basal rate program being created are then shown in a Basal Rate Program View N.15. The basal rate program is displayed with its name, and is shown as a set of time spans. If the current basal program to save exceeds the max number of steps allowed, a New Basal Program, Too Many Steps N.15A screen informs the user and prompts the user to edit the program to remove the extra steps.

The basal programming interface of the present invention permits a user to modify a basal program by inserting a step into the basal program without overwriting subsequent steps that have already been programmed. An intermediate step of a basal program can be entered without overwriting subsequent steps by requiring the user to input at least two of a start time, an end time and a duration. In a preferred embodiment shown in FIG. 44, the user enters a Start Time in N.16 and an end time in N.17.

A Save New Basal Program Graph N.18 screen requires the user to confirm “saving” the newly created basal rate program. It should show the basal program graph that has been entered. Alternatively, if the user selects the soft key switch labeled “List” a Save New Basal Program List N.18A screen requires the user to confirm “saving” the newly created basal rate program. It should show the basal program list that has been entered similar to N.5.

Referring bask to FIG. 43, if a temp basal is in process a Cannot Change Active Basal Program During Temp Basal N.22 screen informs the user that they cannot change their active basal program while a temp basal is in process. In FIG. 42, a Cannot Delete Active Basal Program N.20 screen informs the user that they cannot delete an active basal program.

The presently disclosed infusion pump and control system allows a user to create custom basal programs. Each program contains: An identifying name of up to 15 characters (allowable characters are alphanumeric upper and lower case, ‘@’, hyphen, period and a space.); A sequence of one or more time periods, in half-hour increments, that represents the full 24-hour period from midnight to midnight; Up to 24 time periods (segments) can be specified in a single basal program; and A non-zero basal rate, in units per hour, associated with each specified time period.

The user is able to store up to seven (7) basal programs in the remote controller 100, and is able to change the name of a program. However, the system requires unique basal program names, and the user is not allowed to save a basal program that violates the user-defined maximum basal rate. The user is able to view a list of program names with the currently running program clearly marked, and is able to select a basal program from this list. The user can enable the displayed program, edit the program and view the program graph, or navigate back to the list of basal programs. In a preferred embodiment, different basal programs may be associated with days of the week and be automatically selected in conjunction with the system calendar. Thus, for example, a user might have certain basal programs for work days and different basal programs for weekend days. In such an embodiment, the basal program associated with each day of the week would automatically run on the designated day without additional user intervention.

When the user changes the enabled basal program or enables a different basal program, the remote controller 100 sends the new basal program to the pump 10, and the remote informs the user when the basal rate begins. The remote 100 configures the pump 10 to beep when the basal program is enabled.

The user is also able to view the details of a stored basal program, change any rates and start/end times for any basal program stored in the remote, and delete a basal program that is not currently enabled.

The user is able to change the basal program that the pump 10 is currently administering, and the remote 100 will require the user to confirm the change, and then update the active program in the pump. If there is also a temporary basal adjustment active, the remote informs the user that the active basal program cannot be edited while a temp basal is in progress.

The user is also able to temporarily adjust the current basal program by specifying a flat rate, or by specifying a percentage adjustment of the current basal profile. The desired method is configurable via the Setup Wizard and configuration screens.

The user is allowed to temporarily suspend the basal program by specifying a rate of “Off”, which corresponds to 0.0 units/hr. If the temporary adjustment is set to Off, the remote 100 programs the pump 10 with confidence and reminder alerts enabled throughout the adjustment. The user is able to enter the amount of the temporary adjustment, or select a temporary basal adjustment preset by name, and is able to cancel a temporary basal adjustment. The remote 100 is programmed to allow only one temporary basal adjustment to be active at any time, but the user is allowed to initiate an immediate or extended bolus while a temporary basal adjustment is in progress.

“Manage Presets” Submenu

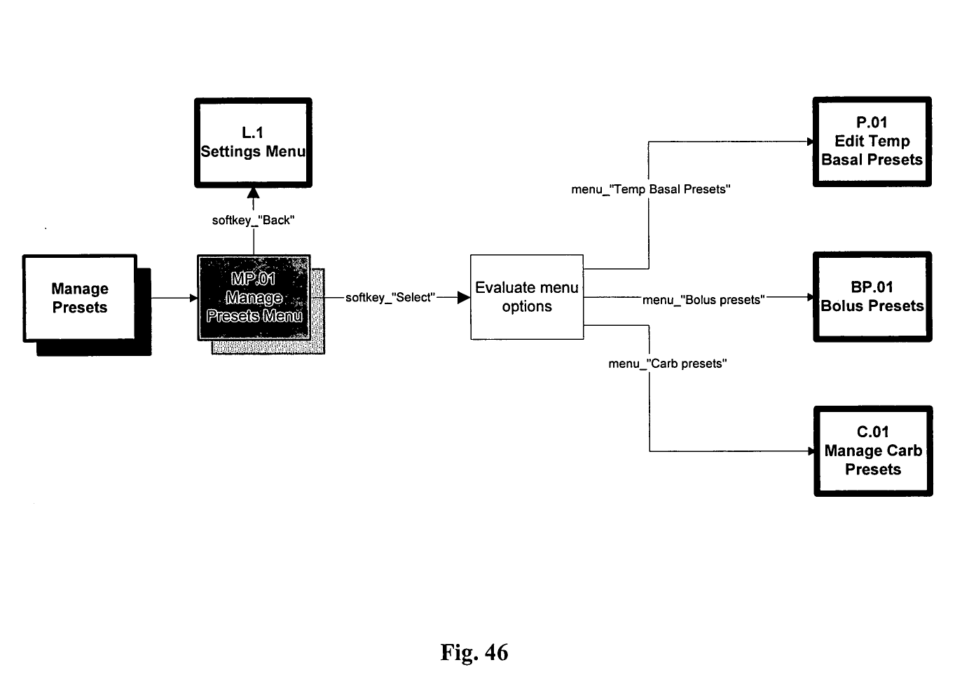

FIG. 46 is a flowchart illustrating an exemplary embodiment of a “manage presets” submenu component of a user interface computer program according to the present disclosure, which is operated on the remote controller of FIG. 5 after the “manage presets” submenu has been selected from the settings submenu of FIG. 40. A Manage Presets Menu MP.01 screen lists an edit temporary basal presets submenu, a bolus presets” submenu, and a manage carbohydrate presets submenu.

“Temporary Basal Presets List” Submenu

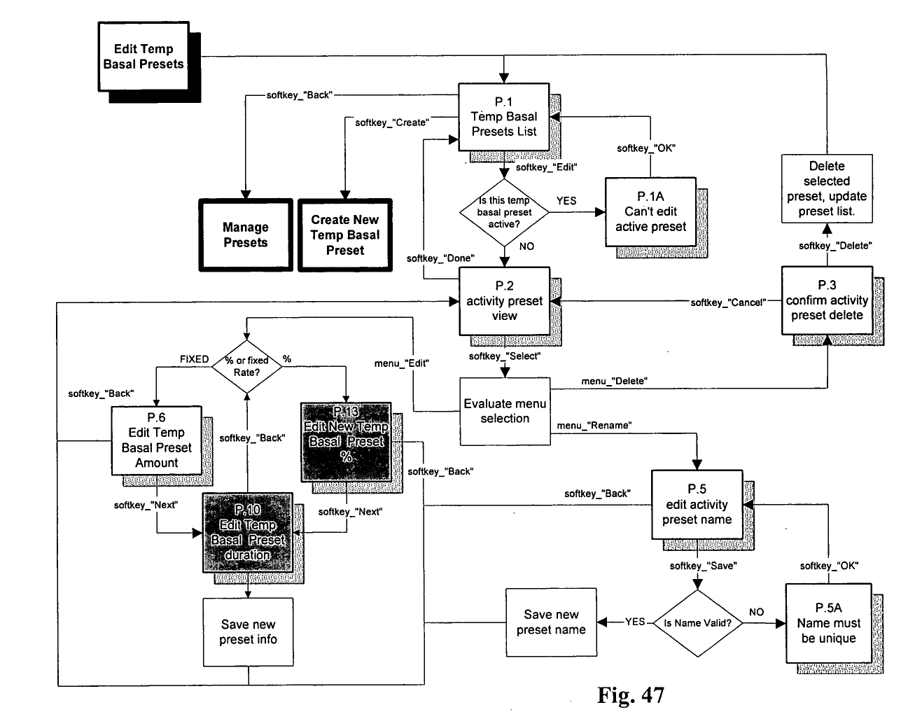

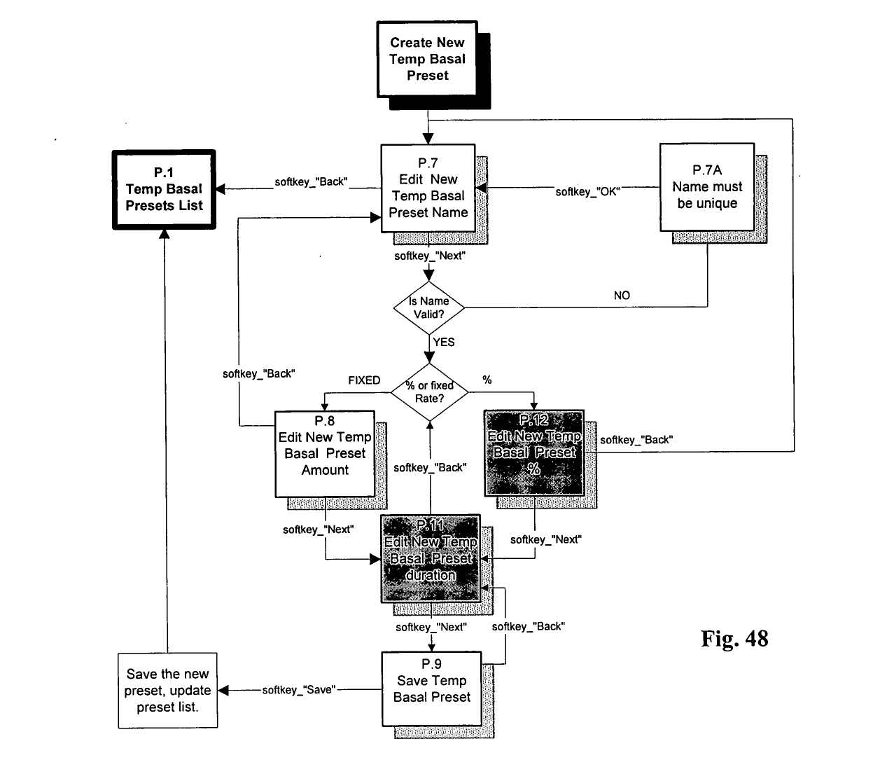

FIGS. 47 and 48 are flowcharts illustrating an exemplary embodiment of a “temporary basal presets list” submenu component of a user interface computer program according to the present disclosure, which is operated on the remote controller of FIG. 5 after the “edit temporary basal presets” submenu has been selected from the “manage presets” submenu of FIG. 46.

In FIG. 47, a Temp Basal Presets List P.1 screen lists the temp basal presets in the device and allows the user to choose one to edit or create a new one. The names of the temp basal programs are shown in a list, with the delivery rate shown in parenthesis. The Up/Down Controller Button navigates the list. If the number of temp basal presets previously created is less than the number allowed, then appended to the list is “[new preset]” to allow for the creation of additional presets. A Cannot Edit Active Temp Basal Preset P.1A screen informs the user that they are not allowed to edit a temp basal program that is active.

A Temp Basal Preset View P.2 screen shows the details of one of the temp basal presets stored in the device, while a Confirm Temp Basal Preset Delete P.3 screen requires the user to confirm the deletion of a temp basal preset. Alternatively, an Edit Temp Basal Preset Name P.5 text edit page allows the user to edit the name text for the current temp basal preset. A Temp Basal Preset Name Not Valid P.5A screen informs the user that the name they are trying to save is not valid and does not contain the minimum number of characters (one) or the name is already assigned to another temp basal program.

An Edit Temp Basal Preset Amount P.6 numeric-entry screen allows the user to specify the temp basal rate for the current preset. A flashing icon next to the number to change signifies use of the Up/Down Controller Button to change the value. Alternatively, an Edit Temp Basal Preset Adjustment Percentage P.13 numeric-entry screen allows the user to specify the percentage amount to adjust the basal rate for this preset. A flashing icon next to the number to change signifies use of the up/down controls to change the value. Negative values are presented with a “−” to their left; positive values show a “+”.

In FIG. 48, an Edit New Temp Basal Preset Name P.7 text edit page allows the user to edit the name text for the temp basal preset being created. Again, an Edited Temp Basal Preset Name Not Valid P.7A screen informs the user that the temp basal preset name they are trying to edit and save is not valid and does not contain the minimum number of characters (one) or the name is already assigned to another temp basal program.

An Edit New Temp Basal Preset Amount P.8 numeric-entry screen allows the user to specify the basal rate for the new preset being created. A flashing icon next to the number to change signifies use of the Up/Down Controller Button to change the value. Alternatively, an Edit New Temp Basal Preset Adjustment Percentage P.12 numeric-entry screen allows the user to specify the percentage amount to adjust the basal rate for this preset. A flashing icon next to the number to change signifies use of the up/down controls to change the value. Negative values are presented with a “−” to their left; positive values show a “+”. An Edit New Temp Basal Preset Duration P.11 numeric-entry screen allows the user to specify duration of the temp basal adjustment for the current preset. A Preset Duration P.11 numeric-entry screen allows the user to specify duration of the temp basal adjustment for the current preset, while a Save Temp Basal Preset P.9 screen shows the details of the new temp basal preset created.

“Bolus Presets List” Submenu

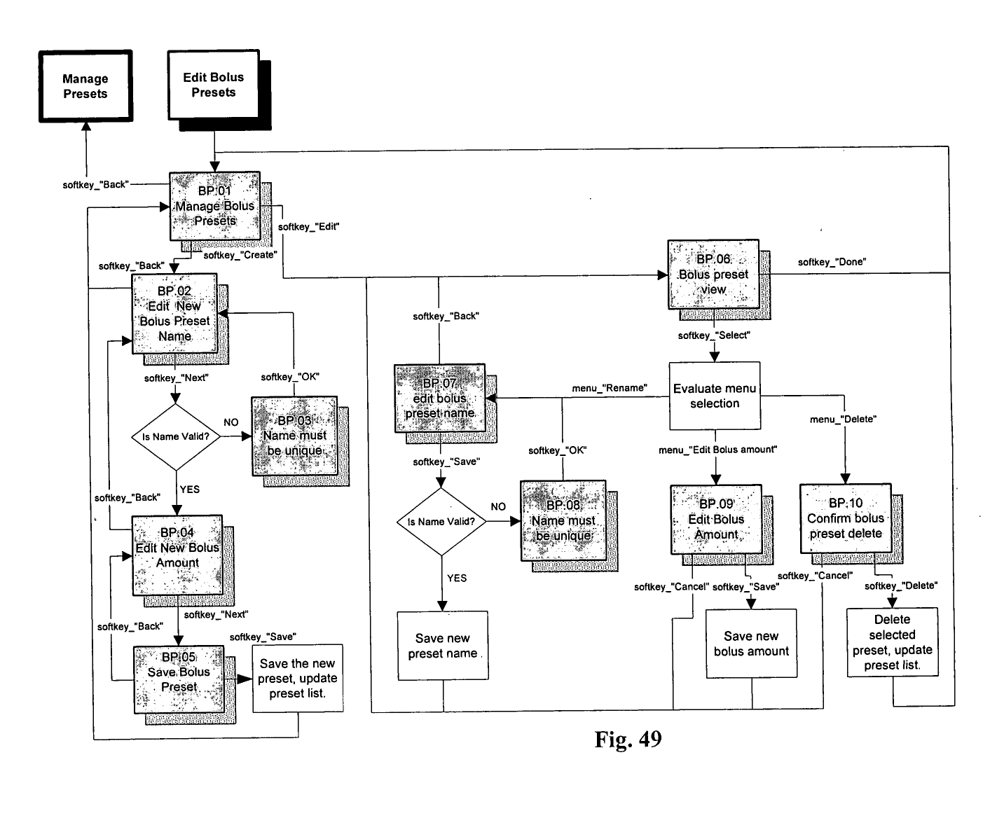

FIG. 49 is a flowchart illustrating an exemplary embodiment of a “manage bolus presets” submenu component of a user interface computer program according to the present disclosure, which is operated on the remote controller of FIG. 5 after the “manage bolus presets” submenu has been selected from the “manage presets” submenu of FIG. 46.

In FIG. 49, a Manage Bolus Presets BP.01 screen lists the bolus presets in the device and allows the user to choose one to edit or create a new one. The names of the bolus presets are shown in a list, with the bolus volume shown in parenthesis. The Up/Down Controller Button navigates the list. If the number of bolus presets previously created is less than the number allowed, then appended to the list is “[new preset]” to allow for the creation of additional presets.

A Create New Bolus Preset Name BP.02 text edit page allows the user to edit the name text for the bolus preset being created. However, a Create New Bolus Preset, Name Invalid BP.03 screen informs the user that the bolus preset name they are trying to edit and save is not valid and does not contain the minimum number of characters (one) or the name is already assigned to another bolus preset.

Still referring to FIG. 49, a Create New Bolus Preset, Enter Amount BP.04 numeric-entry screen allows the user to specify the bolus amount for the new preset being created. A flashing icon next to the number to change signifies use of the Up/Down Controller Button to change the value. A Save New Bolus Preset BP.05 screen shows the details of the new bolus preset created, while a View Bolus Preset BP.06 screen shows the details of one of the bolus presets stored in the device.

A Rename Bolus Preset BP.07 text edit page allows the user to edit the name text for an existing bolus preset. However, a Rename Bolus Preset, Name Invalid BP.08 screen informs the user that the bolus preset name they are trying to edit and save is not valid and does not contain the minimum number of characters (one) or the name is already assigned to another bolus preset.

An Edit Bolus Preset Amount BP.09 numeric-entry screen allows the user to edit the bolus amount for the specified preset, and a Confirm Bolus Preset Delete BP.10 screen requires the user to confirm the deletion of a bolus preset.

“Manage Carbohydrate Presets” Submenu

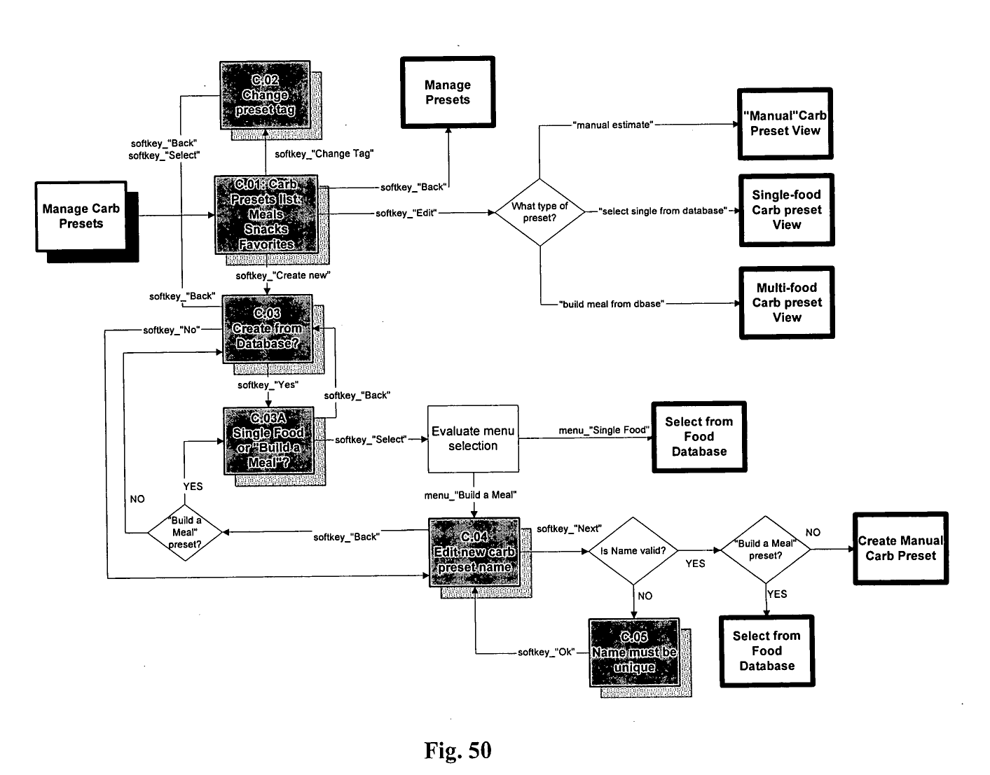

FIGS. 50 through 56 are flowcharts illustrating an exemplary embodiment of a “manage carbohydrate presets” submenu component of a user interface computer program according to the present disclosure, which is operated on the remote controller of FIG. 5 after the “manage carbohydrate presets” submenu has been selected from the “manage presets” submenu of FIG. 46.

In FIG. 50 a List Carb Presets C.01 screen lists the carb presets foods created by the user and allows the user to choose one to edit or create a new one. The names of the carb presets are shown in a list, and the Up/Down Controller Button navigates the list. If the number of carb presets previously created is less than the number allowed, then appended to the list is “[new preset]” to allow for the creation of carb presets. Each preset has an icon to the left of the preset name, indicating whether it is a manual entry preset, a “build a meal” multi-food preset, a single food from the custom database, or a single food from the standard database. In this way, the user can distinguish between preset, even if the user creates a preset name that is similar (or even identical) to a food that is in the database.

A Change Carb Preset Tag C.02 screen allows the user to change the tag for the specified carb preset, via a list of available carb preset tags. A Use Food Database for preset C.03 page asks the user if the preset that they are setting up will use the food database. A Specify New Carb Preset Name C.04 text edit page allows the user to edit the name text for the custom food being created. If the name to be saved is not valid and does not contain the minimum number of characters (one) or the name is already assigned to another custom food, a New Carb Preset Name Invalid C.05 screen is shown.

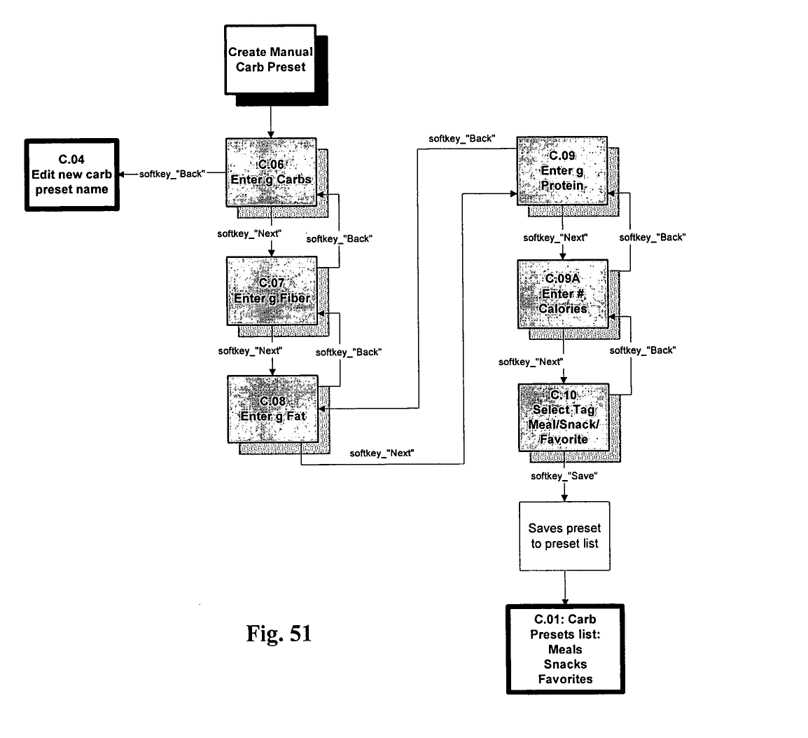

In FIG. 51 a New Manual Carb Preset, Enter Carbs C.06 numeric-entry screen allows the user to specify the grams of carbohydrates for the current manual carbohydrate preset, and a New Manual Carb Preset, Enter Fiber C.07 numeric-entry screen allows the user to specify the grams of fiber for the current manual carbohydrate preset. A New Manual Carb Preset, Enter Fat C.08 numeric-entry screen allows the user to specify the grams of fat for the current carbohydrate preset, a New Manual Carb Preset, Enter Protein C.09 numeric-entry screen allows the user to specify the grams of fat for the current carbohydrate preset, and New Manual Carb Preset, Enter Calories C.09A numeric-entry screen allows the user to specify the number of calories for the current carbohydrate preset. A New Manual Carb Preset, Enter Tag C.10 screen allows the user to specify the tag for the specified carb preset, via a list of available carb preset tags.

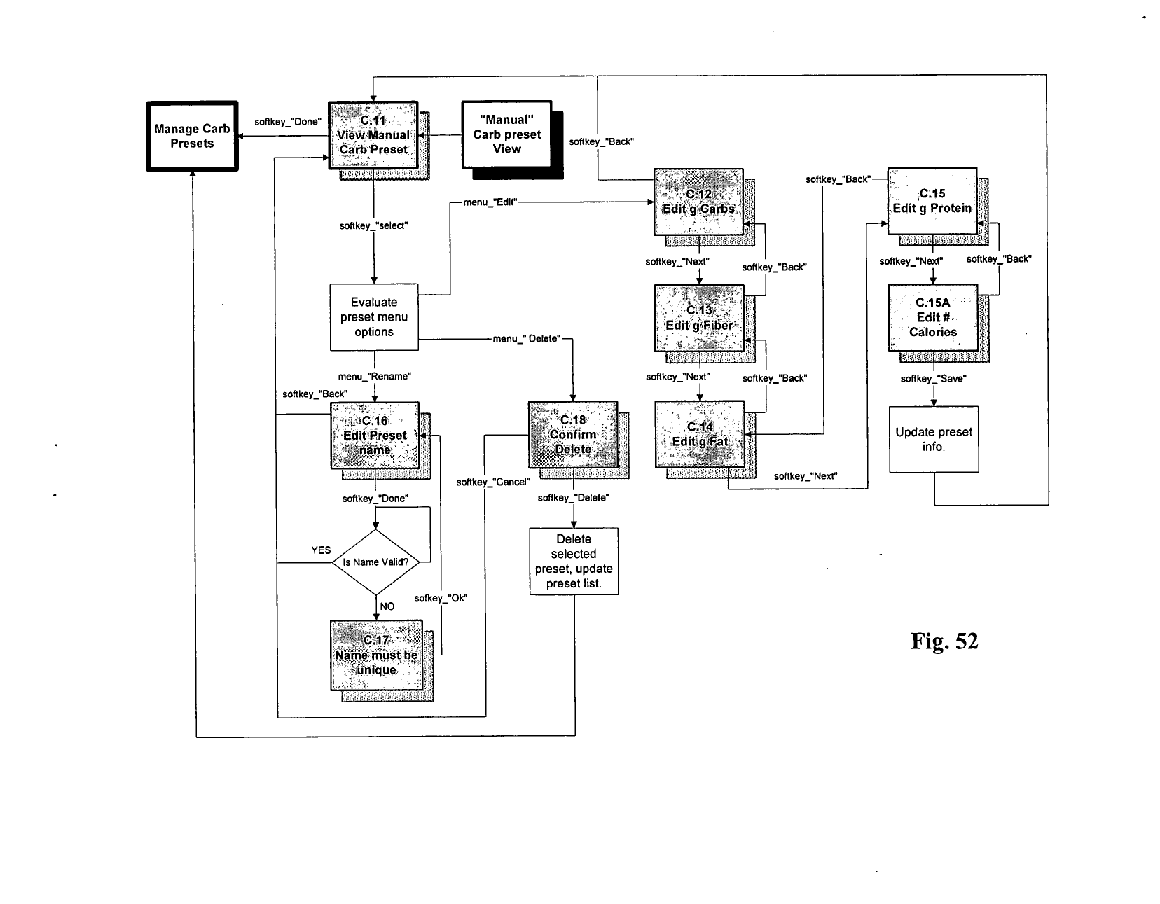

In FIG. 52 a View Manual Carb Preset C.11 screen shows the details of one of the current manual carbohydrate preset. The preset information is displayed in this format: Name: [preset name]; Tag: [preset tag]; Carbohydrates: [preset carbohydrates] g; Fiber: [preset fiber] g; Fat: [preset fat] g; Protein: [preset protein] g; and Calories: [preset calories]. An Edit Manual Carb Preset Carbs C.12 numeric-entry screen allows the user to edit the grams of carbohydrates for the current manual carbohydrate preset, an Edit Manual Carb Preset Fiber C.13 numeric-entry screen allows the user to edit the grams of fiber, an Edit Manual Carb Preset Fat C.14 numeric-entry screen allows the user to edit the grams of fat, an Edit Manual Carb Preset Protein C.15 numeric-entry screen allows the user to edit the grams of protein for the current carbohydrate preset, an Edit Manual Carb Preset Calories C.15A numeric-entry screen allows the user to edit the number of calories for the current carbohydrate preset, and an Edit Manual Carb Preset Name C.16 text edit page allows the user to edit the name text for the current carb preset. If the name to save is not valid and does not contain the minimum number of characters (one) or the name is already assigned to another carb preset, an Edit Manual Carb Preset, Invalid Name C.17 screen is shown. An Edit Manual Carb Preset, Confirm Delete C.18 screen requires the user to confirm the deletion of a manual carb preset.

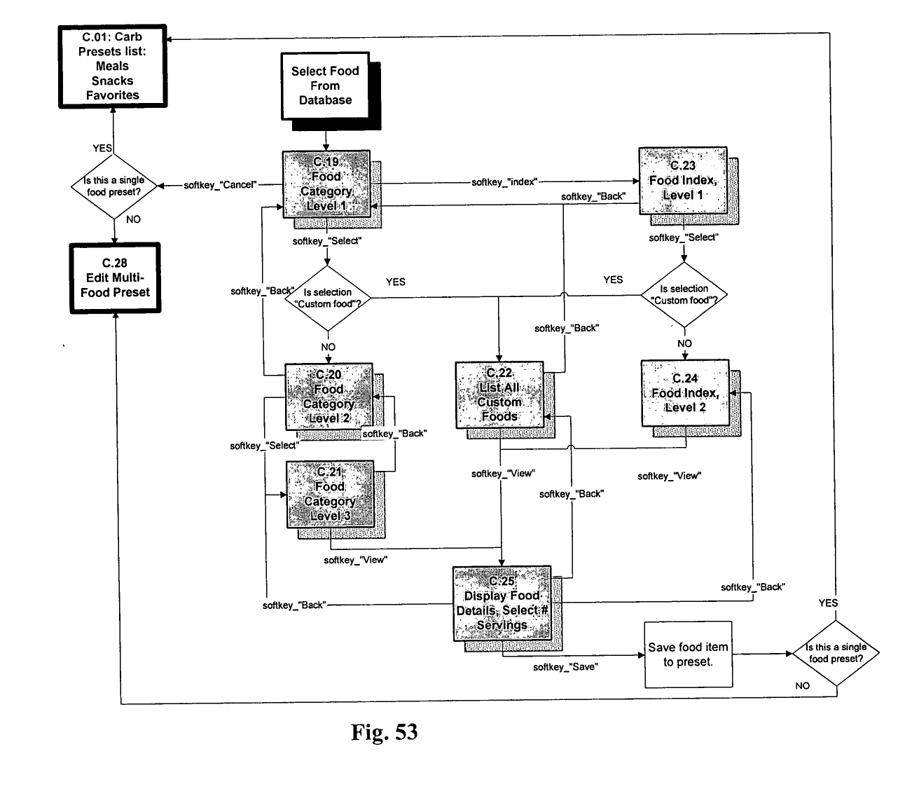

In FIG. 53 a Select Database Category, Level 1 C.19 screen is the entry point into the “Select from Database” functionality. It lists the high-level categories of foods within the database. The names of the categories are shown in a list, and the Up/Down Controller Button navigates the list. A Select Database Category, Level 2 C.20 screen displays the level 2 categories for the standard food database. The names of the categories are shown in a list, and the Up/Down Controller Button navigates the list. A Select Database Category, Level 3 C.21 screen displays all of the standard database food items in the category that the user has selected. The names of the foods are shown in a list, and the Up/Down Controller Button navigates the list. This screen allows the user to select a food to add to the current carbohydrate preset.

A Select Database Custom Foods List C.22 screen lists the custom foods created by the user and allows the user to select one to be added to the current carbohydrate preset.

A Select Database Index, Level 1 C.23 screen allows the user to select a food name via an alphabetical index. The user is presented with a letter-entry field. A flashing icon next to the letter field signifies the use of the Up/Down Controller Button to change the value. A Select Database Index, Level 2 C.24 screen displays all of the standard food items in the database whose names begin with the letter as selected by the user. A Select Database Food Serving Size C.25 screen shows the details of the food that the user has selected. It may be a standard database food or a user-defined custom food. The information is displayed in this format: Name: [food name], Serving size: [food serving size name], Carbohydrates: [food carbohydrates] g, Fiber: [food fiber] g, Fat: [food fat] g, Protein: [food protein] g, and Calories: [calories]. Next to the food name, the proper food type icon—custom or standard —appears. Below the food information is a numeric entry field that allows the user to specify how many servings of this food to add to the preset.

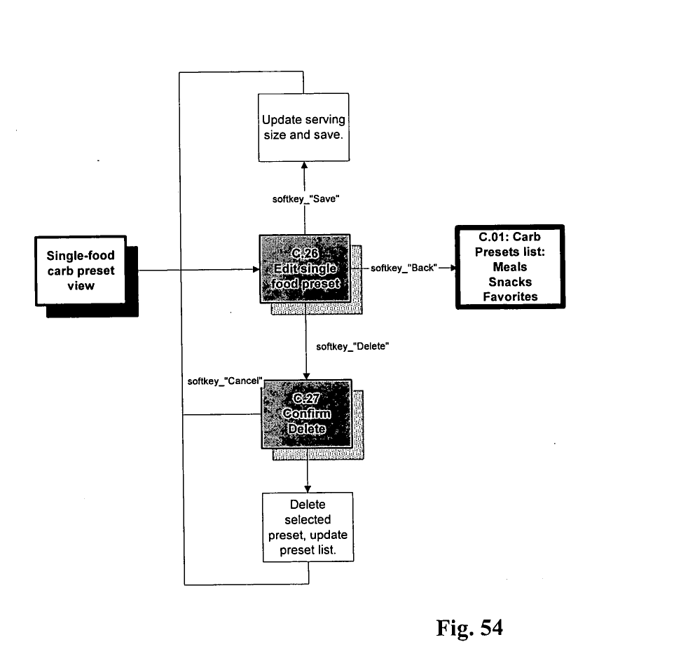

In FIG. 54 an Edit Single Database Food Preset C.26 screen shows the details of the food that the user for this “single food” preset. It may be a standard database food or a user-defined custom food. The information is displayed in this format: Name: [food name], Serving size: [food serving size name], Carbohydrates: [food carbohydrates] g, Fiber: [food fiber] g, Fat: [food fat] g, Protein: [food protein] g, and Calories: [calories]. Next to the food name, the proper food type icon—custom or standard —appears. Below the food information is a numeric entry field that allows the user to specify how many servings of this food to add to the preset. An Edit Single Database Food Preset, Confirm Delete C.27 screen requires the user to confirm the deletion of this carb preset.

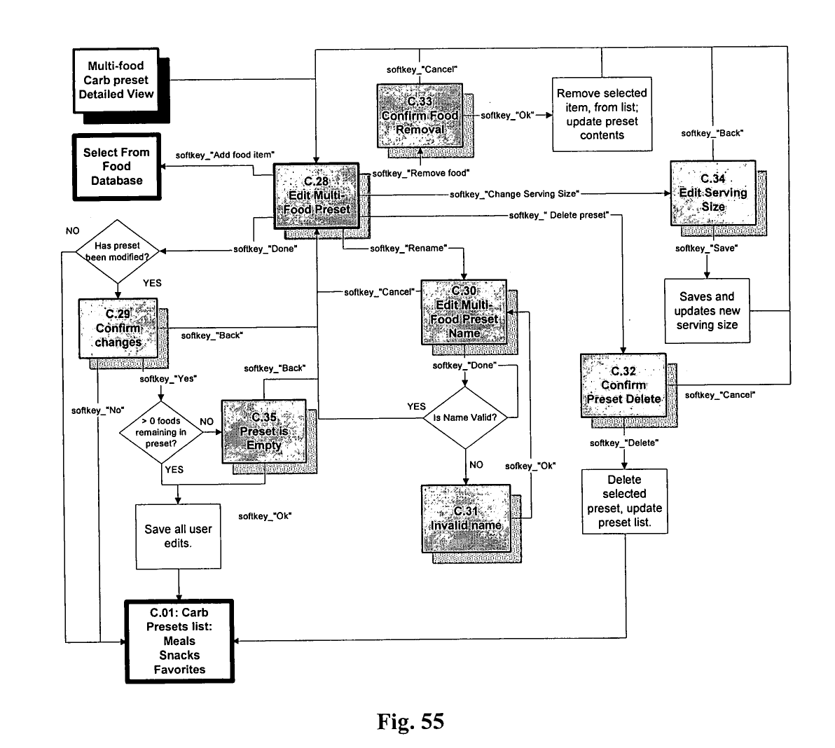

Referring to FIGS. 53 and 55, if the preset is not for a single food, an Edit Multi-Food Preset C.28 screen shows the details of a multi-food “Build a Meal” preset, which is based upon foods selected from the food database. Any of the foods can be a standard database food or a user-defined custom food. To the left of each food that is displayed is an icon indicating whether the food is a custom food or a standard database food. The information is displayed in this format: Name: [preset name], Tag: [preset tag], and Contents. In the “Contents” section, there may be up to twelve food items listed. If less than twelve foods have been added to this preset, then the final item in the list will be “add new food”. The Up/Down Controller Button navigates the list of foods, and can also highlight the name of the preset itself.

In FIG. 55 an Edit Multi-Food Preset, Confirm Changes C.29 screen requires the user to confirm the changes to this carbohydrate preset. Since multi-food presets are more complex than other presets, this screen gives the user the opportunity to “undo” changes. An Edit Multi-Food Preset Name C.30 text edit page allows the user to edit the name text for the current carb preset. If the name to save is not valid and does not contain the minimum number of characters (one) or the name is already assigned to another carb preset name, an Edit Multi-Food Preset, Invalid Name C.31 screen is shown. An Edit Multi-Food Preset, Confirm Preset Delete C.32 screen requires the user to confirm the deletion of a multi-food carb preset.

An Edit Multi-Food Preset, Food Serving Size C.34 screen shows the details and serving information for this particular food within this multi-food preset. It may be a standard database food or a user-defined custom food. The information is displayed in this format: Name: [food name], Serving size: [food serving size name], Carbohydrates: [food carbohydrates] g, Fiber: [food fiber] g, Fat: [food fat] g, Protein: [food protein] g, and Calories: [calories]. Next to the food name, the proper food type icon—custom or standard—appears. Below the food information is a numeric entry field that allows the user to specify how many servings of this food to add to the preset.

In FIG. 55, an Edit Multi-Food Preset, Contents Empty C.35 screen is displayed when the user is attempting to save a multi-food carbohydrate preset, but there are no more food items contained in the preset.

In FIG. 56 a Carb Entry, Manual Entry C.36 numeric-entry screen allows the user to enter the grams of carbohydrates to be used when calculating the meal bolus. A Carb Entry, Select Preset C.37 screen lists the carb presets foods created by the user and allows the user to specify one that should be used to estimate a carbohydrate/meal bolus. The names of the carb presets are shown in a list, and the Up/Down Controller Button navigates the list. Each preset has an icon to the left of the preset name, indicating whether it is a manual entry preset, a “build a meal” multi-food preset, a single food from the custom database, or a single food from the standard database. In this way, the user can distinguish between preset, even if the user creates a preset name that is similar (or even identical) to a food that is in the database. Pressing the “?” key will display details about the highlighted preset.

A Carb Entry, View Manual Carb Preset Details C.38 screen shows the details of one of the current manual carbohydrate preset. The information is displayed in this format: Name: [food name], Serving size: [food serving size name], Carbohydrates: [food carbohydrates] g, Fiber: [food fiber] g, Fat: [food fat] g, Protein: [food protein] g, and Calories: [calories].

Still referring to FIG. 56, a Carb Entry, View Single Database Food Preset Details C.39 screen shows the details of the food that the user for this “single food” preset. It may be a standard database food or a user-defined custom food. The information is displayed in this format: Name: [food name], Serving size: [food serving size name], Carbohydrates: [food carbohydrates] g, Fiber: [food fiber] g, Fat: [food fat] g, Protein: [food protein] g, and Calories: [calories]. Next to the food name, the proper food type icon—custom or standard —appears.

A Carb Entry, View Multi-Food Preset Details C.40 screen shows the details of a multi-food “Build a Meal” preset, which is based upon foods selected from the food database. Any of the foods can be a standard database food or a user-defined custom food. To the left of each food that is displayed is an icon indicating whether the food is a custom food or a standard database food. The information is displayed in this format: Name: [preset name], Tag: [preset tag], and Contents. In the “Contents” section, there may be up to 12 food items listed.

“View Food Database” Submenu

FIG. 57 is a flowchart illustrating an exemplary embodiment of a “view food database” submenu component of a user interface computer program according to the present disclosure, which is operated on the remote controller of FIG. 5 after the “view food database” submenu has been selected from the “manage carbohydrate presets” submenu of FIGS. 50 through 56.

In FIG. 57 a View Database Category, Level 1 J.01 screen is the entry point into the “View Database” functionality. It lists the high-level categories of foods within the database. The names of the categories are shown in a list, and the Up/Down Controller Button navigates the list. The “View Database” button on the remote can be used by the user to search for and view details on any food item in the database. It does not allow the user to create custom foods or manage carbohydrate presets. Preferably, this option can be invoked in the middle of the carbohydrate entry process.

A View Database Category, Level 2 J.02 screen displays the level 2 categories for the standard food database, while a View Database Category, Level 3 J.03 screen displays all of the standard database food items in the category that the user has selected.

A View Database Index, Level 1 J.05 screen allows the user to select a food name via an alphabetical index. The user is presented with a letter-entry field. A flashing icon next to the letter field signifies the use of the Up/Down Controller Button to change the value. A View Database Index, Level 2 J.06 screen displays all of the standard food items in the database whose names begin with the letter as selected by the user. A View Database Food Details J.07 screen shows the details of the food that the user has selected. It may be a standard database food or a user-defined custom food. The information displayed is: food name, food serving size, food carbohydrates, food fiber, food fat, food protein, and calories.

“Manage Custom Foods” Submenu

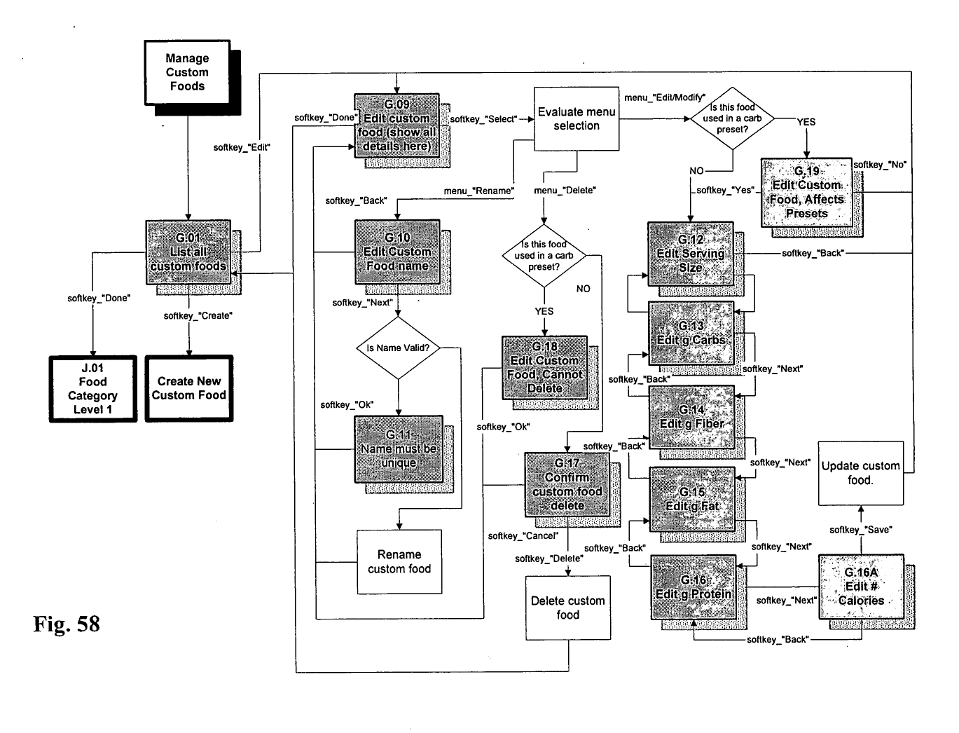

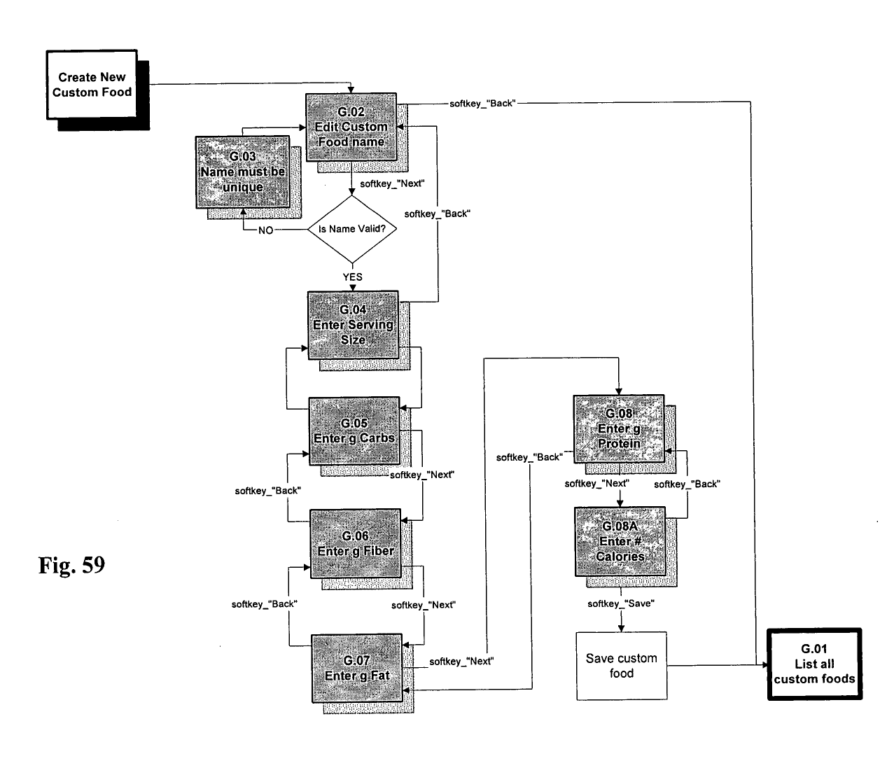

FIGS. 58 and 59 are flowcharts illustrating an exemplary embodiment of a “manage custom foods” submenu component of a user interface computer program according to the present disclosure, which is operated on the remote controller of FIG. 5 after the “manage custom foods” submenu has been selected from the “view food database” submenu of FIG. 57.

In FIGS. 58 and 59 a List Custom Foods G.01 screen lists the custom foods if any have been created by the user and allows the user to choose one to edit or create a new one. The names of the custom foods are shown in a list, and the Up/Down Controller Button navigates the list. If the number of custom foods previously created is less than the number allowed, then appended to the list is “[create new]” to allow for the creation of additional food items.

In FIG. 59 a Create Custom Food Name G.02 text edit page allows the user to edit the name text for the custom food being created. A Create Custom Food, Invalid Name G.03 screen informs the user that the name they are trying to save is not valid and does not contain the minimum number of characters (one) or the name is already assigned to another custom food. A Create Custom Food, Serving Size G.04 text edit page allows the user to enter a text string to describe the serving size for the custom food being created. A Create Custom Food, Enter Carbs G.05 numeric-entry screen allows the user to specify the grams of carbohydrates for the current custom food, while a Create Custom Food, Enter Fiber G.06 numeric-entry screen allows the user to specify the grams of fiber for the current custom food, a Create Custom Food, Enter Fat G.07 numeric-entry screen allows the user to specify the grams of fat for the current custom food, a Create Custom Food, Enter Protein G.08 numeric-entry screen allows the user to specify the grams of protein for the current custom food, and a Create Custom Food, an Enter Calories G.08A numeric-entry screen allows the user to specify the number of calories for the current custom food.

Referring back to FIG. 57 a View Custom Food Details G.09 screen shows the details of one of the custom foods that the user has defined. The information displayed in this format: custom food name, custom food serving size, custom food carbohydrates, custom food fiber, custom food fat, custom food protein, and custom food calories. Below the displayed information is a short menu of functions to act on the custom food. An Edit Custom Food Name G.10 text edit page allows the user to edit the name text for the current custom food. However, an Edit Custom Food, Invalid Name G.11 screen informs the user that the name they are trying to save is not valid and does not contain the minimum number of characters (one) or the name is already assigned to another custom food.

An Edit Custom Food, Serving Size G.12 text edit page allows the user to edit the text string to describe the serving size for the custom food being created, an Edit Custom Food Carbs G.13 numeric-entry screen allows the user to specify the grams of carbohydrates for the current custom food, a Edit Custom Food Fiber G.14 numeric-entry screen allows the user to specify the grams of fiber for the current custom food, an Edit Custom Food Fat G.15 numeric-entry screen allows the user to specify the grams of fat for the current custom food, an Edit Custom Food Protein G.16 numeric-entry screen allows the user to specify the grams of protein for the current custom food, and an Edit Custom Food Calories G.16A numeric-entry screen allows the user to specify the number of calories for the current custom food.

Still referring to FIG. 57, an Edit Custom Food Confirm Delete G.17 screen requires the user to confirm the deletion of a custom food, while an Edit Custom Food, Cannot Delete G.18 screen informs the user that the custom food that has been selected cannot be used because it is used in one or more carbohydrate presets. An Edit Custom Food, Affects Preset G.19 screen informs the user that the custom food that has been selected is used in one or more carbohydrate presets, and that the changes that are made to this food will affect one or more presets.

“System Setup” Submenu

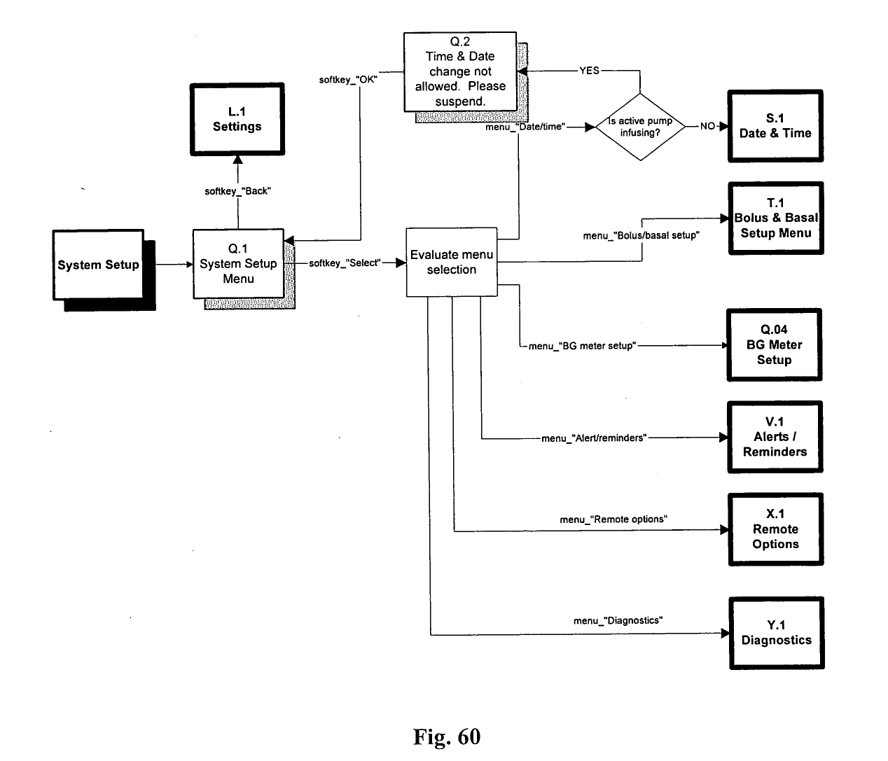

FIG. 60 is a flowchart illustrating an exemplary embodiment of a “system setup” submenu component of a user interface computer program according to the present disclosure, which is operated on the remote controller of FIG. 5 after the “system setup” submenu has been selected from the settings submenu of FIG. 40. As shown, the “system setup” submenu includes a date & time submenu, a bolus & basal setup menu, a blood glucose meter setup menu, alerts/reminders menu, a remote options menu, and a diagnostics menu.

In FIG. 60 through 62, 70, 71, 74 and 75 a System Setup Menu Q.01 screen lists the system setup options for the controller. In FIG. 60, a Cannot Change Time or Date while Pump is active Q.02 screen informs the user that they are not allowed to change the date or time while the pump is not suspended.

“Edit Date And Time” Selection Submenu

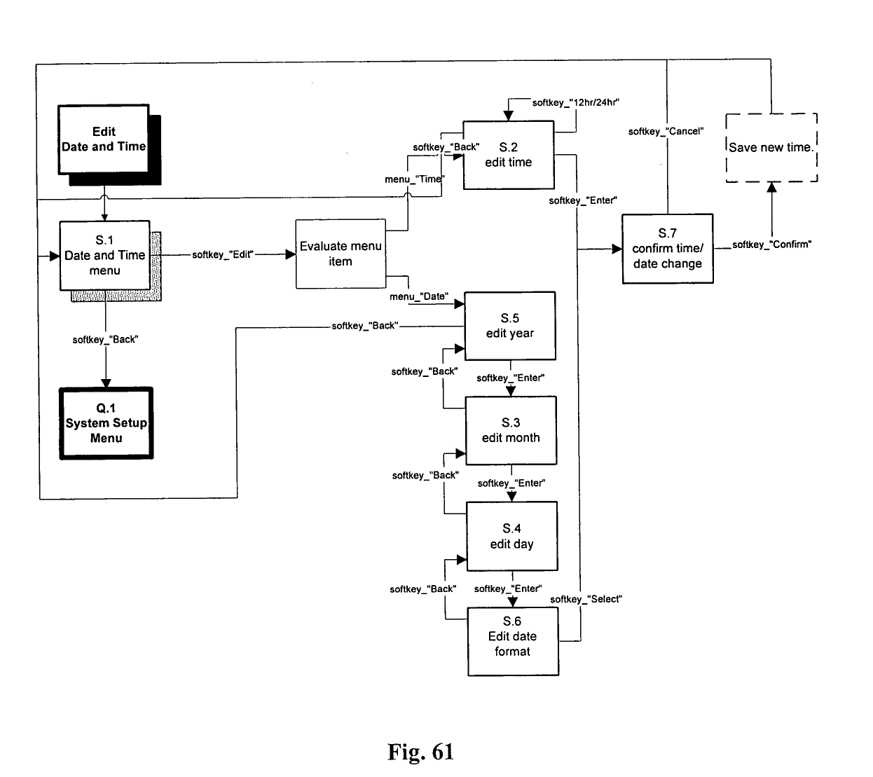

FIG. 61 is a flowchart illustrating an exemplary embodiment of a “edit date and time” submenu component of a user interface computer program according to the present disclosure, which is operated on the remote controller of FIG. 5 after the “edit date and time” submenu has been selected from the system setup submenu of FIG. 60.

In FIGS. 60 and 61, a Date and Time Menu S.1 screen lists the components of the current date and time, and allows the user to change them. An Edit Time S.2 time-entry screen allows the user to specify the time, while an Edit Month S.3 date-entry screen allows the user to specify the month, an Edit Day S.4 numeric-entry screen allows the user to specify the day, an Edit Year S.5 date-entry screen allows the user to specify the year, and a Change Date format S.6 screen shows a menu listing the options for the date format and seeds each format with the previously entered information. Finally a Confirm Time and/or Date Change S.7 screen requires the user to confirm the changes to the current system time or date.

“Bolus And Basal Setting” Submenu

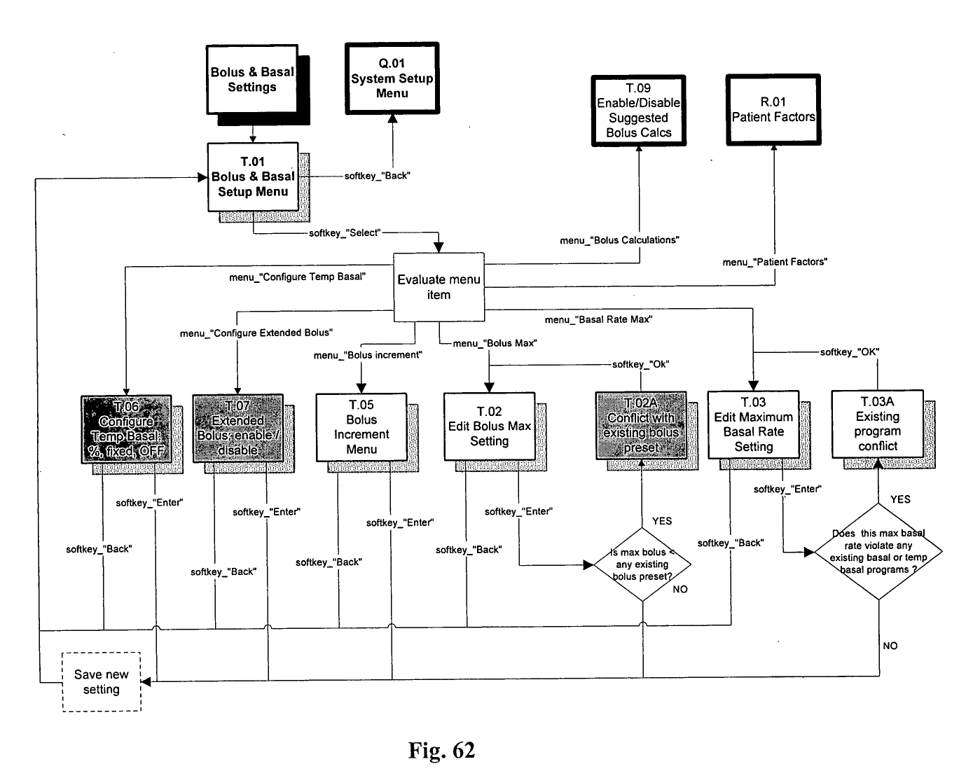

FIGS. 62 through 65 are flowcharts illustrating an exemplary embodiment of a “bolus and basal setting” submenu component of a user interface computer program according to the present disclosure, which is operated on the remote controller of FIG. 5 after the “bolus and basal setting” submenu has been selected from the system setup submenu of FIG. 60.

In FIGS. 60, 62, 63, 65 and 66 a Bolus and Basal Menu T.01 screen lists the bolus and basal setup options, and allows the user to select and edit them. Each option is shown by name, with its value in parenthesis. The “Patient Factors” option is only shown if bolus calculations are enabled. In FIG. 62, an Edit Bolus Max Setting T.02 numeric-entry screen allows the user to specify the value for a bolus or basal setting, but a Max Bolus Setting Conflicts with Existing Bolus Preset T.2A screen informs the user that the value for the Max Bolus Setting they are editing conflicts with an existing bolus preset.

An Edit Maximum Basal Rate Setting T.03 numeric-entry screen allows the user to specify the value for a bolus or basal setting, while a Max Basal Rate Edit Conflicts with Existing Basal Programs or Temp Preset T.03A screen informs the user that the value for the Max Basal Rate they are editing conflicts with an existing basal program or temp basal preset.

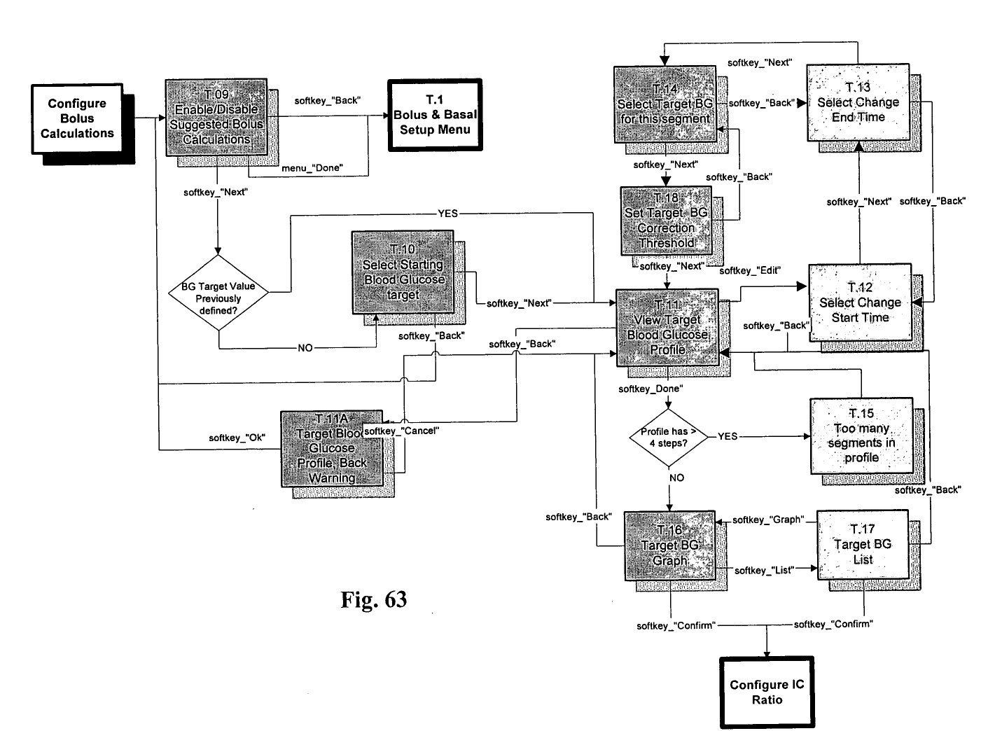

A Bolus Increment Menu T.05 Bolus Settings Menu screen is a menu listing the settings options for the Bolus increment, and a Select Temp Basal Option T.06 screen is a menu displaying the three options for configuring the temp basal feature: Off, % Adjustment or Fixed Rate. A Select Extended Bolus Option T.07 screen is a menu allowing the user to enable or disable the extended bolus feature. In FIGS. 62 and 63 a Select Bolus Calculations Option T.09 screen is a menu displaying two options for the “suggested bolus calculations” feature: enable or disable.

In FIG. 63 a Configure Starting Blood Glucose Target Value T.10 numeric-entry screen allows the user to specify the starting target blood glucose value, which is used for correction bolus calculations. A flashing icon next to the number to change signifies use of the Up/Down Controller Button to change the value. The units for this selection are dependent upon the user's selection in Select BG Meter Display Units (SW.20). A Configure View Target BG. Value Profile T.11 screen displays the user-defined Target BG Value profile, which can have up to four segments, and is shown as a set of time spans, while a Configure Target BG, Back Warning T.11A screen informs the user that the Target BG profile that has been defined will be lost if the user decides to backup at this point.

A Configure Target BG Value, Select Segment Start Time T.12 time-entry screen allows the user to specify a change in the start time for this segment, a Configure Target BG Value, Select Segment End Time T.13 time-entry screen allows the user to specify a change in the end time for this segment, and a Configure Target BG Value, Select Segment Target BG Value T.14 numeric-entry screen allows the user to specify the Target BG Value to be used when correction bolus volumes. If the Target BG Value profile that has been defined exceeds the max number of segments allowed, a Configure Target BG Value, Too Many Segments T.15 screen is displayed. Otherwise a Configure Target BG Value, View Profile Graph T.16 screen graphically displays a representation of the Target BG Value profile that the user has defined. It requires the user to confirm “saving” the current Correction Factor profile. Alternatively, a Configure Target BG Value, View Profile List T.17 screen displays in list format the Target BG Value profile that the user has defined, and also requires the user to confirm “saving” the current Target BG Value profile.

Still referring to FIG. 63, a Configure Target BG Correction Threshold T.18 numeric-entry screen allows the user to specify the target blood glucose correction threshold value for this segment, which is used to indicate when a correction bolus should be suggested. A flashing icon next to the number to change signifies use of the Up/Down Controller Button to change the value. The units for this selection are dependent upon the user's selection in Select BG Meter Display Units (SW.20).

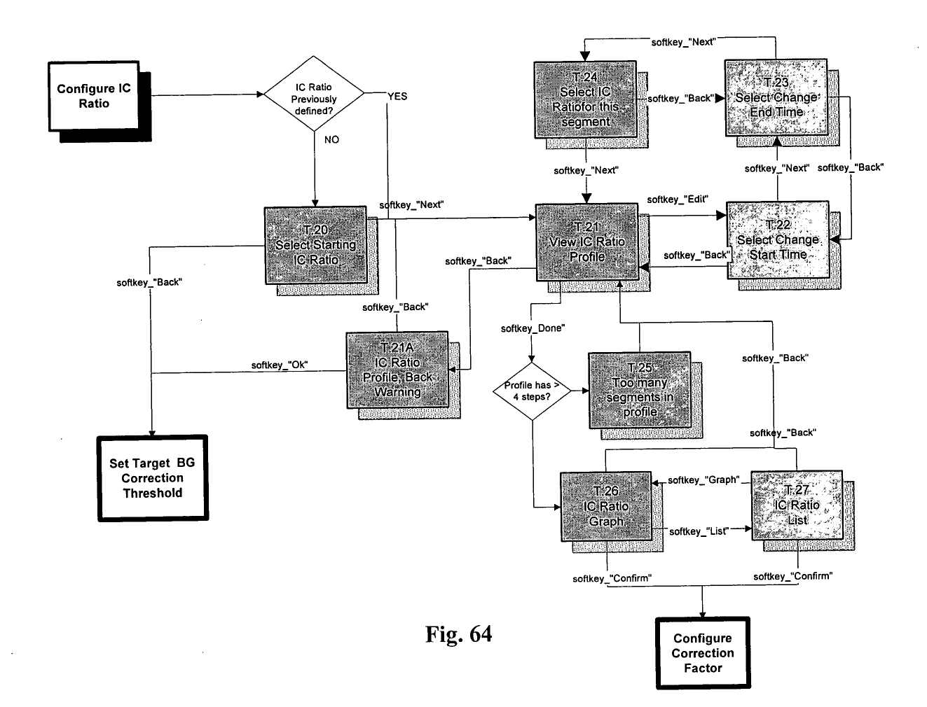

In FIG. 64 a Configure Starting IC Ratio T.20 numeric-entry screen allows the user to specify starting value for the Insulin-to-Carbohydrate ratio to be used when calculating meal/carbohydrate bolus volumes. A Configure View IC Ratio Profile T.21 screen displays the user-defined IC Ratio profile, which can have up to four segments, and is shown as a set of time spans, while a Configure IC Ratio, Back Warning T.21A screen informs the user that the IC Ratio profile that has been defined will be lost if the user decides to backup at this point.

A Configure IC Ratio, Select Segment Start Time T.22 time-entry screen allows the user to specify a change in the start time for this segment, a Configure IC Ratio, Select Segment End Time T.23 time-entry screen allows the user to specify a change in the end time for this segment, and a Configure IC Ratio, Select Segment IC Ratio T.24 numeric-entry screen allows the user to specify the Insulin-to-Carbohydrate ratio to be used when calculating meal/carbohydrate bolus volumes. However, a Configure IC Ratio, Too Many Segments T.25 screen informs the user that the IC Ratio profile that has been defined exceeds the max number of segments allowed. Otherwise a Configure IC Ratio, View Profile Graph T.26 screen graphically displays a representation of the IC Ratio profile that the user has defined. It requires the user to confirm “saving” the current IC Ratio profile. Alternatively, a Configure IC Ratio, View Profile List T.27 screen, if selected by the user, displays in list format the IC Ratio profile that the user has defined and requires the user to confirm “saving” the current IC Ratio profile.

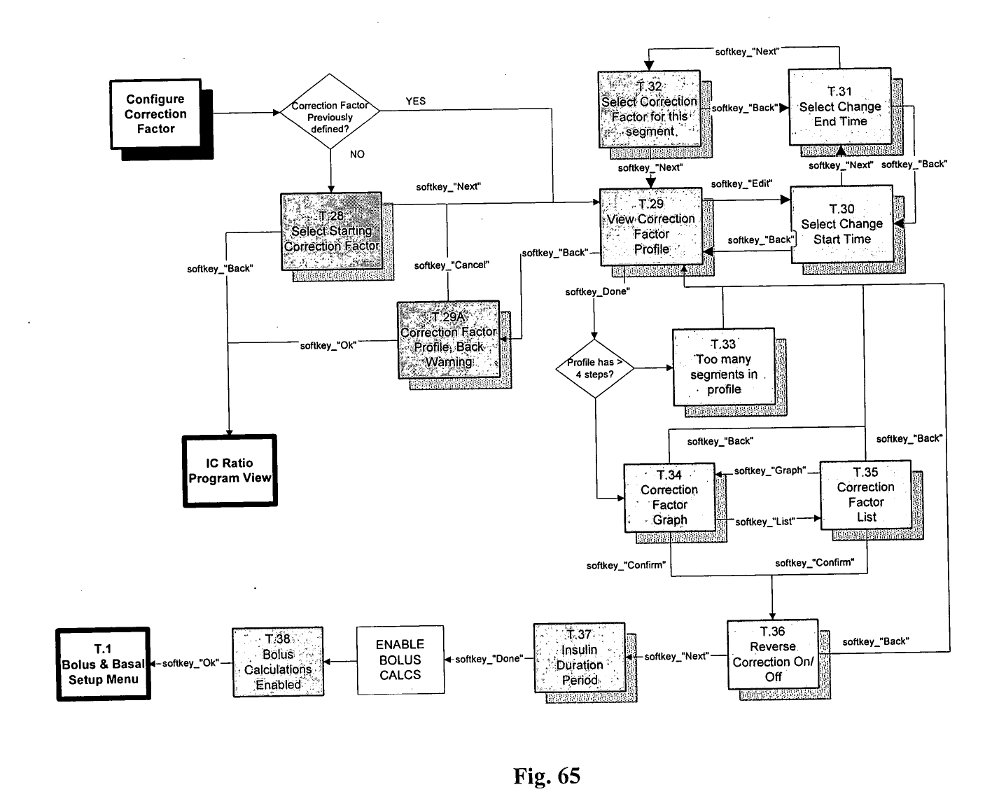

In FIG. 65 a Configure Starting Correction Factor T.28 numeric-entry screen allows the user to specify the starting correction factor for the remote to use when calculating a suggested correction bolus. A flashing icon next to the number to change signifies use of the Up/Down Controller Button to change the value. The units for this selection are dependent upon the user's selection in Select BG Meter Display Units (SW.20). A Configure View Correction Factor Profile T.29 screen displays the user-defined Correction Factor profile, which can have up to four segments, and is shown as a set of time spans, while a Configure Correction Factor, Back Warning T.29A screen informs the user that the Correction Factor profile that has been defined will be lost if the user decides to backup at this point.

A Configure Correction Factor, Select Segment Start Time T.30 time-entry screen allows the user to specify a change in the start time for this segment, a Configure Correction Factor, Select Segment End Time T.31 time-entry screen allows the user to specify a change in the end time for this segment, and a Configure Correction Factor, Select Segment Correction Factor T.32 numeric-entry screen allows the user to specify the Correction Factor to be used when correction bolus volumes are calculated. A Configure Correction Factor, Too Many Segments T.33 screen informs the user that the Correction Factor profile that has been defined exceeds the max number of segments allowed. Otherwise a Configure Correction Factor, View Profile Graph T.34 screen graphically displays a representation of the Correction Factor profile that the user has defined. It requires the user to confirm “saving” the current Correction Factor profile. Alternatively a Configure Correction Factor, View Profile List T.35 screen, if selected by the user, displays in list format the Correction Factor profile that the user has defined and requires the user to confirm “saving” the current Correction Factor profile.

Still referring to FIG. 65, a Configure Reverse Correction T.36 screen displays two menu options for the user: On and Off, and requires the user to select an option and continue. A Configure Insulin Duration Period T.37 numeric-entry screen allows the user to specify the insulin duration period to be used for the calculation of “insulin on board”, which is considered when suggesting a correction bolus. A Configure Bolus Calculations Enabled T.38 screen informs the user that all of the settings pertaining to enabling bolus calculations have been satisfied, and that bolus calculations are now turned on. If the user does not complete this process, then bolus calculations are left off.

“Patient Factors” Submenu

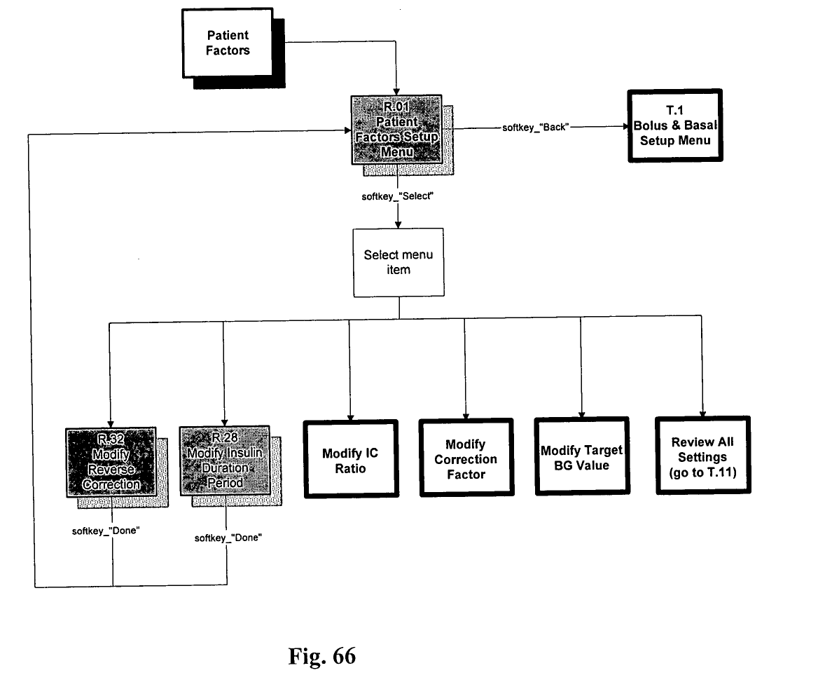

FIGS. 66 through 69 are flowcharts illustrating an exemplary embodiment of a “patient factors” submenu component of a user interface computer program according to the present disclosure, which is operated on the remote controller of FIG. 5 after the “patient factors” submenu has been selected from the “bolus and basal setting” submenu of FIG. 62.

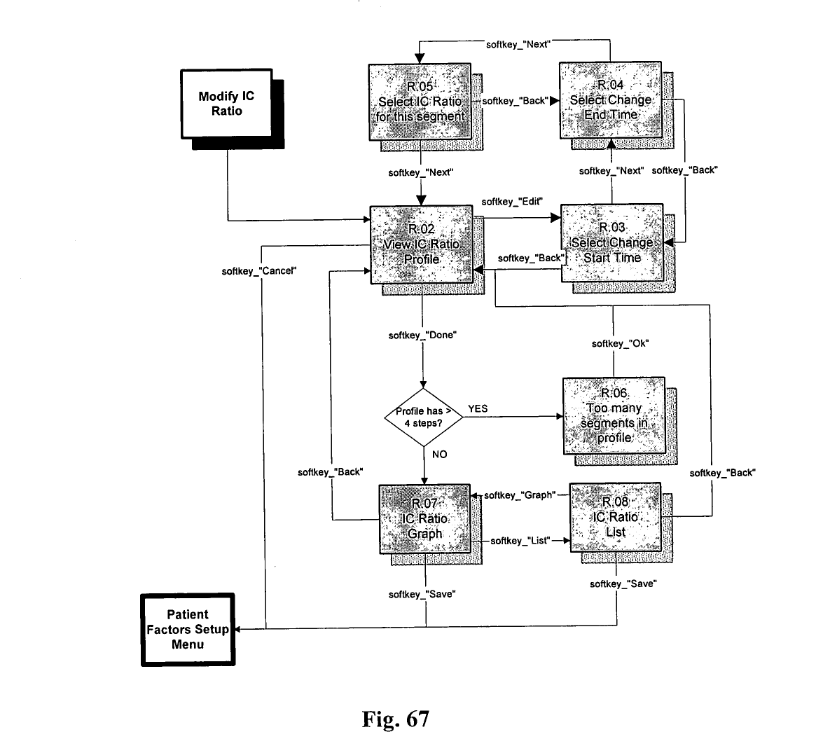

In FIGS. 62 and 66, a Patient Factors Setup Menu R.01 screen lists the Patient Factors options and allows the user to select and patient variable to edit. Each option is shown by name. In FIGS. 66 and 67 a Modify View IC Ratio Profile R.02 screen displays the user-defined IC Ratio profile, which can have up to four segments, and is shown as a set of time spans.

In FIG. 67 a Modify Insulin-to-Carbohydrate (IC) Ratio, Select Segment Start Time R.03 time-entry screen allows the user to specify a change in the start time for this segment, a Modify IC Ratio, Select Segment End Time R.04 time-entry screen allows the user to specify a change in the end time for this segment, and a Modify IC Ratio, Select Segment IC Ratio R.05 numeric-entry screen allows the user to specify the Insulin-to-Carbohydrate ratio to be used when calculating meal/carbohydrate bolus volumes. A Modify IC Ratio, Too Many Segments R.06 screen is shown if the IC Ratio profile that has been defined exceeds the max number of segments allowed. Otherwise a Modify IC Ratio, View Profile Graph R.07 screen graphically displays a representation of the IC Ratio profile that the user has defined and requires the user to confirm “saving” the current IC Ratio profile. Alternatively, a Modify IC Ratio, View Profile List R.08 screen displays in list format the IC Ratio profile that the user has defined. It also requires the user to confirm “saving” the current IC Ratio profile.

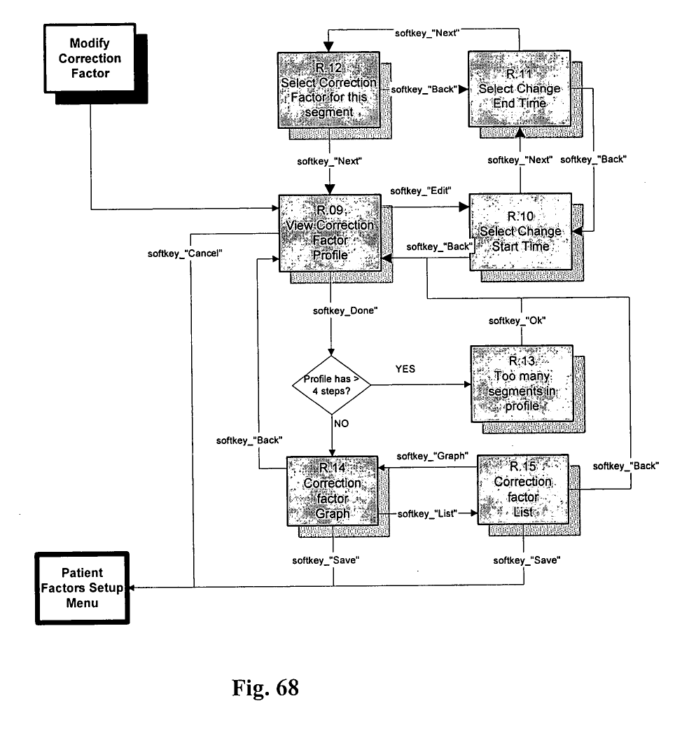

In FIGS. 66 and 68, a Modify View Correction Factor Profile R.09 screen displays the user-defined Correction Factor profile, which can have up to four segments, and is shown as a set of time spans. In FIG. 68 a Modify Correction Factor, Select Segment Start Time R.10 time-entry screen allows the user to specify a change in the start time for this segment, a Modify Correction Factor, Select Segment End Time R.11 time-entry screen allows the user to specify a change in the end time for this segment, and a Modify Correction Factor, Select Segment Correction Factor R.12 numeric-entry screen allows the user to specify the Correction Factor to be used when correction bolus volumes. A Modify Correction Factor, Too Many Segments R.13 screen informs the user that the Correction Factor profile that has been defined exceeds the max number of segments allowed. Otherwise, a Modify Correction Factor, View Profile Graph R.14 screen graphically displays a representation of the Correction Factor profile that the user has defined and requires the user to confirm “saving” the current Correction Factor profile. Alternatively, a Modify Correction Factor, View Profile List R.15 screen displays in list format the Correction Factor profile that the user has defined, and also requires the user to confirm “saving” the current Correction Factor profile.

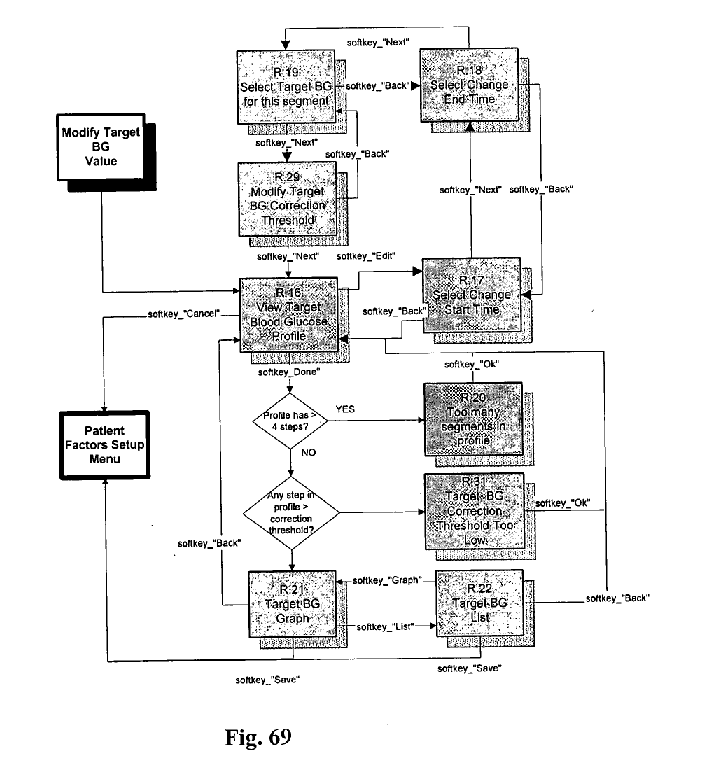

In FIGS. 66 and 69, a Modify View Target BG Value Profile R.16 screen displays the user-defined Target BG Value profile, which can have up to four segments, and is shown as a set of time spans. In FIG. 69 a Modify Target BG Value, Select Segment Start Time R.17 time-entry screen allows the user to specify a change in the start time for this segment, a Modify Target BG Value, Select Segment End Time R.18 time-entry screen allows the user to specify a change in the end time for this segment, and a Modify Target BG Value, Select Segment Target BG Value R.19 numeric-entry screen allows the user to specify the Target BG Value to be used when correction bolus volumes. A Modify Target BG Value, Too Many Segments R.20 screen is shown if the Target BG Value profile that has been defined exceeds the max number of segments allowed. Otherwise a Modify Target BG Value, View Profile Graph R.21 screen graphically displays a representation of the Target BG Value profile that the user has defined and requires the user to confirm “saving” the current Correction Factor profile. Alternatively, a Modify Target BG Value, View Profile List R.22 screen displays in list format the Target BG Value profile that the user has defined and requires the user to confirm “saving” the current Target BG Value profile.

In FIG. 70, a Modify View Target BG Range R.23 screen displays the current upper and lower limits of the user's BG range. These limits are used for characterizing each blood glucose reading as either within range, above range, or below range. A Modify Target BG Range Lower Limit R.24 numeric-entry screen allows the user to specify the value for lower limit of the target blood glucose range. A flashing icon next to the number to change signifies use of the Up/Down Controller Button to change the value. The units for this selection are dependent upon the user's selection in Select BG Meter Display Units (SW.20). A Modify Target BG Range Upper Limit R.25 numeric-entry screen allows the user to specify the value for upper limit of the target blood glucose range. A flashing icon next to the number to change signifies use of the Up/Down Controller Button to change the value. The units for this selection are dependent upon the user's selection in Select BG Meter Display Units (SW.20). A Modify Target BG Range Error R.26 screen is displayed if the user has made an error in specifying the lower and upper limits of the target blood glucose range. A Confirm Target BG Range screen displays the user's selected lower and upper range limits and asks the user to confirm.

Referring back to FIG. 66 a Modify Insulin Duration Period R.28 numeric-entry screen allows the user to modify the insulin duration period to be used for the calculation of “insulin on board”, which is considered when suggesting a correction bolus. In FIG. 69, a Modify Target BG Correction Threshold R.29 numeric-entry screen allows the user to edit the target blood glucose correction threshold value, which is used to indicate when a correction bolus should be suggested. A flashing icon next to the number to change signifies use of the Up/Down Controller Button to change the value. The units for this selection are dependent upon the user's selection in Select BG Meter Display Units (SW.20).

In FIG. 69, a Modify Target BG Value, Value Above Threshold R.31 screen informs the user that the blood glucose target value profile that has been defined includes at least one segment whose value is below the blood glucose correction threshold specified by the user. This correction threshold must be higher than the highest value in the profile. In FIG. 66 a Modify Reverse Correction R.32 screen displays two menu options for the user: On and Off, and requires the user to select an option and continue.

“Blood Glucose Meter Setup” Submenu

FIG. 70 is a flowchart illustrating an exemplary embodiment of a “blood glucose meter setup” submenu component of a user interface computer program according to the present disclosure, which is operated on the remote controller of FIG. 5 after the “blood glucose meter setup” submenu has been selected from the system setup submenu of FIG. 60.

Referring to FIGS. 60 and 70, an Edit BG Meter Display Units Q.03 screen is a menu displaying options for the blood glucose meter display units. In FIG. 70 a BG Meter Setup menu Q.04 screen list the setup options for the BG Meter, and a Setting the Sound Q.05 screen allows the user to turn Off and On the alerts associated with the blood glucose meter. The sounds indicate fill detection, BG measurement complete, and error messages.

“Alarm/Reminders” Submenu

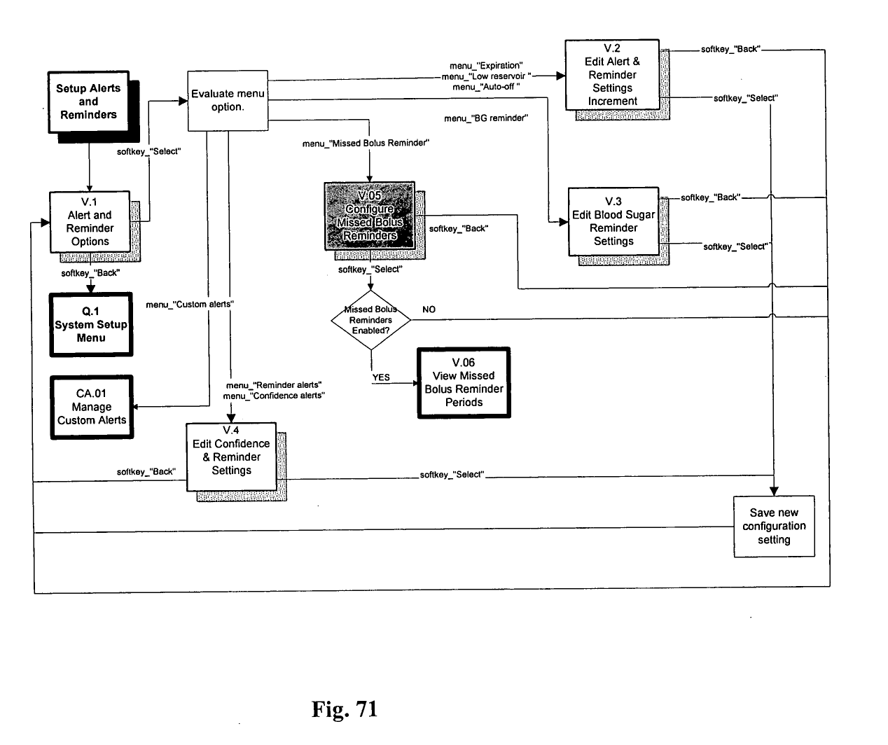

FIGS. 71 through 73 are flowcharts illustrating an exemplary embodiment of an “alarms and reminders” submenu component of a user interface computer program according to the present disclosure, which is operated on the remote controller of FIG. 5 after the “alarms and reminders” submenu has been selected from the system setup submenu of FIG. 60.

Referring to FIGS. 60 and 71 through 73, an Alert & Reminder Options V.01 screen lists the alarm options, and allows the user to select and edit them. Each option is shown by name, with its value in parenthesis. In FIG. 71 an Edit Alert & Reminder Settings Increment V.02 numeric-entry screen allows the user to specify the value for a low reservoir, auto-off or expiration alarms & alerts setting, an Edit Blood Glucose Reminder Settings V.03 screen lists the settings options for the blood glucose reminder.

An Edit Confidence & Reminder Alert Settings V.04 lists the settings options for alarms and alerts. An Edit Missed Bolus Reminder Alert Settings V.05 screen allows the user to enable or disable missed bolus reminders.

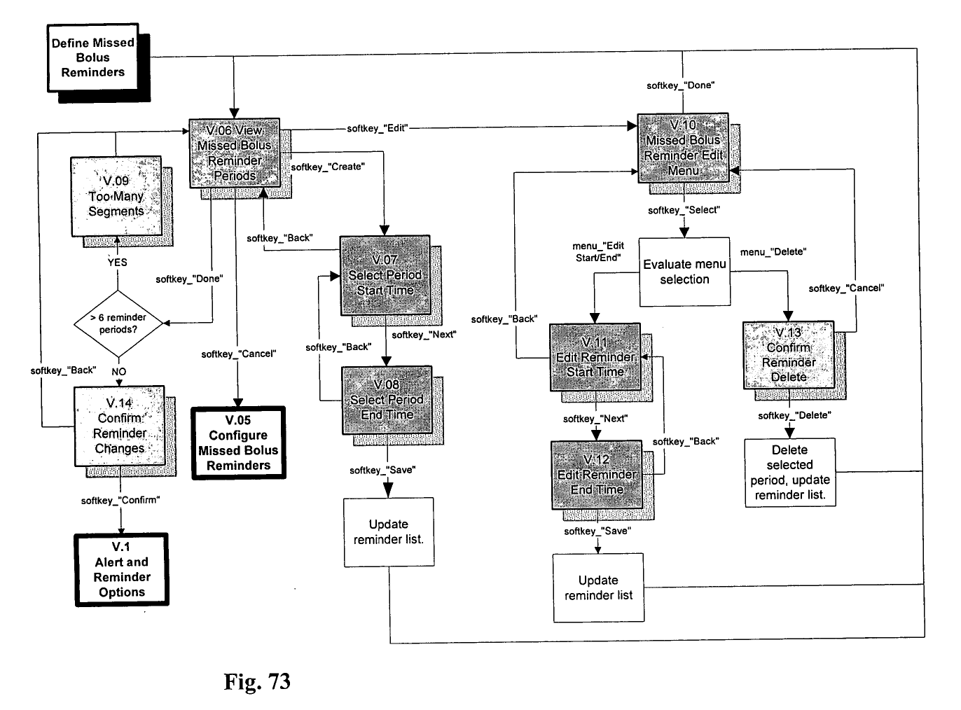

In FIGS. 71 and 73 a View Missed Bolus Reminder Periods V.06 screen lists the missed bolus reminder periods that the user has specified. The screen lists the periods in chronological order. It allows the user to highlight each time period that has been defined, as well as the final option in the list [add new]. In FIG. 73 a Select Missed Bolus Reminder Start Time V.07 time-entry screen allows the user to specify the start time for the missed bolus reminder period being created, and a Select Missed Bolus Reminder End Time V.08 time-entry screen allows the user to specify the end time for the current missed bolus reminder period. A Missed Bolus Reminders, Too Many Segments V.09 screen informs the user that too many Missed Bolus Reminder periods have been defined. Otherwise a Missed Bolus Reminder Edit Menu V.10 screen shows the start and end time of the selected period and allows the user to either delete this segment, or to edit the start and end times. An Edit Missed Bolus Reminder Start Time V.11 time-entry screen allows the user to specify a change in the start time for the missed bolus reminder period being modified, and an Edit Missed Bolus Reminder End Time V.12 time-entry screen allows the user to specify the end time for the current missed bolus reminder period. A Confirm Missed Bolus Reminder Delete V.13 screen requires the user to confirm the deletion of the current missed bolus reminder period, and a Confirm Missed Bolus Reminder Alert Edits V.14 screen requires the user to confirm “saving” the changes to the missed bolus reminder periods. It should show the periods that the user has specified.

In FIGS. 71 and 72 a Manage Custom Alerts CA.01 screen lists custom alert presets in the device and allows the user to choose one to edit or create a new one. The names of the custom alerts are shown in a list. Next to each alert, in parentheses, is the state of the alert: a) off, b) HH:MM AM/PM, c) HH:MM AM/PM daily. The Up/Down Controller Button navigates the list. If the number of alerts previously created is less than the number allowed, then appended to the list is “[new alert]” to allow for the creation of additional custom alerts.

In FIG. 72 a Create New Custom Alert Name CA.02 text edit page allows the user to edit the text for the custom alert being created. A Create New Custom Alert, Name Invalid CA.03 screen informs the user that the alert text they are trying to edit and save is not valid and does not contain the minimum number of characters (one) or the name is already assigned to another custom alert. A Create New Custom Alert, Set Time CA.04 time-entry screen allows the user to specify the time at which the remote should generate this custom alert, and Create New Custom Alert, Enable Menu CA.05 screen allows the user to enable or disable this custom alert. If disabled, then the custom alert will be created, but it will not be active, and no alert will be generated. At a future time, the user can turn on this alert via an Edit Custom Alert, Enable Menu CA.10 screen. The user has two choices for enabling any alert: to occur once only, or to be a daily recurring alert. If the user selects “once”, then after the alert is generated, the remote will change this alert's setting back to “disabled”.

A View Custom Alert CA.06 screen shows the details of the selected custom alert. The alert is displayed in the following format: Name: [custom alert name], Time: [custom alert time], and Setting: [frequency: daily, once, disabled]. Below the displayed preset information is a short menu of functions to act on the preset. An Edit Custom Alert Name CA.07 text edit page allows the user to edit the text for the selected custom alert, but an Edit Custom Alert, Name Invalid CA.08 screen informs the user that the alert text they are trying to edit and save is not valid and does not contain the minimum number of characters (one) or the name is already assigned to another custom alert. An Edit Custom Alert Time CA.09 time-entry screen allows the user to specify the time at which the remote should generate this custom alert. A Confirm Custom Alert Delete CA.11 screen requires the user to confirm the deletion of a custom alert.

“Setup Remote Options” Submenu

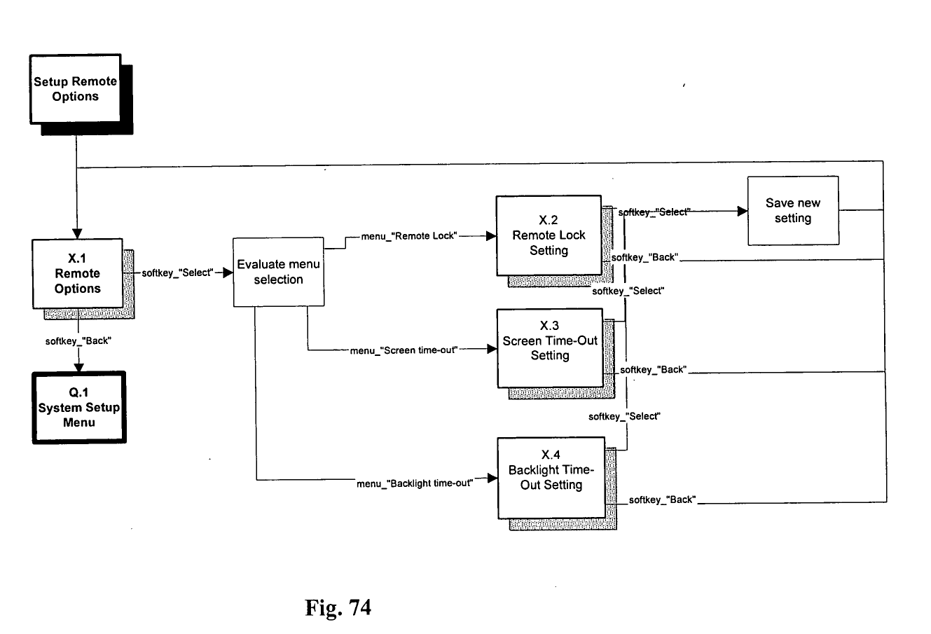

FIG. 74 is a flowchart illustrating an exemplary embodiment of a “setup remote options” submenu component of a user interface computer program according to the present disclosure, which is operated on the remote controller of FIG. 5 after the “setup remote options” submenu has been selected from the system setup submenu of FIG. 60.

Referring to FIGS. 60 and 74, a Remote Options X.1 screen lists the remote options and allows the user to select and edit them. Each option is shown by name, with its value in parenthesis. In FIG. 74 a Remote Lock Setting X.2 screen is a menu listing the two options for the remote lock: on or off. A Screen Time-Out Setting X.3 screen is a menu listing the menu options for the a screen time out: e.g., 15, 30, or 60 seconds, and a Backlight Time-Out Setting X.4 screen shows a menu listing the options for the backlight time-out: e.g., 15, 30, or 60 seconds.

“Run Diagnostics” Submenu

FIG. 75 is a flowchart illustrating an exemplary embodiment of a “run diagnostics” submenu component of a user interface computer program according to the present disclosure, which is operated on the remote controller of FIG. 5 after the “run diagnostics” submenu has been selected from the system setup submenu of FIG. 60.

Referring to FIGS. 60 and 75, a Diagnostics Menu Y.1 screen lists the diagnostics options and allows the user to select and perform them. Each option is shown by name. In FIG. 75 a Check Alarm Function Y.2 screen requires the user to confirm checking the alarm function on their system (pump and remote). Upon confirmation, pump and remote will alarm/alert (three information beeps on remote and then on pump; vibratory alarm on remote).

A Restore Remote Default Settings Y.3 screen requires that no pump is currently active. This screen requires the user to confirm that they want to restore the remote factory default settings. Confirming will take user back to the setup wizard. A Remote Reset Denied—Pump Active Y.4 screen informs the user that they cannot reset remote defaults because there is a pump active.

An Alarm Function Check in Process Y.5 screen informs the user to that the remote is in the process of checking the alarm function of their system (pump and remote). Upon confirmation on Y.2, this screen will display and show “Checking alarms” until completed. Once the tests have completed, the Diagnostics Menu Y.1 screen will return.

“Suspend/Cancel” Submenu

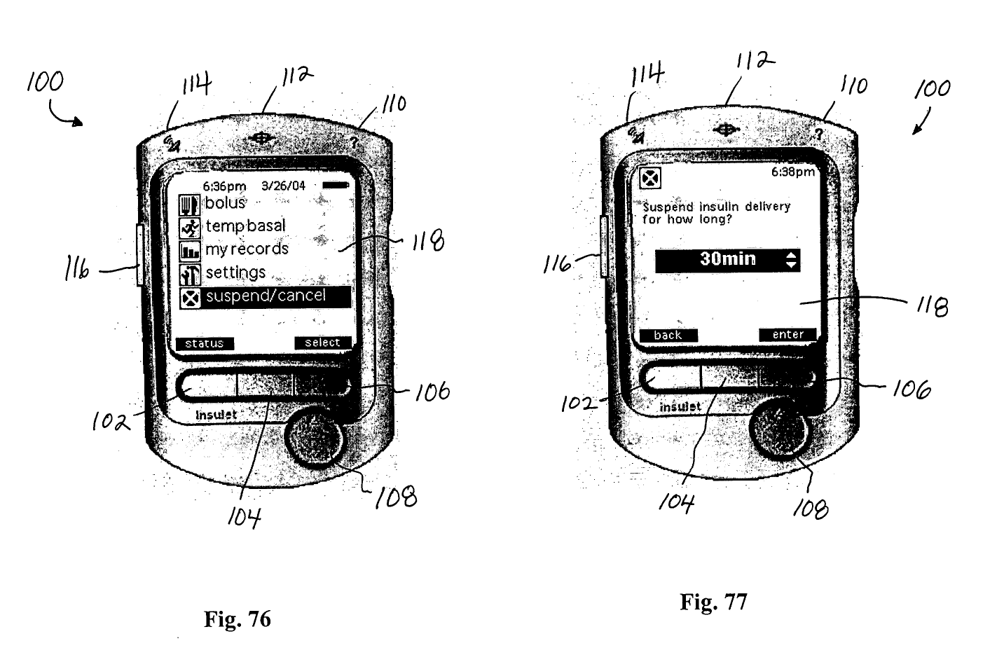

FIG. 76 is a front elevation view of the remote controller of FIG. 5, wherein the menu screen is displayed on the remote controller and a “suspend/cancel” submenu selection is highlighted. FIG. 77 is a front elevation view of the remote controller after the “suspend/cancel” submenu has been selected from the menu screen of FIG. 13.

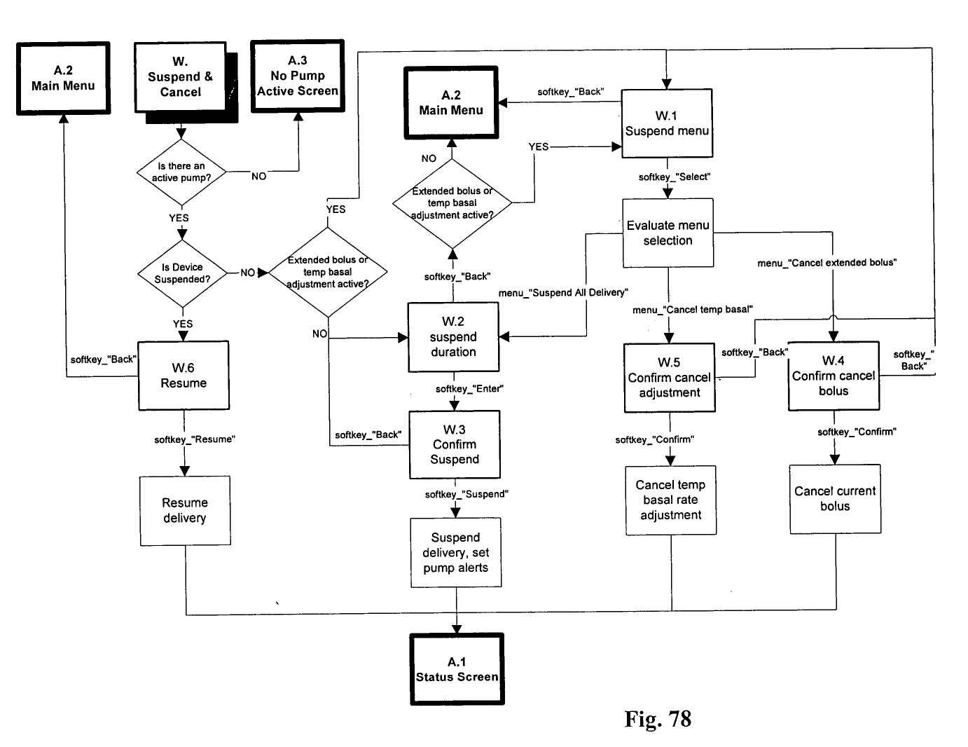

FIG. 78 is a flowchart illustrating an exemplary embodiment of a suspend/cancel submenu component of a user interface computer program according to the present disclosure, which is operated on the remote controller of FIG. 5 after the “suspend/cancel” submenu has been selected. In general, the suspend delivery instructions include initiating a hazard alarm through the user interface components when the suspend delivery mode has been in effect greater than a predetermined suspend period. The user is allowed to set the predetermined suspend period through the user interface components, but not greater then a predetermined maximum suspend period. An advisory alarm is also periodically initiate by the system through the user interface components when the suspend delivery mode is in effect.

Referring to the exemplary embodiments of FIG. 78, a Suspend Menu W.1 screen lists the Suspend & Cancel options available. A Suspend Duration W.2 duration-entry screen allows the user to specify the length of time to suspend insulin delivery, a Confirm Suspend Insulin W.3 screen requires the user to confirm a suspension of insulin delivery, a Confirm Cancel Extended Bolus W.4 screen requires the user to confirm the cancellation of a bolus, a Confirm Cancel Temp Basal Rate W.5 screen asks the user if they would like to turn off the current temp basal rate, and a Resume W.6 screen asks the user if they would like to turn off the “suspend” state of the system.

Although exemplary embodiments of the disclosure have been shown and described, many changes, modifications and substitutions may be made by those having ordinary skill in the art without necessarily departing from the spirit and scope of this disclosure.

1. A system for delivering fluid to a patient comprising:
an infusion pump; and
a control system controlling the infusion pump and including,
user interface components for allowing a user to receive and provide information,
a processor connected to the user interface components and adapted to provide instructions to the infusion pump, and
a computer program having setup instructions that cause the processor to enter a setup mode upon the control system first being turned on that includes prompting the user, in a sequential manner, through the user interface components to input basic information for use by the processor in controlling the infusion pump, and allowing the user to operate the infusion pump only after the user has completed the setup mode.

2. The system of claim 1, wherein the setup instructions cause the processor to exit the setup mode only after the user inputs each item of the basic information.

3. The system of claim 2, wherein the setup instructions cause the processor to use default basic information if the user aborts the setup mode.

4. The system of claim 1, wherein the items of basic information include at least two of a current time, a current date, a preferred date display format, a maximum basal rate, a starting basal rate, a bolus increment, a maximum bolus dose, whether to enable a missed bolus reminder, whether to enable an external bolus function, and whether to enable a low reservoir volume alert level.

5. The system of claim 4, wherein the items of basic information further include a blood glucose unit preference, a blood glucose lower range limit, a blood glucose upper range limit, a blood glucose target value, a target blood glucose correction value, an insulin to carbohydrate ratio, a correction factor, a carbohydrate preset value, and an insulin duration.

6. The system of claim 1, wherein the user interface components comprise a display screen and the setup instructions cause the processor to display a sequence of screens on the display screen, and wherein each screen prompts the user to enter one of the items of basic information.

7. The system of claim 6, wherein the user interface components comprise keys for allowing a user to move sequentially forward and backward through the sequence of screens.

8. The system of claim 1, wherein the setup instructions cause the processor to alert the user if the items of basic information are inconsistent.

9. The system of claim 8, wherein the setup instructions cause the processor to prompt the user to reenter at least one of the items of basic information to resolve the inconsistency.

10. The system of claim 1, wherein the setup instructions cause the processor to prompt the user to select between a main menu and a new pump activation after the user has completed the setup mode.

11. The system of claim 1, wherein the infusion pump comprises:
an exit port,
a reservoir connected to the exit port,
a dispenser for causing fluid within the reservoir to be dispensed through the exit port,
a wireless receiver connected to the dispenser and adapted to receive remotely transmitted flow instructions that instruct the dispenser to dispense fluid.

12. The system of claim 11, further comprises a remote controller separate from the infusion pump and including:
the user interface components;
a wireless transmitter for transmitting the flow instructions to the receiver of the infusion pump;
the processor connected to the user interface components and the transmitter; and
the computer program further including instructions that cause the processor to receive information from a user through the user interface components, calculate flow instructions based on the information and provide the flow instructions to the transmitter.

13. The system of claim 11, wherein the infusion pump includes a transcutaneous patient access tool connected to the exit port.

14. The system of claim 11, wherein the infusion pump includes a housing containing the exit port, the reservoir, the dispenser and the wireless receiver, and wherein the housing is free of user input components for providing flow instructions to the dispenser.

15. A machine-readable medium having stored thereon instructions for a control system of an infusion pump for delivering fluid to a patient, wherein the instructions comprise:
operating instructions that cause the control system to receive information from a user through user interface components of the control system, calculate flow instructions based on the information and transmit the flow instructions to the infusion pump; and
setup instructions that cause the control system to enter a setup mode that includes prompting the user, in a sequential manner, through the user interface components to input basic information for use by the control system in computing the flow instructions, and allowing the user to operate the infusion pump through the control system only after the user has completed the setup mode.

16. The medium of claim 15, wherein the setup instructions cause the control system to exit the setup mode only after the user inputs each item of the basic information.

17. The medium of claim 16, wherein the setup instructions cause the control system to use default basic information if the user aborts the setup mode.

18. The medium of claim 15, wherein the items of basic information include at least two of a current time, a current date, a preferred date display format, a maximum basal rate, a starting basal rate, a bolus increment, a maximum bolus dose, whether to enable a missed bolus reminder, whether to enable an external bolus function, and whether to enable a low reservoir volume alert level.

19. The medium of claim 18, wherein the items of basic information further include a blood glucose unit preference, a blood glucose lower range limit, a blood glucose upper range limit, a blood glucose target value, a target blood glucose correction value, an insulin to carbohydrate ratio, a correction factor, a carbohydrate preset value, and an insulin duration.

20. The medium of claim 15, wherein the setup instructions are run only upon the control system being turned on for a first time.

21. A method for controlling a control system of an infusion pump for delivering fluid to a patient, comprising:
instructing a processor of the control system to receive information from a user through user interface components of the control system, calculate flow instructions based on the information and provide the flow instructions to the infusion pump; and
instructing the processor to enter a setup mode that includes prompting the user, in a sequential manner, through the user interface components to input basic information for use by the processor in computing the flow instructions, and allowing the user to operate the infusion pump through the control system only after the user has completed the setup mode.

22. The method of claim 21, wherein the processor of the control system is instructed to exit the setup mode only after the user inputs each item of the basic information.

23. The method of claim 22, wherein the processor is instructed to use default basic information if the user aborts the setup mode.

24. The method of claim 21, wherein the items of basic information include at least two of a current time, a current date, a preferred date display format, a maximum basal rate, a starting basal rate, a bolus increment, a maximum bolus dose, whether to enable a missed bolus reminder, whether to enable an external bolus function, and whether to enable a low reservoir volume alert level.

25. The method of claim 24, wherein the items of basic information further include a blood glucose unit preference, a blood glucose lower range limit, a blood glucose upper range limit, a blood glucose target value, a target blood glucose correction value, an insulin to carbohydrate ratio, a correction factor, a carbohydrate preset value, and an insulin duration.

26. The method of claim 21, wherein the processor is instructed to enter the setup mode only upon the control system being turned on for a first time.

27. A system for delivering fluid to a patient comprising:
an infusion pump; and
a control system for controlling the infusion pump, including,
user interface components for allowing a user to receive and provide information,
a processor connected to the user interface components and adapted to provide instructions to the infusion pump including bolus dose instructions, and
a computer program having instructions for operating the processor, including bolus dose instructions that are initiated upon the user selecting a bolus dose through the user interface components and that instruct the processor to prompt a user through the user interface components for information regarding the bolus dose and then calculate flow instructions for causing the infusion pump to deliver the bolus dose,
wherein the bolus dose instructions include instructing the processor to require the user to specify whether the bolus dose is a normal bolus dose or an extended bolus dose.

28. The system of claim 27, wherein the computer program further comprises expedited bolus dose instructions that are initiated upon the user selecting an expedited bolus dose through the user interface components and that instruct the processor to prompt a user through the user interface components for information regarding the expedited bolus dose without requiring the user to specify whether the bolus dose is a normal bolus dose or an extended bolus dose.

29. The system of claim 28, wherein the expedited bolus dose instructions cause the processor to default to one of a normal bolus dose and an extended bolus dose.

30. The system of claim 29, wherein the expedited bolus dose instructions cause the processor to allow a user to define the default as one of a normal bolus dose and an extended bolus dose.

31. The system of claim 28, wherein the user interface components include a key dedicated to initiating the expedited bolus instructions.

32. The system of claim 31, wherein the key dedicated to initiating the expedited bolus instructions is further used to increase the bolus increment once the expedited bolus instructions are initiated.

33. The system of claim 27, wherein, if the user specifies that the bolus dose is an extended bolus dose, the bolus dose instructions further comprise instructing the processor to require the user to specify an amount of the bolus dose to be immediately infused and to specify a duration of infusion for the remainder of the bolus dose.

34. The system of claim 27, wherein the user interface components comprise a display screen and the processor displays a sequence of screens on the display screen, wherein each screen prompts the user to enter information, and the user interface components comprise keys for allowing the user to move sequentially forward and backward through the sequence of screens.

35. The system of claim 27, wherein the infusion pump comprises:
an exit port,
a reservoir connected to the exit port,
a dispenser for causing fluid within the reservoir to be dispensed through the exit port,
a wireless receiver connected to the dispenser and adapted to receive remotely transmitted flow instructions that instruct the dispenser to dispense fluid.

36. The system of claim 35, further comprises a remote controller separate from the infusion pump and including:
the user interface components;
a wireless transmitter for transmitting the flow instructions to the receiver of the infusion pump;
the processor connected to the user interface components and the transmitter; and
the computer program further including instructions that cause the processor to receive information from a user through the user interface components, calculate flow instructions based on the information and provide the flow instructions to the transmitter.

37. The system of claim 35, wherein the infusion pump includes a transcutaneous patient access tool connected to the exit port.

38. The system of claim 35, wherein the infusion pump includes a housing containing the exit port, the reservoir, the dispenser and the wireless receiver, and wherein the housing is free of user input components for providing flow instructions to the dispenser.

39. A machine-readable medium having stored thereon instructions for a control system of an infusion pump for delivering fluid to a patient, wherein the instructions comprise:
bolus dose instructions that are initiated upon the user selecting a bolus dose through user interface components of the control system and that instruct a processor of the control system to prompt a user through the user interface components for information regarding the bolus dose and then calculate flow instructions for causing the infusion pump to deliver the bolus dose,
wherein the bolus dose instructions include instructing the processor to require the user to specify whether the bolus dose is a normal bolus dose or an extended bolus dose.

40. The medium of claim 39, wherein the instructions further comprise expedited bolus dose instructions that are initiated upon the user selecting an expedited bolus dose through the user interface components and that instruct the processor to prompt a user through the user interface components for information regarding the expedited bolus dose without requiring the user to specify whether the bolus dose is a normal bolus dose or an extended bolus dose.

41. The medium of claim 40, wherein the expedited bolus dose instructions cause the processor to default to one of a normal bolus dose and an extended bolus dose.

42. The medium of claim 41, wherein the expedited bolus dose instructions cause the processor to allow a user to define the default as one of a normal bolus dose and an extended bolus dose.

43. The medium of claim 40, wherein, if the user specifies that the bolus dose is an extended bolus dose, the bolus dose instructions further comprise instructing the processor to require the user to specify an amount of the bolus dose to be immediately infused and to specify a duration of infusion for the remainder of the bolus dose.

44. A method for controlling a fluid delivery system including an infusion pump, comprising:
instructing a processor of the system to prompt a user through user interface components of the system for information regarding a bolus dose, upon a user selecting a bolus dose through the user interface components;
instructing the processor to calculate flow instructions for causing the infusion pump to deliver the bolus dose; and
instructing the processor to require the user to specify whether the bolus dose is a normal bolus dose or an extended bolus dose.

45. The method of claim 44, further comprising instructing the processor to prompt a user through the user interface components for information regarding an expedited bolus dose upon the user selecting an expedited bolus dose through the user interface components, and without requiring the user to specify whether the expedited bolus dose is a normal bolus dose or an extended bolus dose.

46. The method of claim 45, further comprising instructing the processor to default to one of a normal bolus dose and an extended bolus dose upon the user selecting the expedited bolus dose.

47. The method of claim 46, further comprising instructing the processor to allow a user to define the default for the expedited bolus dose as one of a normal bolus dose and an extended bolus dose.

48. The method of claim 44, wherein, if the user specifies that the bolus dose is an extended bolus dose, the method further comprises instructing the processor to require the user to specify an amount of the bolus dose to be immediately infused.

49. The method of claim 48, further comprising instructing the processor to require the user to specify a duration of infusion for the remainder of the bolus dose.

50. A system for delivering fluid to a patient comprising:
an infusion pump; and
a control system for controlling the infusion pump, including,
user interface components for allowing a user to receive and provide information,
a processor connected to the user interface components and adapted to provide instructions to the infusion pump, and
a computer program having instructions for operating the processor, including suspend delivery instructions that are initiated upon the user selecting a suspend delivery mode through the user interface components and that instruct the processor to provide instructions for causing the infusion pump to suspend deliver of fluid,
wherein the suspend delivery instructions include instructing the processor to initiate a hazard alarm through the user interface components when the suspend delivery mode has been in effect greater than a predetermined suspend period.

51. The system of claim 50, wherein the suspend delivery instructions instruct the processor to allow the user to set the predetermined suspend period through the user interface components.

52. The system of claim 51, wherein the suspend delivery instructions instruct the processor to allow the user to set the predetermined suspend period not greater then a predetermined maximum suspend period.

53. The system of claim 50, wherein the suspend delivery instructions instruct the processor to allow the user to terminate the hazard alarm through the user interface components.

54. The system of claim 50, wherein the hazard alarm is at least one of a continuous audible alarm, an intermittent audible alarm, a vibratory alarm, and a visual alarm provided through the user interface components.

55. The system of claim 50, wherein the suspend delivery instructions include instructing the processor to periodically initiate an advisory alarm through the user interface components when the suspend delivery mode is in effect.

56. The system of claim 55, wherein the advisory alarm is at least one of a continuous audible alarm, an intermittent audible alarm, a vibratory alarm, and a visual alarm provided through the user interface components.

57. The system of claim 50, wherein the suspend delivery instructions include instructing the processor to check that the infusion pump is active and if the infusion pump is already in the suspend mode.

58. The system of claim 50, wherein the suspend delivery instructions include instructing the processor to:
check whether the infusion pump is operating under a temporary basal rate program or an extended bolus program; and
allow the user to choose between canceling one of the temporary basal rate program and the extended bolus program, canceling both of the temporary basal rate program and the extended bolus program, and suspending all fluid delivery.

59. The system of claim 50, wherein the infusion pump comprises:
an exit port,
a reservoir connected to the exit port,
a dispenser for causing fluid within the reservoir to be dispensed through the exit port,
a wireless receiver connected to the dispenser and adapted to receive remotely transmitted flow instructions that instruct the dispenser to dispense fluid.

60. The system of claim 59, further comprises a remote controller separate from the infusion pump and including:
the user interface components;
a wireless transmitter for transmitting the flow instructions to the receiver of the infusion pump;
the processor connected to the user interface components and the transmitter; and
the computer program further including instructions that cause the processor to receive information from a user through the user interface components, calculate flow instructions based on the information and provide the flow instructions to the transmitter.

61. The system of claim 59, wherein the infusion pump includes a transcutaneous patient access tool connected to the exit port.

62. The system of claim 59, wherein the infusion pump includes a housing containing the exit port, the reservoir, the dispenser and the wireless receiver, and wherein the housing is free of user input components for providing flow instructions to the dispenser.

63. A machine-readable medium having stored thereon suspend delivery instructions for a control system of an infusion pump for delivering fluid to a patient, wherein the instructions are initiated upon a user selecting a suspend delivery mode through user interface components of the control system and that include:
instructing the control system to provide instructions for causing the infusion pump to suspend delivery of fluid; and
instructing the system to initiate a hazard alarm through the user interface components when the suspend delivery mode has been in effect greater than a predetermined suspend period.

64. The medium of claim 63, wherein the suspend delivery instructions instruct the processor to allow the user to set the predetermined suspend period through the user interface components.

65. The medium of claim 64, wherein the suspend delivery instructions instruct the processor to allow the user to set the predetermined suspend period not greater then a predetermined maximum suspend period.

66. The medium of claim 63, wherein the suspend delivery instructions instruct the processor to allow the user to terminate the hazard alarm through the user interface components.

67. The medium of claim 63, wherein the suspend delivery instructions include instructing the processor to periodically initiate an advisory alarm through the user interface components when the suspend delivery mode is in effect.

68. The medium of claim 63, wherein the suspend delivery instructions include instructing the control system to check whether the infusion pump is active and, if active, whether the infusion pump is already in the suspend mode.

69. The medium of claim 63, wherein the suspend delivery instructions include instructing the control system to:
check whether the infusion pump is operating under a temporary basal rate program or an extended bolus program; and
allow the user to choose between canceling one of the temporary basal rate program and the extended bolus program, canceling both of the temporary basal rate program and the extended bolus program, and suspending all fluid delivery.

70. A method for controlling a fluid delivery system including an infusion pump, comprising:
initiating suspend delivery instructions upon a user selecting a suspend delivery mode through user interface components of the system;
instructing the fluid delivery system to provide instructions for causing the infusion pump to suspend delivery of fluid; and
instructing the fluid delivery system to initiate a hazard alarm through the user interface components when the suspend delivery mode has been in effect greater than a predetermined suspend period.

71. The method of claim 70, further comprising instructing the processor to allow the user to set the predetermined suspend period through the user interface components.

72. The method of claim 71, further comprising instructing the processor to allow the user to set the predetermined suspend period not greater then a predetermined maximum suspend period.

73. The method of claim 70, further comprising instructing the processor to allow the user to terminate the hazard alarm through the user interface components.

74. The method of claim 71, further comprising instructing the processor to periodically initiate an advisory alarm through the user interface components when the suspend delivery mode is in effect.

75. The method of claim 70, further comprising instructing the fluid delivery system to check whether the infusion pump is active and, if active, whether the infusion pump is already in the suspend mode.

76. The method of claim 70, further comprising instructing the fluid delivery system to:
check whether the infusion pump is operating under a temporary basal rate program or an extended bolus program; and
allow the user to choose between canceling one of the temporary basal rate program and the extended bolus program, canceling both of the temporary basal rate program and the extended bolus program, and suspending all fluid delivery.

77. A system for delivering fluid to a patient comprising:
an infusion pump; and
a control system for controlling the infusion pump, including,
user interface components for allowing a user to receive and provide information,
a processor connected to the user interface components and adapted to provide instructions to the infusion pump, and
a computer program having instructions for operating the processor, including change pump instructions that that are initiated upon the user selecting a change pump option through the user interface components and that instruct the processor to sequentially prompt the user through the user interface components to take predetermined actions to prepare the replacement infusion pump to deliver fluid to a patient, wherein the actions include at least one of,
checking whether an infusion pump is currently active,
deactivating the infusion pump if the infusion pump is active,
removing the infusion pump if the infusion pump is deactivated,
filling a replacement infusion pump,
setting a unique ID for the replacement infusion pump,
priming the replacement infusion pump,
removing an adhesive cover from the replacement infusion pump and securing the replacement infusion pump on a skin surface of the patient using the adhesive,
activating an insertion assembly of the replacement infusion pump, and
begin basal delivery from the replacement infusion pump.

78. The system of claim 77, wherein the change pump instructions include filling a replacement infusion pump, setting a unique ID for the replacement infusion pump, priming the replacement infusion pump, activating an insertion assembly of the replacement infusion pump, and beginning a basal delivery from the replacement infusion pump.

79. The system of claim 77, wherein the change pump instructions include filling a replacement infusion pump, setting a unique ID for the replacement infusion pump, priming the replacement infusion pump, and beginning a basal delivery from the replacement infusion pump.

80. The system of claim 77, wherein the change pump instructions include instructing the processor to prompt the user through the user interface components for confirmation of a pump change after checking whether the infusion pump is active and before deactivating the infusion pump if the infusion pump is active.

81. The system of claim 77, wherein the change pump instructions include instructing the processor to prompt the user through the user interface components to remove the infusion pump if the infusion pump is deactivated.

82. The system of claim 77, wherein the change pump instructions include instructing the processor to prompt the user through the user interface components to fill the replacement infusion pump.

83. The system of claim 77, wherein the change pump instructions include instructing the processor to prompt the user through the user interface components that the replacement infusion pump is ready to be primed after setting a unique ID for the replacement infusion pump, and priming the replacement infusion pump only after the user responds.

84. The system of claim 77, wherein the change pump instructions include instructing the processor to prompt the user through the user interface components to remove the adhesive cover from the replacement infusion pump.

85. The system of claim 77, wherein the change pump instructions include instructing the processor to prompt the user through the user interface components to start delivery before activating the insertion assembly of the replacement infusion pump, and beginning basal delivery from the replacement infusion pump.

86. The system of claim 77, wherein the change pump instructions further includes instructing the processor to obtain the pump status and indicate to the user through the user interface components that basal delivery from the replacement infusion pump has begun.

87. The system of claim 77, wherein the infusion pump comprises:
an exit port,
a reservoir connected to the exit port,
a dispenser for causing fluid within the reservoir to be dispensed through the exit port,
a wireless receiver connected to the dispenser and adapted to receive remotely transmitted flow instructions that instruct the dispenser to dispense fluid.

88. The system of claim 87, further comprising a remote controller separate from the infusion pump and including:
the user interface components;
a wireless transmitter for transmitting the flow instructions to the receiver of the infusion pump;
the processor connected to the user interface components and the transmitter; and
the computer program further including instructions that cause the processor to receive information from a user through the user interface components, calculate flow instructions based on the information and provide the flow instructions to the transmitter.

89. The system of claim 87, wherein the infusion pump includes a transcutaneous patient access tool connected to the exit port.

90. The system of claim 87, wherein the infusion pump includes a housing containing the exit port, the reservoir, the dispenser and the wireless receiver, and wherein the housing is free of user input components for providing flow instructions to the dispenser.

91. A machine-readable medium having stored thereon change pump instructions for a control system of an infusion pump, wherein the change pump instructions include instructing the control system to sequentially prompt a user through user interface components of the control system to take predetermined actions to prepare a replacement infusion pump to deliver fluid to a patient, wherein the actions include at least one of,
checking whether an infusion pump is currently active,
deactivating the infusion pump if the infusion pump is active,
removing the infusion pump if the infusion pump is deactivated,
filling a replacement infusion pump,
setting a unique ID for the replacement infusion pump,
priming the replacement infusion pump,
removing an adhesive cover from the replacement infusion pump and securing the replacement infusion pump on a skin surface of the patient using the adhesive,
activating an insertion assembly of the replacement infusion pump, and
begin basal delivery from the replacement infusion pump.

92. The medium of claim 91, wherein the change pump instructions include filling the replacement infusion pump, setting a unique ID for the replacement infusion pump, priming the replacement infusion pump, activating an insertion assembly of the replacement infusion pump, and beginning a basal delivery from the replacement infusion pump.

93. The medium of claim 91, wherein the change pump instructions include filling the replacement infusion pump, setting a unique ID for the replacement infusion pump, priming the replacement infusion pump, and beginning a basal delivery from the replacement infusion pump.

94. The medium of claim 91, wherein the change pump instructions include instructions to prompt the user through the user interface components for confirmation of a pump change after checking whether an infusion pump is active and before deactivating the infusion pump if the infusion pump is active.

95. The medium of claim 91, wherein the change pump instructions include instructions to prompt the user through the user interface components to remove the infusion pump if the current infusion pump is deactivated.

96. The medium of claim 91, wherein the change pump instructions include instructions to prompt the user through the user interface components to fill the replacement infusion pump.

97. The medium of claim 91, wherein the change pump instructions include instructions to prompt the user through the user interface components that the replacement infusion pump is ready to be primed after setting a unique ID for the replacement infusion pump, and priming the replacement infusion pump only after the user responds.

98. The medium of claim 91, wherein the change pump instructions include instructions to prompt the user through the user interface components to remove the adhesive cover from the replacement infusion pump.

99. The medium of claim 91, wherein the change pump instructions include instructions to prompt the user through the user interface components to start delivery before activating the insertion assembly of the replacement infusion pump, and beginning basal delivery from the replacement infusion pump.

100. The medium of claim 99, wherein the change pump instructions further includes instructions to obtain the pump status and indicate to the user through the user interface components that basal delivery from the replacement infusion pump has begun.

101. A method for controlling a fluid delivery system including an infusion pump, comprising instructing the system to sequentially prompt a user through user interface components of the system to take predetermined actions to prepare a replacement infusion pump to deliver fluid to a patient, wherein the actions include at least one of:
checking whether an current infusion pump is currently active,
deactivating the current infusion pump,
removing the current infusion pump,
filling a replacement infusion pump,
setting a unique ID for the replacement infusion pump,
priming the replacement infusion pump,
removing an adhesive cover from the replacement infusion pump and securing the replacement infusion pump on a skin surface of the patient using the adhesive,
activating an insertion assembly of the replacement infusion pump, and
begin basal delivery from the replacement infusion pump.

102. The method of claim 101, wherein the actions include filling the replacement infusion pump, setting a unique ID for the replacement infusion pump, priming the replacement infusion pump, activating an insertion assembly of the replacement infusion pump, and beginning a basal delivery from the replacement infusion pump.

103. The method of claim 101, wherein the actions include filling the replacement infusion pump, setting a unique ID for the replacement infusion pump, priming the replacement infusion pump, and beginning a basal delivery from the replacement infusion pump.

104. The method of claim 101, further comprising instructing the system to prompt the user for confirmation of a pump change after checking whether an current infusion pump is active and before deactivating the current infusion pump.

105. The method of claim 101, further comprising instructing the system to prompt the user to remove the current infusion pump if the current infusion pump is deactivated.

106. The method of claim 101, further comprising instructing the system to prompt the user to fill the replacement infusion pump.

107. The method of claim 101, further comprising instructing the system to inform the user that the replacement infusion pump is ready to be primed after setting a unique ID for the replacement infusion pump, and priming the replacement infusion pump only after the user responds.

108. The method of claim 101, further comprising instructing the system to prompt the user to remove the adhesive cover from the replacement infusion pump.

109. The method of claim 101, further comprising instructing the system to prompt the user to start delivery before activating the insertion assembly of the replacement infusion pump, and beginning basal delivery from the replacement infusion pump.

110. The method of claim 109, further comprising instructing the system to obtain a status of the replacement pump and indicate to the user through the user interface components whether basal delivery from the replacement pump has begun.

111. A system for delivering fluid to a patient comprising:
an infusion pump; and
a control system for controlling the infusion pump, including,
user interface components for allowing a user to receive and provide information,
a processor connected to the user interface components and adapted to provide instructions to the infusion pump, and
a computer program having instructions for operating the processor, including a continuous basal rate delivery program comprising one or more segments that are continuously executed by the processor to deliver a continuous basal rate and new basal rate segments that are executed by the processor upon the user selecting a new basal rate through the user interface components and that instruct the processor to:
prompt the user through the user interface components to enter a fluid delivery rate for a new basal segment, and at least two of a start time for the new basal segment, an end time and a duration for the new basal segment;
create a new basal segment delivery program using the delivery rate input by the user for the new basal segment;
calculate the end time based on the start time and the duration, if the end time was not entered for the new basal segment; and
create a new basal rate delivery program by inserting the new basal segment delivery program into the continuous basal rate delivery program between the start time and the end time.

112. The system of claim 111, wherein, for each new basal rate delivery program, the new basal segment instructs the processor to prompt the user to enter whether the just-created new basal rate delivery programs should overwrite previously created new basal rate delivery programs.

113. The system of claim 111, wherein a duration of the continuous basal rate delivery program is 24 hours and the new basal segment delivery program has a duration of between 30 minutes and 24 hours.

114. The system of claim 111, wherein the new basal rate delivery program instructs the processor to determine whether the fluid delivery rate for the new basal segment that the user has selected, for the duration selected, will result in a flow rate that is beyond a predetermined flow rate range.

115. The system of claim 111, wherein the fluid delivery rate for the new basal segment is entered in units per hour.

116. The system of claim 111, wherein the fluid delivery rate for the new basal segment is entered as a percentage of the continuous basal rate.

117. The system of claim 111, wherein the infusion pump comprises:
an exit port,
a reservoir connected to the exit port,
a dispenser for causing fluid within the reservoir to be dispensed through the exit port,
a wireless receiver connected to the dispenser and adapted to receive remotely transmitted flow instructions that instruct the dispenser to dispense fluid.

118. The system of claim 117, further comprises a remote controller separate from the infusion pump and including:
the user interface components;
a wireless transmitter for transmitting the flow instructions to the receiver of the infusion pump;
the processor connected to the user interface components and the transmitter; and
the computer program further including instructions that cause the processor to receive information from a user through the user interface components, calculate flow instructions based on the information and provide the flow instructions to the transmitter.

119. The system of claim 117, wherein the infusion pump includes a transcutaneous patient access tool connected to the exit port.

120. The system of claim 117, wherein the infusion pump includes a housing containing the exit port, the reservoir, the dispenser and the wireless receiver, and wherein the housing is free of user input components for providing flow instructions to the dispenser.

121. A machine-readable medium having stored thereon new basal segment for a control system of an infusion pump for delivering fluid to a patient, wherein a continuous basal rate delivery program is continuously executed by the control system to deliver a continuous basal rate while the new basal segment are executed when a user selects a new basal rate through user interface components of the control system and wherein the new basal segment instruct the control system to:
prompt the user through the user interface components to enter a fluid delivery rate for a new basal segment, a start time for the new basal segment, and one of an end time and a duration for the new basal segment;
create a new basal segment delivery program using the delivery rate input by the user for the new basal segment;
calculate the end time based on the start time and the duration input by the user, if the duration is entered for the new basal segment; and
create a new basal rate delivery program by inserting the new basal segment delivery program into the continuous basal rate delivery program between the start time and the end time.

122. The medium of claim 121, wherein, for each new basal rate delivery program, the new basal segment instruct the processor to prompt the user to enter whether the just created new basal rate delivery programs should overwrite previously created new basal rate delivery programs.

123. The medium of claim 121, wherein a duration of the continuous basal rate delivery program is 24 hours and the new basal segment delivery program has a duration of between 30 minutes and 24 hours.

124. The medium of claim 121, wherein the new basal segment instruct the control system to determine whether the new basal segment that the user has selected, for the duration selected, will result in a flow rate that is beyond a predetermined flow rate range.

125. The medium of claim 121, wherein the fluid delivery rate for the new basal segment is entered in units per hour.

126. The medium of claim 121, wherein the fluid delivery rate for the new basal segment is entered as a percentage of the continuous basal rate.

127. A method for controlling a fluid delivery system including an infusion pump, comprising:
instructing the fluid delivery system to execute a continuous basal rate delivery program so that the infusion pump delivers a continuous basal rate; and
instructing the fluid delivery system to execute new basal segment upon a user selecting a new basal rate through user interface components of the fluid delivery system, wherein the new basal segment cause the fluid delivery system to,
prompt the user through the user interface components to enter a fluid delivery rate for a new basal segment, a start time for the new basal segment, and one of an end time and a duration for the new basal segment,
create a new basal segment delivery program using the delivery rate entered by the user for the new basal segment;
calculate the end time based on the start time and the duration, if the duration is entered for the new basal segment; and
create a new basal rate delivery program by inserting the new basal segment delivery program into the continuous basal rate delivery program between the start time and the end time.

128. The method of claim 127, wherein, for each new basal rate delivery program, the new basal segment instruct the processor to prompt the user to enter whether the just created new basal rate delivery programs should overwrite previously created new basal rate delivery programs.

129. The method of claim 127, wherein a duration of the continuous basal rate delivery program is 24 hours and the new basal segment delivery program has a duration between 30 minutes and 24 hours.

130. The method of claim 127, wherein the new basal segment cause the fluid delivery system to determine whether the new basal segment that the user has selected, for the duration selected, will result in a flow rate that is beyond a predetermined flow rate range.

131. The method of claim 127, wherein the fluid delivery rate for the new basal segment is entered in units per hour.

132. The method of claim 127, wherein the fluid delivery rate for the new basal segment is entered as a percentage of the continuous basal rate.

133. A system for delivering fluid to a patient comprising:
an infusion pump; and
a control system for controlling the infusion pump, including,
user interface components for allowing a user to receive and provide information,
a processor connected to the user interface components and adapted to provide instructions to the infusion pump including bolus dose delivery instructions, and
a computer program having instructions for operating the processor, including suggested bolus dose calculation instructions that are initiated upon the user turning on a bolus calculator and selecting a bolus dose through the user interface components and that instruct the processor to prompt the user through the user interface components for information regarding the bolus dose and then calculate a suggested bolus dose for display to the user, wherein the suggested bolus dose calculation instructions include,
instructing the processor to request and receive from the user,
a target blood glucose value for the patient,
a current blood glucose value for the patient,
a correction factor for the patient,
a duration of insulin action value, in minutes, for the patient,
an insulin to carbohydrate ratio for the patient, and
grams of carbohydrates and grams of fiber to be eaten, if any,
calculate a suggested bolus dose equal to a correction bolus minus insulin on board the patient plus a carbohydrate bolus, if the current blood glucose value is above the target blood glucose, wherein,
the correction bolus is equal to the current blood glucose minus the target blood glucose divided by the correction factor,
the insulin on board is equal to, for each previous bolus dose administered to the patient within the duration of insulin action, a total correction volume of the previous bolus dose, in units, multiplied by one minus an elapsed time in minutes since the previous bolus was administered divided by the duration of insulin action, in minutes, and
the carbohydrate bolus is equal to the grams of carbohydrates minus the grams of fiber divided by the insulin to carbohydrate ratio.

134. The system of claim 133, wherein the suggested bolus dose calculation instructions further comprise instructing the processor to calculate a suggested bolus dosage equal to a reverse correction bolus plus the carbohydrate bolus if the current blood glucose value is less than the target blood glucose value, and the user has enabled reverse correction boluses through the user interface components.

135. The system of claim 133, wherein the suggested bolus dose calculation instructions further comprise instructing the processor to calculate a suggested bolus dosage equal to the carbohydrate bolus if the current blood glucose value is less than the target blood glucose value, and the user has disabled reverse correction boluses through the user interface components.

136. The system of claim 133, wherein the suggested bolus dose calculation instructions further comprise instructing the processor to calculate a suggested bolus dosage equal to the carbohydrate bolus if the current blood glucose value is unknown.

137. The system of claim 133, wherein the suggested bolus dose calculation instructions further comprise instructing the processor to not suggest a bolus to the user if the current blood glucose reading is outside of a predetermined range.

138. The system of claim 133, wherein the suggested bolus dose calculation instructions further comprise instructing the processor to request and receive from the user a maximum bolus dose and to inform the user that the calculated suggested bolus dose exceeds the maximum bolus dose, and offer the user the option to cancel or temporarily override the maximum bolus dose if the suggested bolus dose exceeds the maximum bolus dose.

139. The system of claim 133, wherein the suggested bolus dose calculation instructions further comprise instructing the processor to request and receive from the user a target blood glucose correction threshold and calculate the suggested correction bolus to be zero if the current blood glucose value is greater than or equal to the target blood glucose value but less than the target blood glucose correction threshold.

140. A system for delivering fluid to a patient comprising:
an infusion pump; and
a control system for controlling the infusion pump, including,
user interface components for allowing a user to receive and provide information,
a processor connected to the user interface components and adapted to provide instructions to the infusion pump, and
a computer program having instructions for operating the processor, including carbohydrate preset interface instructions that are initiated when the user selects carbohydrate presets through the user interface components and that instruct the processor to,
prompt the user through the user interface components to choose between reviewing existing carbohydrate presets, editing existing carbohydrate presets and creating new carbohydrate presets, wherein the carbohydrate presets include single food presets and multiple food presets, and
maintaining a database of the carbohydrate presets, wherein the database includes a preset name field, a tag field, an amount of carbohydrates per serving size field, and an amount of fiber per serving size field for each of the single food presets and a list of single foods fields for each multiple food presets.

141. The system of claim 140, wherein the database further includes an amount of fat per serving size field, an amount of protein per serving size field, and an amount of calories per serving size field for each of the single food presets.

142. The system of claim 140, wherein the tag field of the database includes meals, snack and favorites.

143. The system of claim 140, wherein the carbohydrate preset interface instructions instruct the processor to prompt the user through the user interface components to select between a single food and build a meal upon the user selecting to create a new carbohydrate preset.

144. The system of claim 143, wherein the carbohydrate preset interface instructions instruct the processor to maintain at least one food database and prompt the user to select a food from the food database upon selecting a single food.

145. The system of claim 143, wherein the carbohydrate preset interface instructions instruct the processor to maintain at least one food database and prompt the user to select multiple foods from the food database upon selecting to build a meal.

146. The system of claim 140, wherein values within the fields of the database of the carbohydrate presets are read only with respect to the single food presets and multiple food presets.

147. The system of claim 140, wherein the carbohydrate presets further include a manual carbohydrate preset, wherein the values within the fields of the database of the carbohydrate presets for the manual carbohydrate preset are entered by the user through the user interface components.

150. A system for delivering fluid to a patient comprising:
an infusion pump; and
a control system for controlling the infusion pump, including,
user interface components for allowing a user to receive and provide information,
a processor connected to the user interface components and adapted to provide instructions to the infusion pump, and
a computer program having instructions for operating the processor, including custom food instructions that instruct the processor to,
prompt the user through the user interface components to enter the patient's insulin to carbohydrate ratio,
maintain a database of custom foods, wherein the database includes a custom food name field, a serving size field, and an amount of carbohydrates per serving size field for each of the custom foods,
prompt the user to select one of the custom foods listed in the database, and
display an amount of insulin required by the selected custom food based upon the serving size field and the amount of carbohydrates per serving size listed in the database for the custom food and the patient's insulin to carbohydrate ratio.

151. The system of claim 150, wherein the database further includes an amount of fat per serving size field, an amount of protein per serving size field, an amount of calories per serving size field, and an amount of fiber per serving size field for each of the custom foods.

152. The system of claim 150, wherein the custom food instructions allow values within the fields of the database to be edited by the user.

153. The system of claim 150, wherein the custom food instructions allow a user to enter new custom foods and corresponding values within the fields of the database for each custom food.

154. The system of claim 153, wherein the custom food instructions require each new custom food to have a name that is different from all the custom food names contained in the database.

155. The system of claim 150, wherein the custom food instructions allow a user to delete a custom food from the database.

156. A system for delivering fluid to a patient comprising:
an infusion pump; and
a control system for controlling the infusion pump, including,
user interface components for allowing a user to receive and provide information,
a processor connected to the user interface components and adapted to provide instructions to the infusion pump including fluid delivery instructions, and
a computer program having instructions for operating the processor, including fluid delivery programming instructions that instruct the processor to,
prompt a user through the user interface components for information regarding a desired dose including a flow rate of the desired dose and a duration of the desired dose,
calculate the fluid delivery instructions based on the flow rate and the duration provided by the user, and
provide a graphical representation of the desired dose through the user interface components.

157. The system of claim 156, wherein the graphical representation comprises a graph of the desired dose with the duration provided by the user displayed on a first axis of the graph and the flow rate provided by the user displayed on a second axis of the graph.

158. The system of claim 157, wherein the desired dose comprises a continuous basal rate.

159. The system of claim 157, wherein the desired dose comprises a new basal rate combined with a continuous basal rate.

160. The system of claim 157, wherein the desired dose comprises a temporary basal rate.

161. The system of claim 157, wherein the desired dose comprises an extended bolus dose.
